(19) United States
(12) Patent Application Publication
(10) Pub. No.: US 2016/0224766 A1
(43) Pub. Date: Aug. 4, 2016

(54) APPARATUS, SYSTEM, AND METHOD FOR OBFUSCATION AND DE-OBFUSCATION OF DIGITAL CONTENT

(71) Applicants: Chad Steelberg, Newport Beach, CA (US); James Steelberg, Newport Beach, CA (US); Anna Steelberg, Newport Beach, CA (US); Logan Steelberg, Newport Beach, CA (US)

(72) Inventors: Chad Steelberg, Newport Beach, CA (US); James Steelberg, Newport Beach, CA (US); Anna Steelberg, Newport Beach, CA (US); Logan Steelberg, Newport Beach, CA (US)

(21) Appl. No.: 14/928,739

(22) Filed: Oct. 30, 2015

Related U.S. Application Data
(60) Provisional application No. 62/072,752, filed on Oct. 30, 2014.

(51) Int. Cl. G06F 21/10

(52) U.S. Cl. CPC G06F 21/10

(57) ABSTRACT

Computer-implemented apparatus, system, and method of generating digital content with various degrees of obfuscation applied. A publisher of content, such as a private or commercial publisher of digital content, may set access restrictions to the content, such as to obfuscate and/or de-obfuscate the content based on select criteria.

### CROSS-REFERENCE TO RELATED APPLICATION

This patent application claims priority to U.S. Provisional Patent Application Ser. No. 62/072752, filed Oct. 30, 2014, the entirety of which is incorporated herein by reference as if set forth herein in its entirety.

### BACKGROUND OF THE INVENTION

1. Field of the Invention

The present invention is directed to providing digital content, and, more particularly, to an apparatus, system and method for obfuscating and de-obfuscating digital content.

2. Description of the Background

Social media is appealing because it provides quick and easy functionality for publishing, sharing, and accessing digital content. For example, successful providers such as Instagram have simplified and accelerated certain processes, such as the process of sharing images, in order to engage and enable users. Another mobile application, or “app,” is SnapChat, which allows a user to control of length of time to live (TTL), that is, the publisher of content may set a time to live value for the content, after which the content becomes inaccessible. Specifically, when a consumer of the content views it, a timer associated with the content is triggered and the content is deleted from the host device once the specified time threshold is reached. Thereby, the content is prevented from lingering indefinitely, and review of the content by unintended parties can be prevented to some extent.

However, progressively revealing content until the occurrence of some event or series of events or criteria is not provided in the prior art. In particular, the prior art does not provide for revealing content over a certain time period, or gradually upon the occurrence of a series of predetermined events or other criteria.

### SUMMARY OF THE INVENTION

Apparatus, systems, and methods for producing, publishing, and revealing obfuscated digital content such as an image. Access restrictions to the content may be applied. The obfuscated content may be de-obfuscated and revealed based upon the occurrence of certain predetermined criteria. For example, a private or commercial may publish obfuscated social content so that the content remains obfuscated until one or a plurality of events occur, whereupon the content may be de-obfuscated and revealed. The reveal may occur suddenly upon the completion of one event or all of a plurality of events, or may be occur gradually or in stages over time as a plurality of events occur in succession.

As used herein, obfuscation of content means to modify the content so as to reduce its clarity or understandability (for example, to blur an image). Conversely, de-obfuscation means to reveal or otherwise modify obfuscated content so as to restore it to its original, unobfuscated condition. De-obfuscation may also be used herein to mean gradually transforming content so as to enhance its value, such as in the case of a coupon whose value increases as certain criteria are met gradually over time.

Thus, the present invention provides an apparatus, system, and method of obfuscating content, and revealing the obfuscated content upon the occurrence of one or more predetermined events.

### BRIEF DESCRIPTION OF THE FIGURES

The present invention will be described in conjunction with the incorporated figures, in which like numerals represent like elements, and in which:

FIG. 1 is a block diagram of an exemplary computing device that may be used as a user terminal in the herein disclosed systems and methods.

FIG. 2 is a block diagram of a plurality of user terminals and a server, that may be used in the herein disclosed systems and methods.

FIG. 3 illustrates aspects of an exemplary apparatus for obfuscating digital content in accordance with the herein disclosed systems and methods.

FIG. 4 illustrates aspects of the apparatus of FIG. 3.

FIG. 5 is a flow diagram of an exemplary method in accordance with the herein disclosed invention.

FIG. 6 is a diagram illustrating exemplary user terminals engaging in obfuscation operations in accordance with the herein disclosed systems and methods.

FIG. 7 illustrates the extension of third party applications to include obfuscation capabilities in accordance with the herein disclosed systems and methods.

FIG. 8 illustrates an exemplary presentation of obfuscated digital content on a user terminal.

FIGS. 9A-E illustrate creating a new blurred post in an exemplary embodiment.

FIGS. 10A-D illustrate applying obfuscation attributes to the image being obfuscated.

FIG. 11 illustrates a so-called “Like View” of the exemplary obfuscation app.

FIGS. 12A, B show the operation of a camera in conjunction with the obfuscation app.

FIGS. 13A-C illustrate a so-called Question and Answer view, for setting information-based obfuscation attributes.

FIGS. 14A, B show a “Map View” of the app for setting geographical obfuscation attributes.

FIGS. 15A-C show a “Date View” of the app, for setting date/time obfuscation attributes.

FIGS. 16A, B show a “Fee View” of the app, for setting fee-based obfuscation attributes.

FIGS. 17A-F illustrate exemplary obfuscation app registration processes.

FIGS. 18A-F illustrate exemplary obfuscation app registration processes in conjunction with third party apps.

FIGS. 19A, 19B illustrate interoperation of the obfuscation app and Facebook.

FIGS. 20A-G illustrate user terminal screens in an exemplary implementation in which a user resets their login password.

FIGS. 21A, B show exemplary screenshots regarding unexpected results in connection with the obfuscation app cooperating with third party apps.

FIGS. 22A-F show exemplary screenshots pertaining to using third party app mechanisms in connection with obfuscation app operations.

FIGS. 23A-F show exemplary screenshots pertaining to resetting a user password within the obfuscation app in a standalone mode.

FIGS. 24A, B show illustrative obfuscation app operations.

FIGS. 25A, B illustrate posting obfuscated material.

FIGS. 26A-C illustrate posting comments.

FIGS. 27A, B illustrate “liking” posted material.

FIG. 28 shows a user viewing comments.

FIG. 29 shows a user attempting to view a locked profile.

FIGS. 30A-C illustrate posting comments.

FIGS. 31A-C illustrate downloading posted material.

FIGS. 32A-B show setting an alert.

FIGS. 33A-B show sharing a post.

FIGS. 34A-B show a user selecting further menu options.

FIGS. 35A-D illustrate selecting options pertaining to other users.

FIGS. 36A-B show a user displaying followers.

FIGS. 37A-B show a user following other users.

FIGS. 38A-C show a user selecting photos for obfuscation operations.

FIG. 39 shows a message displayed to a user trying to access another user's locked account.

FIGS. 40 through 84 illustrate exemplary screen shots pertaining to various aspects of illustrative obfuscation app embodiments.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent arts.

A computer-implemented platform comprising servers and clients is disclosed that allows a publisher of content to set access restrictions based upon various predetermined criteria. The content publisher may be an individual using a social media platform, or may be a commercial provider of digital media. The publisher obfuscates the content, for example, by applying partially transparent overlays with distortion effects sufficient to block content viewing, such as blurring, tiling, fading, and/or animating effects, that prevent consuming the content until one or multiple criteria are met. Examples of such criteria may include one or more of the following. A “like” threshold being achieved on a social app. One or more viewers being located near one or more specified geolocations, or a predetermined distance away from such geolocations. A predefined group of viewers gathered together geographically, identified either by number or by name. Third party app criteria is met, such as a viewer reaching a predetermined level in a game, or a viewer having more than 500 friends on Facebook, or the like.

Thus, computer-implemented platforms, apparatus, systems, and methods are disclosed for obfuscating and revealing digital content. The revealing of obfuscated content may occur suddenly upon the occurrence of one or a plurality of events. Alternatively, the reveal may occur gradually or in stages, as a series of events occurs.

This providing of content may occur within a single application (“app”), or may be requested or defined in a first app and delivered in a second. As used herein, an app may be an application running on a mobile device, such as a smartphone, tablet, or laptop computer, or may be running on a stationary device such as a desktop computer, smart TV, or the like.

The described computer-implemented embodiments are intended to be exemplary and not limiting. As such, it is contemplated that the herein described systems and methods may be adapted to provide many types of users with obfuscation and/or de-obfuscation capabilities, applicable to many types of digital content, and can be extended to provide enhancements to many types of applications. The disclosed systems and methods are intended to encompass all such extensions, the protected scope of which is defined by the claims.

Illustratively, a user may take a photograph, for example, using a smart phone. In an app running on the phone, default or user selected obfuscation rules are applied to the photo. For example, the user may select to apply a “blur distortion”, that requires 100 “likes” in a social app to view without blurring, and the image will be revealed progressively as more “likes” are posted (as opposed to suddenly upon the occurrence of all 100 “likes”, for example). The photo may be shared with a specified group of people, such as by sending it to friends or posting in a social app or the like, or it may be posted in a publicly accessible location. Thereafter, the first viewer who views the obfuscated photo may see a maximally blurred image, along with an indication of the criteria that must be met to see it clearly (i.e., 100 “likes”). After the first user “likes” the image, a measure of de-obfuscation is applied to the photo and it becomes less blurred to the first and subsequent viewers. As more users “like” the image, the image progressively becomes clearer. In addition, sparklines, notifications, and the like may be provided to indicate to viewers the progression of the fulfillment of the de-obfuscation criteria.

As used herein obfuscation includes any partial or complete modification of original content for the purpose of reducing its visibility (e.g., for images or video) or cognitive understanding (e.g., in the case of text). Obfuscation may be applied to “clear” content, and the level of de-obfuscation may be tied to predetermined events. Alternatively, application of the obfuscation may be tied to predetermined events, so that the content starts out clear and becomes more obfuscated as the events occur.

Obfuscation events may be binary, that is, obfuscation may be eliminated or applied in a single step when all criteria are met. Alternatively, obfuscation may be cumulative, and may be eliminated or applied gradually, or in stages, as a series of events occur or criteria are met. Types of criteria or events on which obfuscation operations may be performed can include one or more of social or social-app based, geographic location based, temporal, or the like. Further, obfuscation and de-obfuscation may both be applied within the framework of a single app or platform, or obfuscation may be applied in a first app and de-obfuscation may be applied in a second app. The second app may be a third party app extended by or integrated with obfuscation functionality.

Social events may include, for example, “likes” as in Facebook or the equivalent, dislikes, comments, shares, and the like. Viewership of de-obfuscated content may be unrestricted, or may be restricted to only those who met or participated in the social event criteria.

Geographically determined events may include performing obfuscation or de-obfuscation operations within a specific geographic boundary or set of associated boundaries, or when a group of viewers are within a certain proximity of each other. Thereby, only viewers within the boundary or proximity are enabled to view content that is obfuscated elsewhere, or conversely, content is viewable everywhere except within a geographic boundary, where it is obfuscated.

Combined Social/Geo events may include, for example, at least a certain number N of people on a viewing list must be within a certain geographic area, or within a certain distance of each other, or at least a subset N of M people on a viewing list are within an area or within a certain distance of each other.

Temporal events may include obfuscation or de-obfuscation operations performed, or access to digital content granted, before or after a certain time, or during a specific time period.

Third party app events may include, for example, a computer-based system that provides obfuscation operations, whereby third parties such as web publishers and app developers can make API calls, such as to obtain obfuscation app status updates, third party criteria tracking, and the like. In other cases, where a third party app already provides public APIs such as Facebook, an obfuscation service may be integrated with or interact with the third party app via its APIs, such as to obtain statistics. For example, an obfuscation server may use Facebook APIs to obtain statistics or other information regarding Facebook friends or the like of viewers of obfuscated content, or a number of shares of specific content accessible via Facebook, and the like.

Thus, an arbitrary and unconstrained number and type of events may be chosen to define when and how to apply obfuscation or de-obfuscation operations, both of which are hereinafter collectively referred to as “obfuscation operations”. Thereby, access to content associated with obfuscation operations may be determined on a distributed basis, for example based on behaviors or actions taken by viewers, rather than being centrally and arbitrarily determined.

The use of obfuscation operations need not be socially driven. Further, such operations may be used for commercial purposes. For example, a plurality of users may make payments using an online mechanism such as UPay or the like to see a cleared image. UPay is a system of instant payments, which provides the ability to make instant payments using a mobile phone based on its phone number. Illustratively, a user may purchase “credits” via UPay or the like (e.g., $0.01 per credit), and use the credits to participate in revealing an image. The credits may then be held until the image is de-obfuscated by at least a predetermined amount, such as by 80%. If that amount is not achieved within a predetermined timeframe, such as within 30 days, the credits may be refunded to the user's account.

Moreover, a device displaying blurred content may be a proxy for another type of media, such as a billboard offering a test drive for a new BMW.

An advantage of the herein disclosed systems and methods is providing an economic benefit for engaging media. In the prior art for example, users are not compensated for posting a “like” or for entering a comment. The herein disclosed systems and methods may provide or participate in an exchange or marketplace, whereby participants' social network “friends” are incented to cooperate in achieving a goal, such as by providing a “like”, or a micropayment, or visiting a site, or the like, even though the participants may not be acquainted with each other. For example, in the case of an electronically distributed but obfuscated coupon, the coupon may be revealed only in the case that a certain number of people, such as 1,000 people, arrive at a predetermined place, such as a grand opening of a store, during a predetermined window of time, such as before 10 am on opening day. If those criteria are met, the coupon may be revealed, but only to the first 1,000 viewers who participate in satisfying the criteria.

Other applications may include, for example, revealing obfuscated information when certain criteria are met, such as revealing bank codes when a designated group of people agree to cooperate, or revealing the text of a will so that it may be read, and/or revealing criteria in satisfaction of a trust, or the like.

Moreover, “crowd bartering” may be implemented. Illustratively, LinkedIn connections may be monetized by associating commercial incentives to LinkedIn participants more generally, crowd behaviors can be incentivized by providing incentives to cooperate in order to receive value. Continuing with the LinkedIn example, if participants provide a user with ten referrals in linkedin, that user may respond by providing exposure from among the user's connections.

Applications may include mitigating shopping lines during holidays, or at an amusement park. In addition, benefits of participation may be distributed among non-participating parties if desired. Illustratively, a benefit of some kind may be provided to participants when predetermined criteria are satisfied, as well as to non-participants. For example, de-obfuscation of digital content may be provided to participants, and in addition a contribution may be made to a charity in the event a sufficient number of people participate.

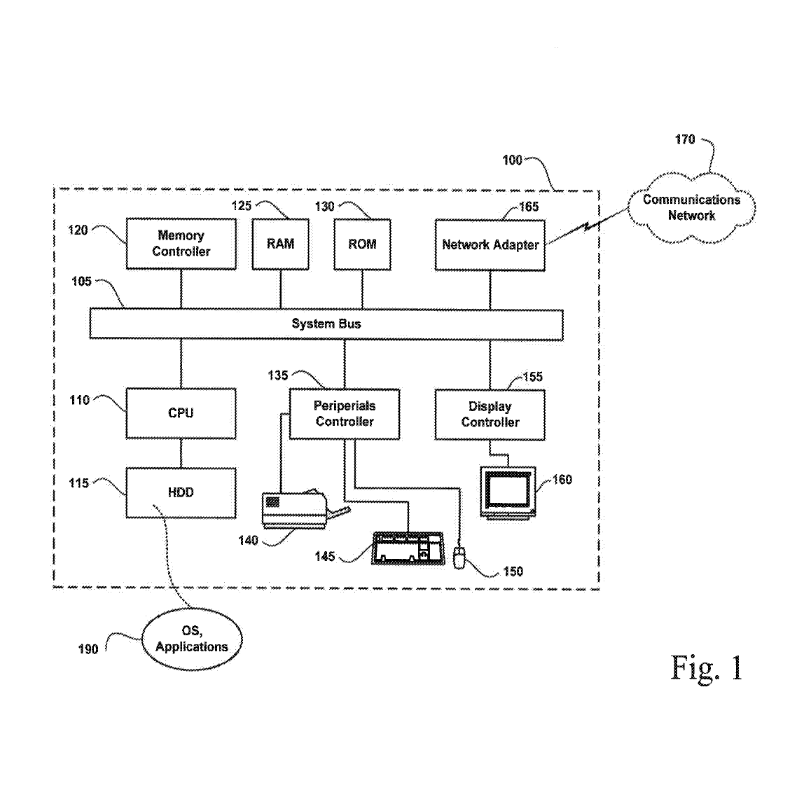

FIG. 1 depicts an exemplary computing system 100 that may be used in implementing the herein described apparatus, systems, and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable storage device, such as hard disk drive (HDD) 115, an optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a microprocessor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths.

Memory devices coupled to system bus 105 can include random access memory (RAM) 125 and read only memory (ROM) 130. Such memories include circuitry that allows information to be stored and retrieved. Data stored in RAM 125 can be read or changed by CPU 110 or other hardware devices, whereas data stored ROM 130 generally cannot Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes.

In addition, computing system 100 may contain peripheral controller 135 responsible for communicating instructions using a peripheral bus from CPU 110 to peripherals, such as printer 140, keyboard 145, and mouse 150. An example of a peripheral bus is the Universal Serial Bus (USB) bus.

Display 160, which is controlled by display controller 155, can be used to display visual output generated by computing system 100. Such visual output may include text, graphics, animated graphics, and/or video, for example. Display 160 may be an LCD-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide for access to and tracking of the data discussed herein. Communications network 170 may provide a user of computing system 100 with means of communicating and transferring software and information electronically. The network interface may be wired, such as an ethernet or cable connection to a wired network, or may be wireless, such as an air interface to a WiFi or cellular network. Additionally, communications network 170 may provide for distributed processing, which involves several computers and the sharing of workloads or cooperative efforts in performing tasks. It is appreciated that the network connections shown are exemplary and other means of establishing communications links between computing system 100 and remote users may be used.

It is appreciated that exemplary computing system 100 is merely illustrative of an exemplary computing environment in which the herein described systems and methods may operate and does not limit the herein disclosed systems and methods. Rather, computing environments having differing components and configurations may be used. That is to say, the inventive concepts described herein may be implemented in various computing environments using various components and configurations.

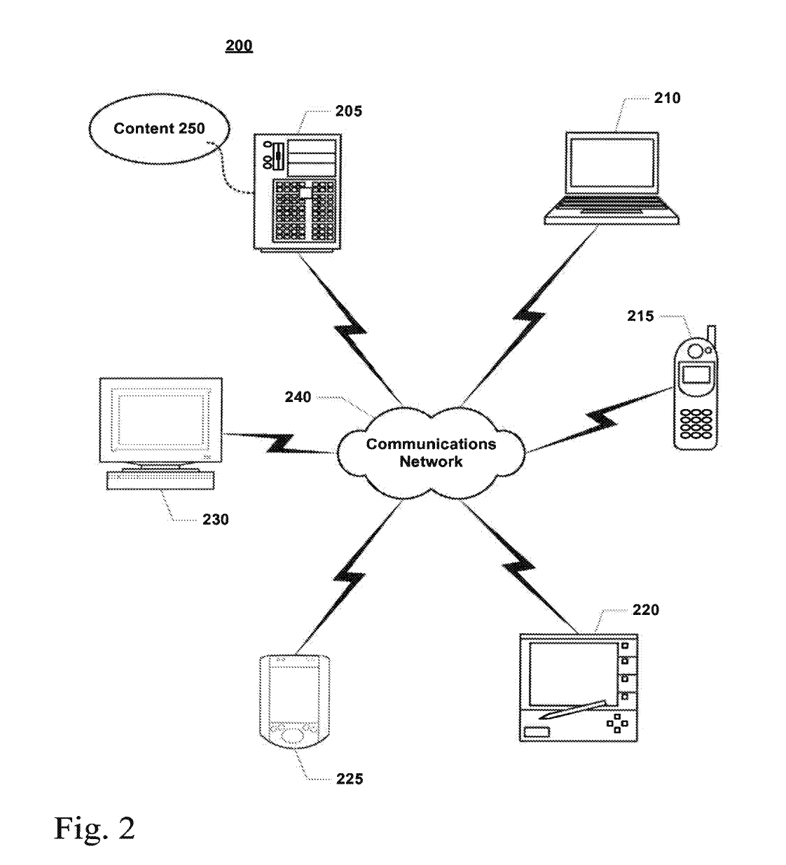

As shown in FIG. 2, computing system 100 may be deployed in networked computing environment 200. In general, aspects of the above description for computing system 100 may be applied to server, client, and peer computers and user terminals deployed in a networked environment as shown. For example, server 205, laptop computer 210, IP telephone 220, desktop computer 230, and various mobile computing devices 215, 225. FIG. 2 illustrates an exemplary networked computing environment 200, including a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone/smartphone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), and independently developed applications, to interact with server 205.

The server 205 may thus deliver and/or or communicate via applications specifically designed for mobile client devices. Client devices 215, 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example.

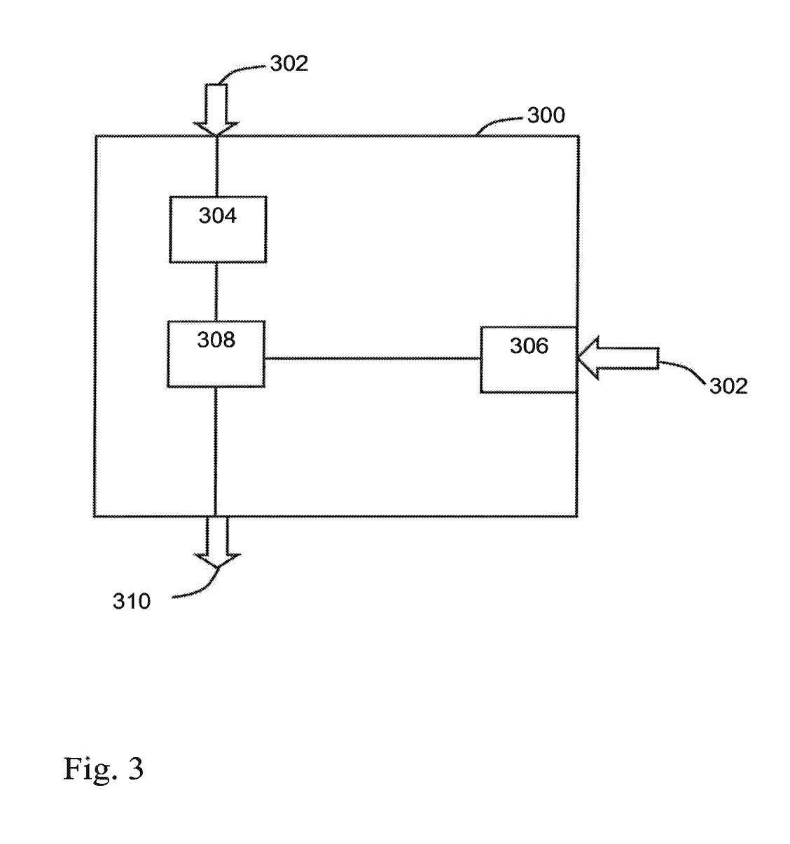

The herein disclosed apparatus, systems, and methods provide a computer-based platform, including server and client aspects as described in connection with FIGS. 1 and 2. As is illustrated in the exemplary embodiment illustrated in FIG. 3, system 300 allows a user, such as a private or commercial publisher, to publish digital content 302, such as a photo. The system allows the user to obfuscate the content using obfuscation engine 304, and to select de-obfuscation criteria which will reveal the obfuscated content. A detector 306 detects the occurrence of events or conditions that constitute the criteria. When one or more of the criteria are satisfied, de-obfuscation engine 308 reveals the original content, 310. The de-obfuscation may be applied all at once after all criteria are satisfied, or may be applied gradually over time, such as when each of a plurality of criteria are satisfied over time, or as groups of criteria are met, or as threshold numbers or types of criteria are met, for example.

As noted, an obfuscation may comprise a partial (such as blurring) or total (such as blocking or not delivering) modification of original content. Obfuscation may thereby reduce the understandability of the content. For example, in the case of an image or video the content may be blurred, or audio content may be garbled, or text may be jumbled. Obfuscation-like operations may also be used to reduce or increase the usefulness or applicability of content, such as in the case of a coupon of increasing value as criteria are met. De-obfuscation may be used to reverse obfuscating effects that have been previously applied to reveal the original, unobfuscated content. By way of non-limiting example, an obfuscation may comprise a distortion function that renders the content at least partially not understandable. For example, an obfuscation may include applying one or more of blurring, tiling, fading, or an animating affect that at least partially distorts, blocks, or prevents consumption of the content by a viewer.

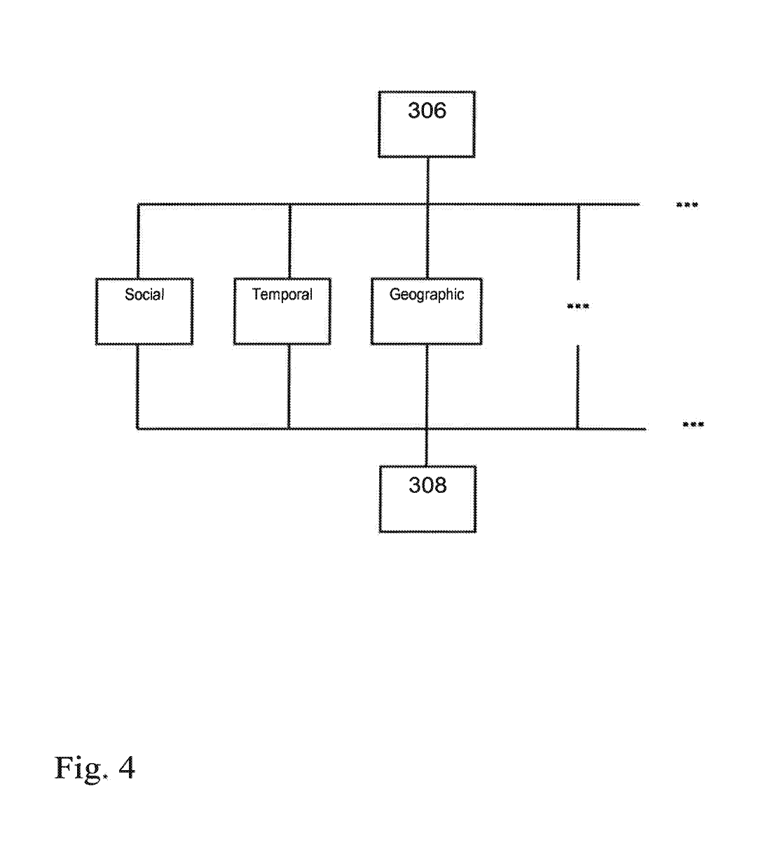

Criteria to be met before applying obfuscation operations may relate to the occurrence of predetermined events, at predetermined times and/or locations, or the like. Criteria may be binary (that is, upon satisfying the criteria, obfuscation is applied or removed) or progressive and cumulative. Progressive criteria may be chosen to incentivize the behavior of one or more viewers, such as to incentivize “liking” the content or other entity, or visiting a designated location at a designated time, or the like. As illustrated in FIG. 4, criteria may comprise one or more events of a variety of types, such as social (based on group behavior), temporal (within or outside of a time/date period), geographic (within or outside of one or more geographic locations) and the like. Obfuscation may be applied within third party apps, and may include fee-based aspects. For example, obfuscation operations may be applied on behalf of any user who pays a fee, or after a certain number of users pay a fee, or after a total amount in fees are paid, such as in connection with a contest, raffle, or the like.

In embodiments, criteria may include one or more of a “like” (or equivalent) threshold, dislikes, comments, links from/to, referrals from/to, or shares. In accordance with the social criteria, viewership may be unrestricted, or may be restricted to only those who meet (or who participated in the meeting of) the criteria. For example, a purely social criteria may include any viewers who have at least 500 friends on Facebook, or may relate to an image or image provider receiving 500, 1,000, or 10,000 “likes”. Thus, social criteria may allow for crowd sourcing content obfuscation operations.

Geo-based criteria may include the presence of the viewer within/outside of a specific geoboundary. Further, geo-based criteria may include the presence (or absence) of specified viewers (either by number or by name) proximate to one another geographically, for example. Illustratively, an image may be progressively de-obfuscated beginning when a viewer is within 5 miles of a particular destination, progressing linearly to complete de-obfuscation when the viewer reaches the destination. By way of non-limiting example of combined social and geographic criteria, at least N people from a list of M “friends” may be required to be within 100′ of each other in order for the N people (or all M people) to be enabled to view particular content.

Third party criteria may pertain to a third party app. For example, a content de-obfuscation criterion may be that a viewer must reach level 20 in the “Angry Birds” app in order to de-obfuscate content, or the content may be progressively de-obfuscated beginning when the viewer reaches level 10 and completing when the viewer reaches level 20 in the app. Accordingly, the computing system and network environment such as the one shown in FIGS. 1 and 2 and further described hereinafter may provide for third party web pages and/or app developers to make API calls to the system for app status updates. In the foregoing example, that may include using an Angry Birds API to obtain an Angry Birds level indicator. Thus, in cases in which a third party app provides a public API, obfuscation operations may be applied using that API to obtain app statistics, such as likes, dislikes, shares, friends, etc. As such, the herein described systems and methods support an open platform by which third party apps may include obfuscation operations.

In an illustrative scenario, a social criterion (crowd sourcing) may be used to enable execution of micro-transactions (i.e., fee-based criteria). Such micro-transactions may additionally include geo-based criteria. For example, de-obfuscation of an obfuscated QR code downloaded by a plurality of users may allow those recipients to obtain a discount on a new micro-brewed beverage, being served at a new restaurant. To reveal the QR code, the publisher of the obfuscated QR code may require 10,000 Facebook “likes” of its micro-brew, and may wish to limit the discount to only those persons that show up at the restaurant during designated hours on designated days.

In another illustrative scenario, a publisher of obfuscated content may wish to raise $500 for a charitable donation. As such, a criterion may be that downloaders of the obfuscated content receive a bonus if they also make a micro-donation in conjunction with downloading the content.

In yet another illustrative scenario, a large beer provider, such as Coors, may define criteria to reveal a coupon redeemable for a free beer to viewers attending the football game. Thus, when 5,000 persons arrive at the game and enter a “like” on Facebook for Coors Light, all those entering a “like” may de-obfuscate the coupon for a free beer. Alternatively, a coupon for a discount on a beer at the game may be provided when 4,000 “likes” are obtained, and the coupon may be de-obfuscated in stages to provide progressively more value as more “likes” are obtained from viewers at the game. Illustratively, a coupon that is initially good for a 10% discount on a beer at the game may be provided to those entering a “like”, upon reaching 4,000 “likes”. However, the percentage discount may be increased as more “likes” are received, progressing to 100% when 5,000 “likes” are obtained from fans at the game.

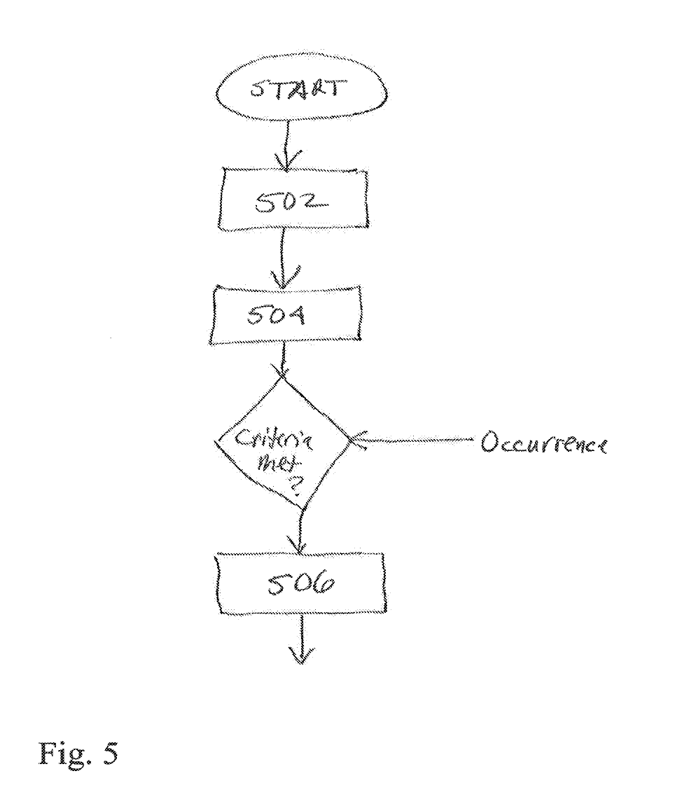

FIG. 5 is a flowchart of an exemplary method for use with the system of FIG. 3. As shown, obfuscation is applied to digital content, 502. For example, a user may set or select obfuscation operations to apply to a digital photo. Further, the user may choose criteria to be applied to de-obfuscate the photo, 504. For example, the user may select “blur distortion” and define a share group. The user may also select 100 “likes” as a criteria to view the unobfuscated photo, and set a progressive reveal of the image, that is, the image will be de-obfuscated in steps with each new “like” received, and will be completely revealed when 100 likes are received, to the participating viewers, 506.

Illustratively, for example, a public photo share group may be selected. A first public user who views the photo sees a blurred image, and an indication of the criteria to see the photo clearly (in this example, 100 likes). Once the first user “likes” the image, the image may immediately become less blurred, such as by 1% (i.e., based on receipt of 1 out of the required 100 likes), although the relationship between the criteria and a gradual reveal may be non-linear. For example, the first viewer may see a 5% improvement, and the last viewer may see a 0.5% improvement to completely reveal the content. As the criteria are met, participating viewers may be provided with, for example, sparklines, notifications, or the like that indicate the progress of the de-obfuscation, and their copy of the photo may be updated as the content is revealed.

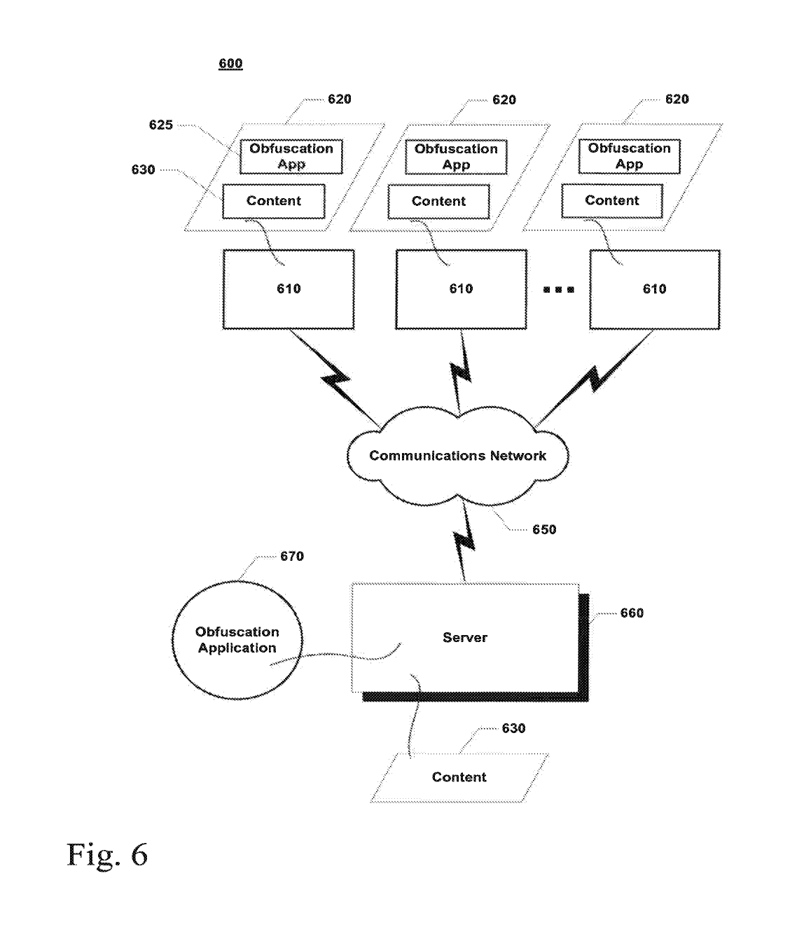

FIG. 6 shows an illustrative implementation of exemplary content obfuscation environment 600. As shown, the obfuscation environment comprises one or more user terminals 610 that are uniquely identifiable to server 660. Although three terminals are shown, the obfuscation environment may include hundreds, thousands, or even millions of user terminals The terminals have one or more obfuscation apps 625, which may be standalone apps, or may operate as extensions to other apps running on the user terminals, for example, as plugins, widgets, or the like. The user terminals also have content 630, which may be images, videos, text, or the like, and which may include either or both of original unobfuscated content and obfuscated content. User authentication, such as a registration process, may be applicable to allow for participation in the herein disclosed methods, and as such the app may provide for a log-in. Thus, an initial set-up of a user account may include establishing a user profile, and may have its inbound and outbound communications subject to security protocols or the like. Alternatively, when operating as an extension, the app may reference a login procedure and security of the associated third party app.

User terminals 610 are communicatively coupled via communications network 650 to obfuscation server 660. Server 660 has one or more obfuscation applications 670, and stores content 630, which may include obfuscated and unobfuscated content obtained from and to be shared with one or more user terminals 610. Server 660 provides obfuscation services to user terminals 610.

In an illustrative operation, a user may use user terminal 610 to select an item of content to be obfuscated, such as an image. Obfuscation app 625 may be used to select obfuscation parameters to be applied to the content to create obfuscated content, and de-obfuscation criteria to be used to remove the obfuscation and reveal the unobfuscated content. The obfuscation app 625 on the user terminal 610 may show a preview of the obfuscated content to the user. When satisfied with the preview, the content and obfuscation criteria may be communicated over network 650 to server 660. The server receives and stores the content, applies the selected obfuscation parameters to the content, monitors and tracks the fulfillment of the de-obfuscation criteria, de-obfuscates the obfuscated content, and distributes the content to participating user terminals in various stages of de-obfuscation in accordance with the fulfillment of the criteria, or in accordance with predetermined default parameters.

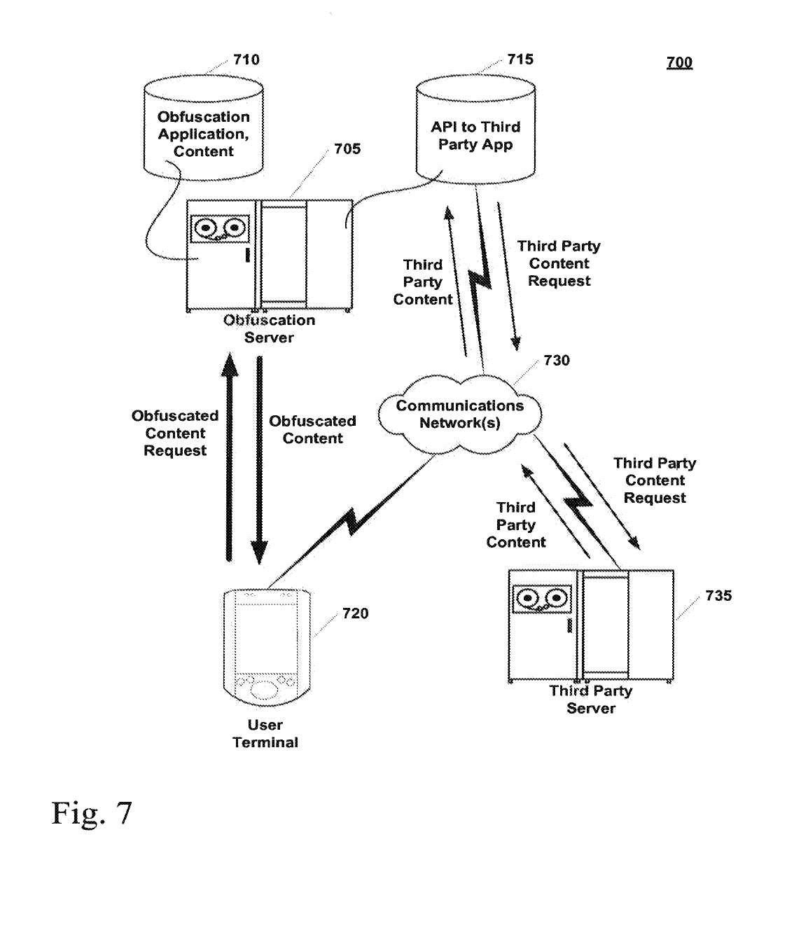

FIG. 7 shows an exemplary obfuscation environment similar to environment 600, but extended to include interfaces to third party applications hosted on third party servers. As shown, exemplary obfuscation environment 700 comprises obfuscation server 705 having obfuscation applications and content 710. Obfuscation server also provides interfaces to third party third party servers 735 using respective third party application programming interfaces (APIs) 715. Obfuscation server 705 communicates via one or more networks 730 with user terminals 720 and third party servers 735.

In an illustrative operation, a user terminal 720 is running an obfuscation app as an extension to a third party app, such as a social app like Facebook or the like. In this case, the obfuscation app interacts with the third party app, and may use the third party app to obtain unobfuscated content, share obfuscated content, invite third party app users to participate in obfuscation scenarios, and the like. To do so, the obfuscation app running on user terminal 720 communicates with obfuscation server 705 and communicates or identifies the unobfuscated content, the select obfuscation parameters, and the obfuscation criteria, along with third-party specific information such as login information, contacts within the third party app, favored third party app parameters, and the like. Server 705 then uses third party app APIs 715 to communicate with third party servers 735, to implement, share, and monitor obfuscation operations in conjunction with the third party app, its mechanisms, and its facilities.

In an illustrative operation, responsive to requests from users for obfuscation content, obfuscation platform 700 can assemble third party app content and obfuscation content for communication to users through communications network 730. The assembled content can then be displayed on user terminals 720 for interaction by participants. If participants interact with the assembled content, obfuscation server 705 can cooperate with user terminals and third party servers to monitor the progress of criteria fulfillment, perform obfuscation operations, and distribute content in various stages of de-obfuscation in accordance with the criteria.

Obfuscation may be applied to digital content in any manner known in the art. For example, in image processing a so-called Gaussian blur may be applied, which blurs an image by applying a Gaussian function, that is, a function of the form

$$f ( x ) = a {e}^{- \frac{{( x - b )}^{2}}{2 {e}^{2}}}$$

for real constants a, b, c, and e≈2.71828 . . . (Euler's number). In particular, a Gaussian blur is applied to a digital image by convolving the image with a Gaussian function. In the present case, such a blurring may be applied in a user selected number of steps using default or selected parameters to apply obfuscation to a photo. Conversely, the photo may be de-obfuscated in the same number of steps by reversing the process.

In an embodiment, a plurality of filters may work together to compute the blur level of a post. Illustratively, if one filter is set, the computed level for that filter directly applies to the image. In the case of more than one filter being active, then the blur level (BL) may be computed for each filter and divided by the number of active filters (AF), that is, BL/AF. The total blur would then be the sum each AF for the given image, although other methods may be used. For example, if a user posts an image with both a “like” filter and a money filter and sets the like and money targets at 100 and $100 respectively, then a viewer who paid $1 (where the collective money paid was $50), with no “likes”, would see an image with 25% blur level, determined as [0/100 (based on zero “likes”)+50/100 (based on $50 collected)]/2.

Illustratively, a blur level may be determined based on the number of “likes” (or other criteria) divided by the number of target likes. In an exemplary operation, if the number of likes goes above the target for some period of time, but then drops back down because people “unlike” it, then the blur level may also be adjusted to reflect that drop.

Non-limiting examples include the following. With regard to geolocation based criteria, as a user's geolocation changes, the blur posts may be updated in real time with different blur levels. For example, a blur level may be computed as a linear percent, in accordance with the following:
Target Point (TP)=the center of the viewable boundary;
Boundary Radius (BR)=the radius in Miles from the TP to the boundary set in the UI;
User position (UP)=current user's position; and
DeblurCalc=min(1,BR/(UP-TP)).
In accordance with the above, for a BR=1 mile, when UP-TP=0.5 miles the DeblurCalc=min(1, 1/0.5)=1=100%. As a second example, for a BR=1 mile, and UP-TP=5 miles, the DeblurCalc=min(1, 1/5)=0.2=20%.

With regard to date/time based criteria, an exemplary way to determine a blur level is as follows:
TD=timedate for no blur;
TOP=timedate of the post;
LAG=TD−TOP;
CT =current timedate.
An exemplary de-blur calculation may then be:
DeblurrCalc=min(1, ((CT-TOP)/LAG)̂3)
although other calculations may be used.

With regard to fee-based criteria, a user may be required to pay a minimum amount for de-blurring be greater than 0. Illustratively,
F=The fee amount;
P=paid amount;
U=User's payment status. That is, 0 if the user hasn't paid and 1 if the user has paid.
An exemplary de-blur calculation may be DeblurCalc=min(U,P/F), although other calculations may be used. Illustratively, the system may not accept fees paid above the F value set by the poster.

Alerts may be implemented in accordance with the following. When a user clicks on the alarm icon, this instructions the obfuscation application to notify the user when that blurr post reaches 100% clarity, for example, via a visible push message with audio alert. The format of the message may include a thumbnail of the de-blurred image and a message that links directly to the post.

In an embodiment, a user may delete a post from their feed. A user may also delete a post that has been sent, but it will not delete it from any of their followers' feeds. A user may have multiple accounts associated with the same email address, using different unique usernames. Preferably, user names and associated email addresses may be updated as desired by users.

In an embodiment, messages may be conveyed to a user in the “heart/comment” section of the app. In that section, all comments and activity on a user's posts may be shown. Further, anytime a user views a blurred post of a poster for the first time with 100% clarity, the poster may be notified. In an embodiment, Time/Date and Geolocation criteria need not be reportable. However, Fee payments may be reported.

The following figures illustrate an embodiment wherein the user terminal is a smartphone, such as a droid or iPhone for example. Here, the phone has a touch sensitive screen, front and back cameras, and support portrait and landscape orientations.

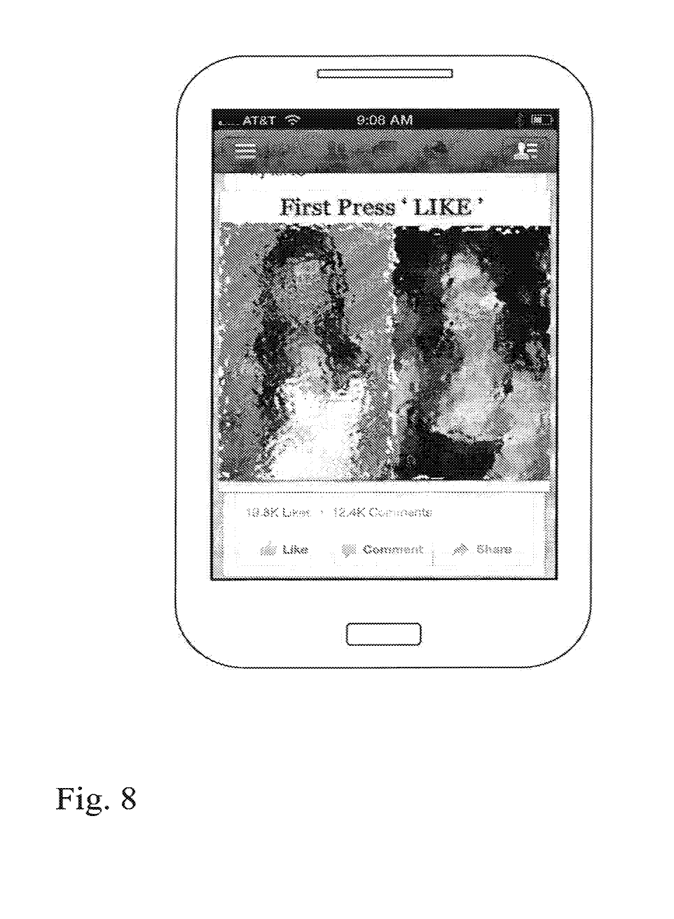

FIG. 8 is an example of a screen showing a photo that has been obfuscated with a blurring effect, which appears in a third party app, such as Facebook. If the viewer presses “Like” (bottom left), the screen will be refreshed with the same photo, with at least a portion of the obfuscation removed. The amount of obfuscation that was applied and that will be removed depends on the obfuscation parameters that were set when the obfuscation was applied.

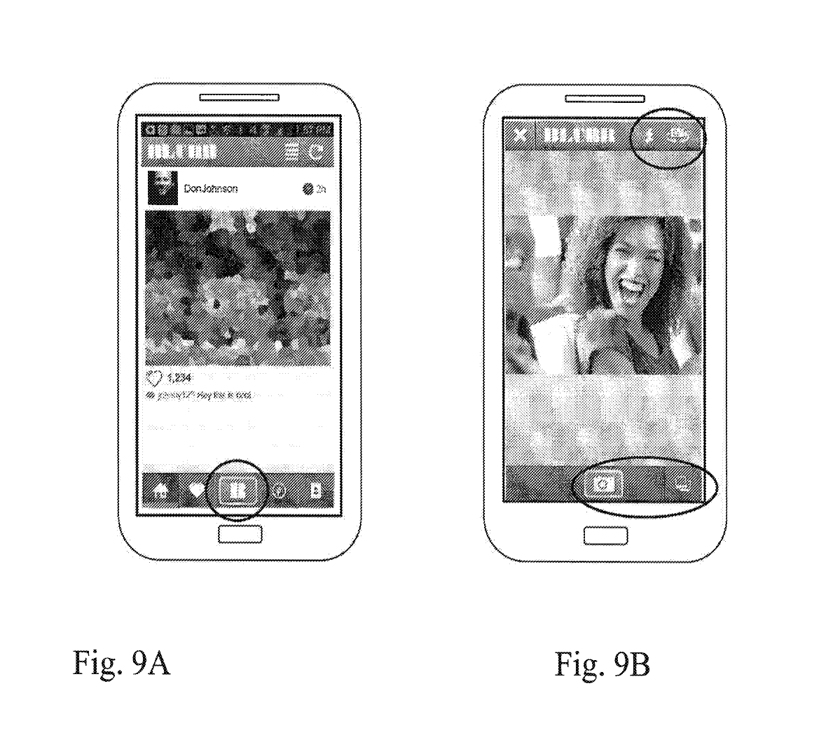

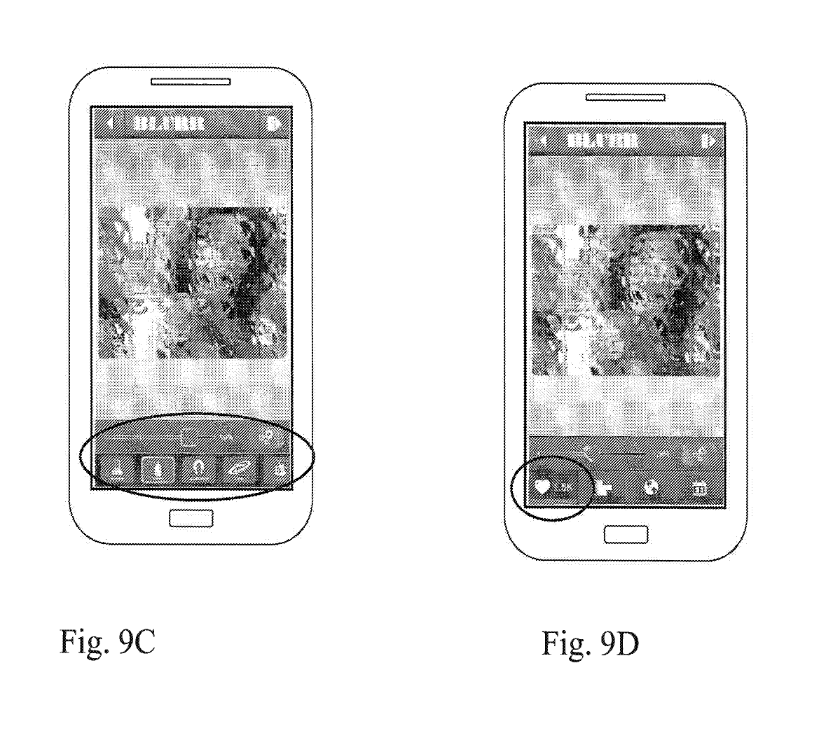

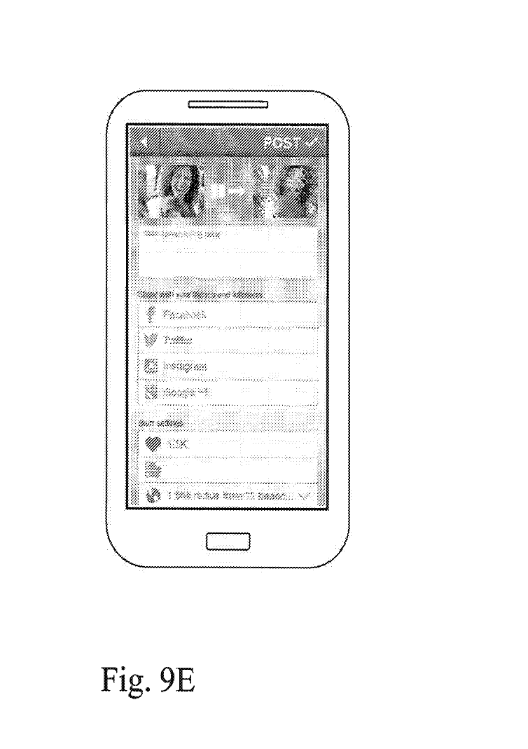

FIGS. 9A-E illustrate creating a new blurred post in an exemplary embodiment. FIG. 9A shows an obfuscated photo, that is, a photo to which obfuscation has already been applied. The app provides a header area at the top of the display in which the app is identified with the illustrative app moniker BLURR, and also contains function icons. In addition, the app has an icon bar at the bottom of the display containing exemplary app icons, one of which contains a “B”, for launching operations of the obfuscation app.

In FIG. 9B, the viewer initiates image obfuscation operations by pressing the “B” icon. When it is pressed, a camera image appears, and the app invokes a camera mode for taking pictures. Illustratively, the camera mode supports landscape mode (invoked by turning the phone on its side), flash (invoked by pressing the flash icon, top right), and front/back mode (for phones with both front and rear facing cameras, invoked by pressing the flip camera icon, top right). The user may also press a photo album icon (bottom right) to invoke a gallery mode that displays photos stored on the phone, and can then choose an image from the photo album. As shown, an unobfuscated photo is displayed, to which obfuscation operations may be applied. The photo may have been taken with the camera or selected from the album.

In FIG. 9C, a plurality of icons appear each of which when pressed invokes a different obfuscation effect. The user selects an effect and then sets the intensity by choosing an obfuscation level on the slider control. The displayed image shows a preview of the selected obfuscation type and intensity. The gear icon may be selected to show icons representing obfuscation parameters that may be applied. Illustratively, those parameters may include setting obfuscation attributes including social parameters, geographic parameters, and time-based parameters, as will be described.

In FIG. 9D, the user selects the “like” icon to set the number of likes required to display the image with obfuscation removed. In FIG. 9E the user may enter comments, and select other apps such as social networks in which the obfuscated photo may be shared. The obfuscation app interacts with the other apps by using their respective application programming interfaces (APIs), for example. By clicking on an obfuscation (“Blurr”) setting the view then changes to that specific effect for editing.

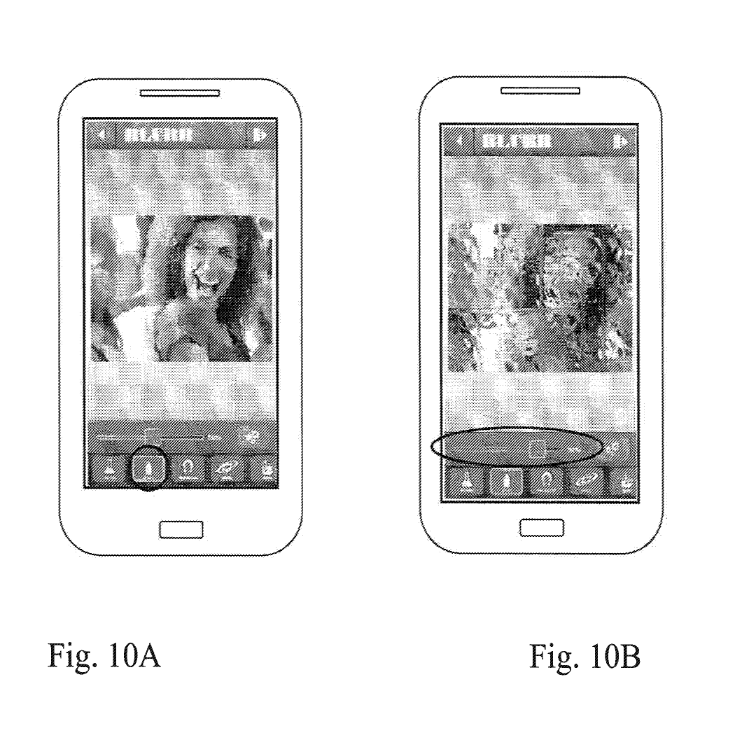

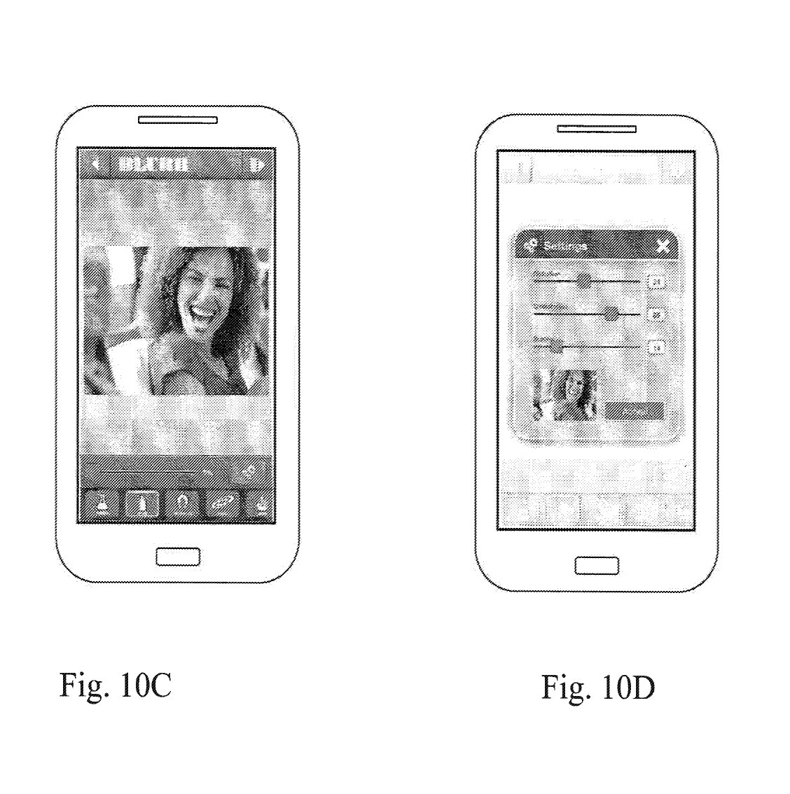

FIGS. 10A-D illustrate applying obfuscation attributes to the image being obfuscated. As shown in FIG. 10A, a so-called “splat” effect has been selected, and the effect is applied at a 50% level. In embodiments, one or more default values may be applied, for example, the splat effect and/or 50% level may be applied as defaults. Alternatively, the app may remember the last value used for a specific effect. In FIG. 10B, the slider adjusts the selected obfuscation effect and displays a preview. In FIG. 10C, setting the slider to zero removes the effect altogether, and no obfuscation attributes are presented for selection. However, as shown in FIG. 10D, if the slider is not set to zero, attribute settings may be presented for selection.

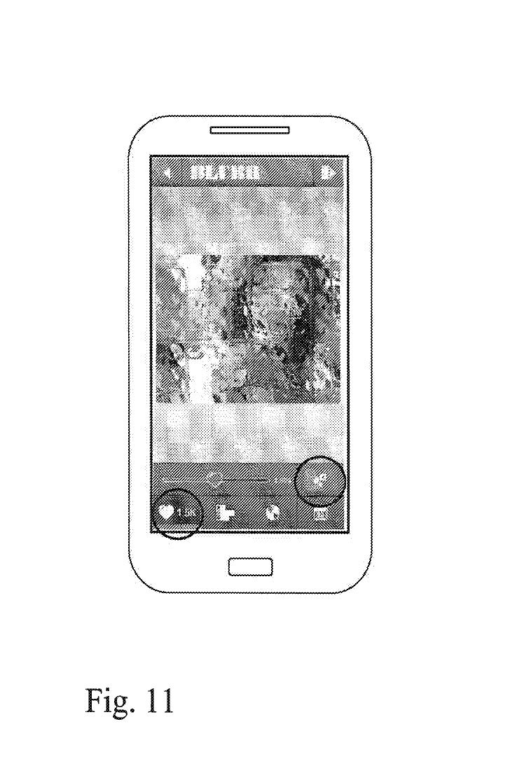

FIG. 11 illustrates a so-called “Like View” of the app, invoked by selecting the

Like icon at the bottom left of the screen, to set social-related obfuscation attributes. As shown, a user may set the number of likes required to display the image de-obfuscated. Illustratively, the function of the slider control may be modified to select a number of likes as an obfuscation attribute. In an embodiment, the slider is set by default to zero, then grows by 1′s until 100, then by 10′s, until 1000, then by 100′s until 10K, and so on. Illustratively, the user interface may display 001 up to 990, then 1.0K, 1.1K to 10K, and so on. In an embodiment, a maximum setting may be 10 million likes.

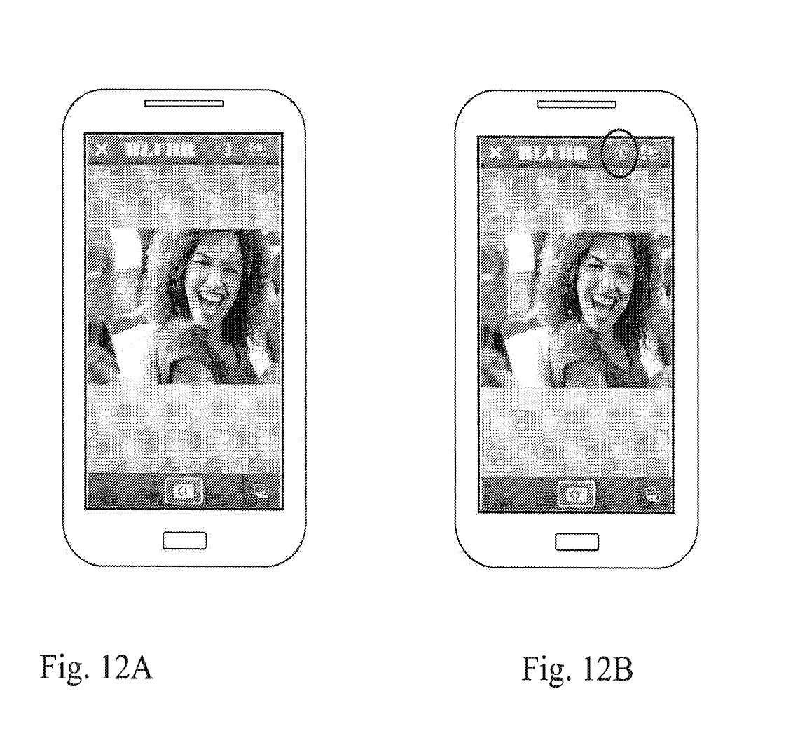

FIGS. 12A, B show the camera view of the app, described previously. In FIG. 12A, the camera image appears when the camera mode is invoked. The camera mode supports landscape mode, flash, and front/back camera. The user may choose the photo album icon to choose an image from the photo album. In FIG. 12B, the flash has been deactivated, and the icon shows deactivated.

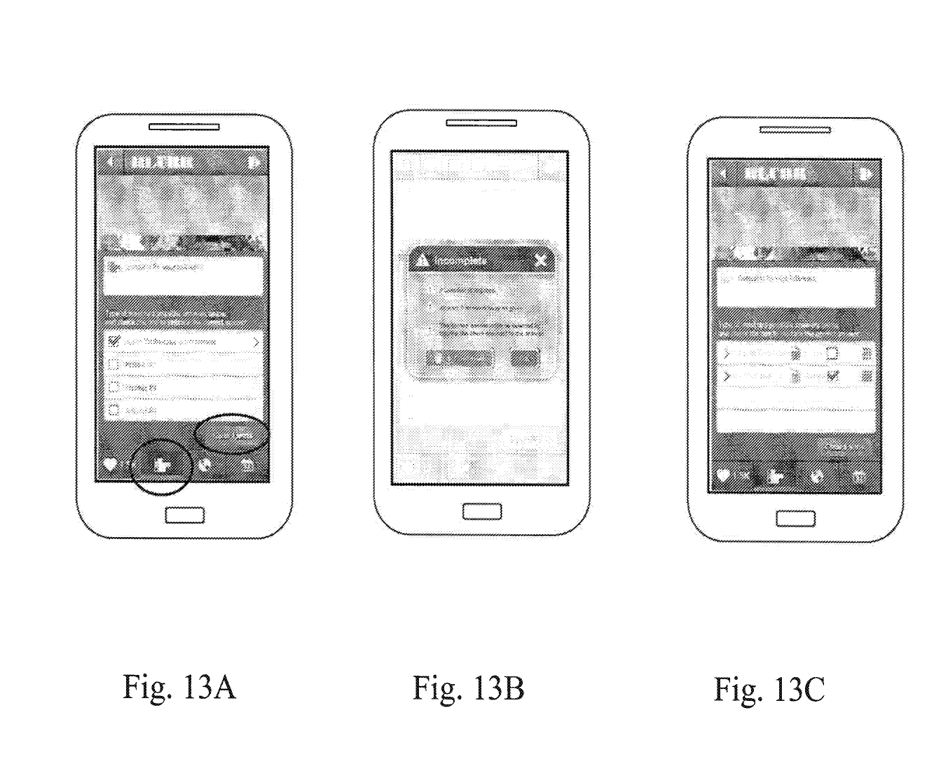

FIGS. 13A-C illustrate a so-called Question and Answer view, invoked by selecting the Q&A icon, bottom left center, to set information-based obfuscation attributes. As shown in FIG. 13A, the user can enter a single question, up to 80 characters in length and provide up to 4 answers, also up to 80 characters in length. Choosing the Clear Fields button clears all the fields. Choosing the checkbox marks the correct answer. In an embodiment shown in FIG. 13B, if the user switches views before at least 2 answers are provided, the correct answer is checked, and a question is entered, then an incomplete error popup appears. In an embodiment shown in FIG. 13C, choosing the right arrow on any answer that is not blank will slide overlay controls across all valid answers. In the overlay, choosing the Trashcan deletes the entry. In an embodiment, the user may reorder the answers, such as by dragging a question to a new position. The check box allows the user to mark the correct answer. Choosing an arrow here restores the UI to the default view.

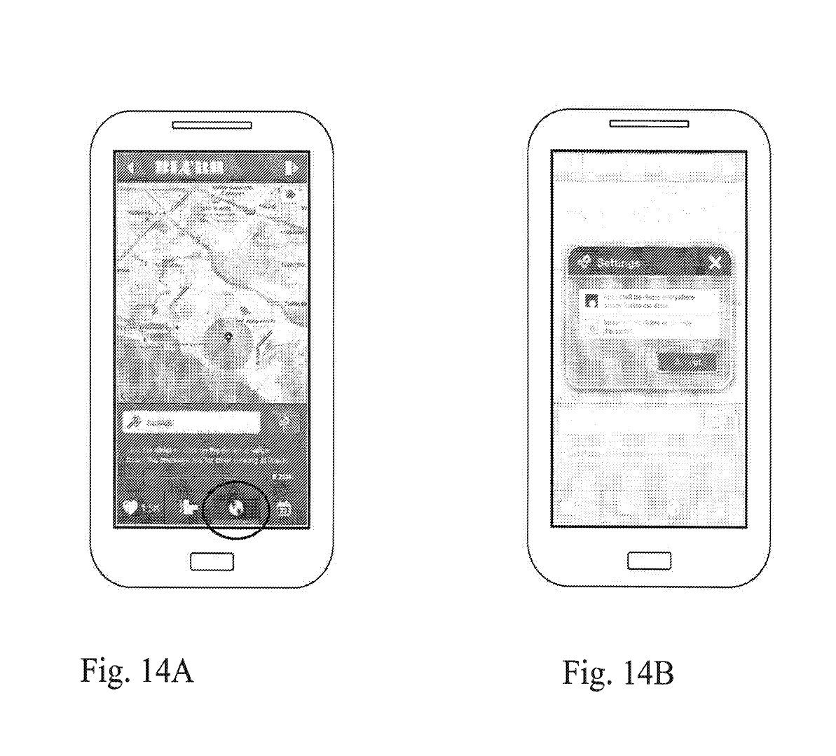

FIGS. 14A, B show a “Map View” of the app, invoked by selecting the Map View icon, bottom right center, to set geographical obfuscation attributes. As shown in FIG. 14A, the user may choose any point on the map to place a pin, to select a location at which obfuscation operations will be applied. In an embodiment, a default radius may be applied, as indicated by a circle having a default radius drawn around the pin, such as a circle with a radius of 0.25 mile. The operation of the slider may be modified to allow the user to dynamically scale the radius. In an embodiment, if the radius reaches the map boundary, the map may zoom out, such as by 2×, and the radius continues to scale. The inverse is true as the user slides the slider to the left to set a smaller radius. Then, as the radius reaches 25% of the screen, the map may zoom in by 2×. The pin may be dragged to a new location. Alternatively or in addition, pressing a new location on the map may move the pin and the radius circle to the new location. In an embodiment, Google Maps can be called to provide the map, and the user can click the Google target icon to locate themselves. Then the user may search using standard Google UI for search results and pin placement. Here, the gear icon may be selected to invoke a modal dialog window, shown in FIG. 14B. Illustratively, a single toggle control may be displayed for setting inclusion or exclusion for the target circle. That is, whether obfuscation will be applied to those within or outside the geographic boundary set by the target radius.

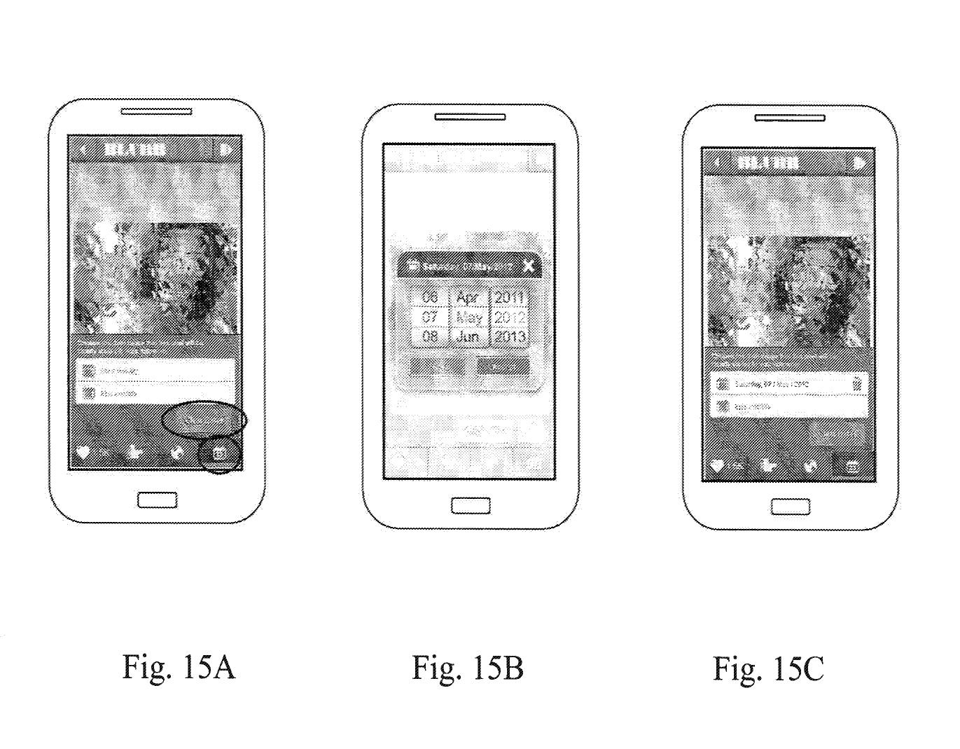

FIGS. 15A-C show a “Date View” of the app, invoked by selecting the Date View icon, bottom right, to set date/time obfuscation attributes. Here, the attributes are set as when visibility of the image will begin and when it will end. As shown in FIG. 15A, the user may press anywhere within either date window and the date picker appears. FIG. 15B shows the date picker for the field chosen, and FIG. 15C shows a confirmation screen that can be used to confirm or delete the dates set. Choosing the clear dates button will erase both dates.

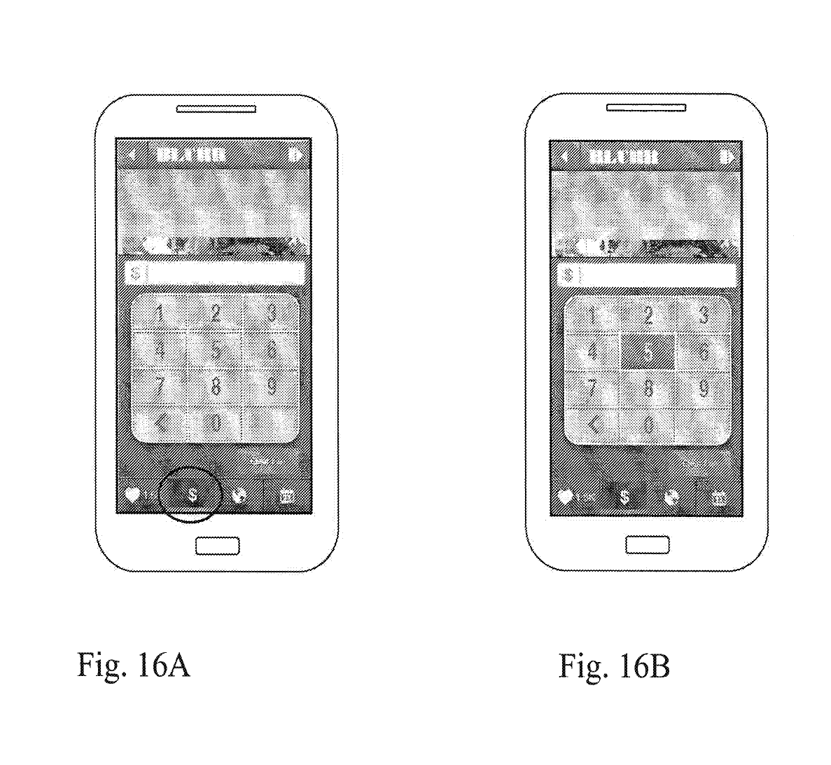

FIGS. 16A, B show an embodiment having a “Fee View” of the app, invoked by selecting the Fee View icon, bottom left center, to set fee-based obfuscation attributes. In FIG. 16A, the user may enter a fee required to participate in obfuscation operations. Illustratively, a fee may range from $1 to $1M, and no decimals or leading zeros may be entered, although other fee ranges, including cents or the like, may be used. In an embodiment, the field view may be autoformatted, such as with a currency denominator (e.g., “$”) and commas.

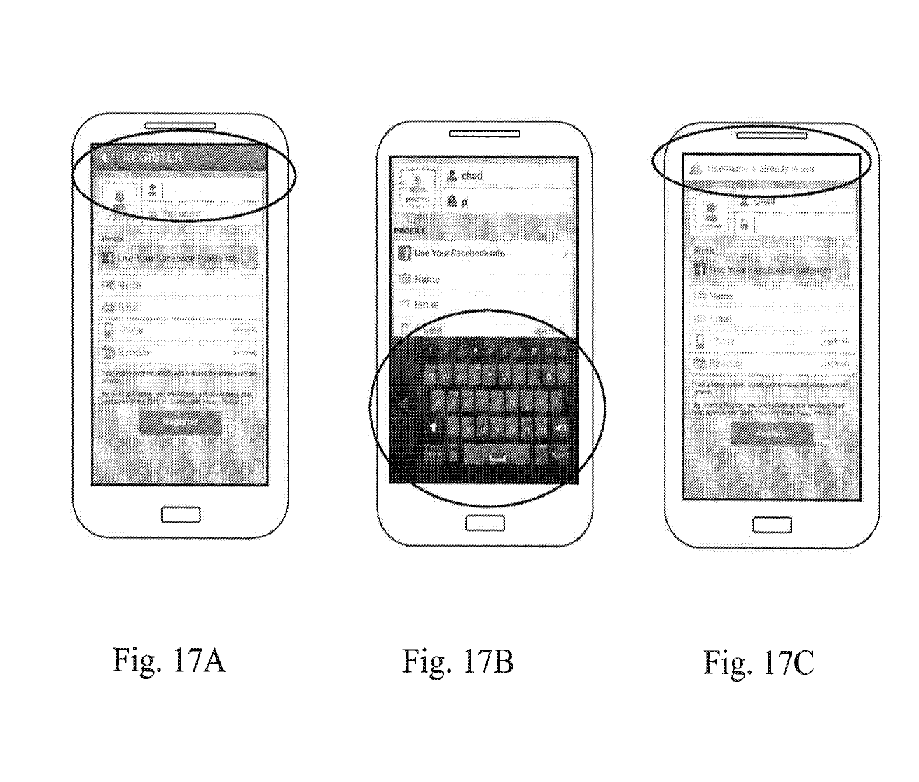

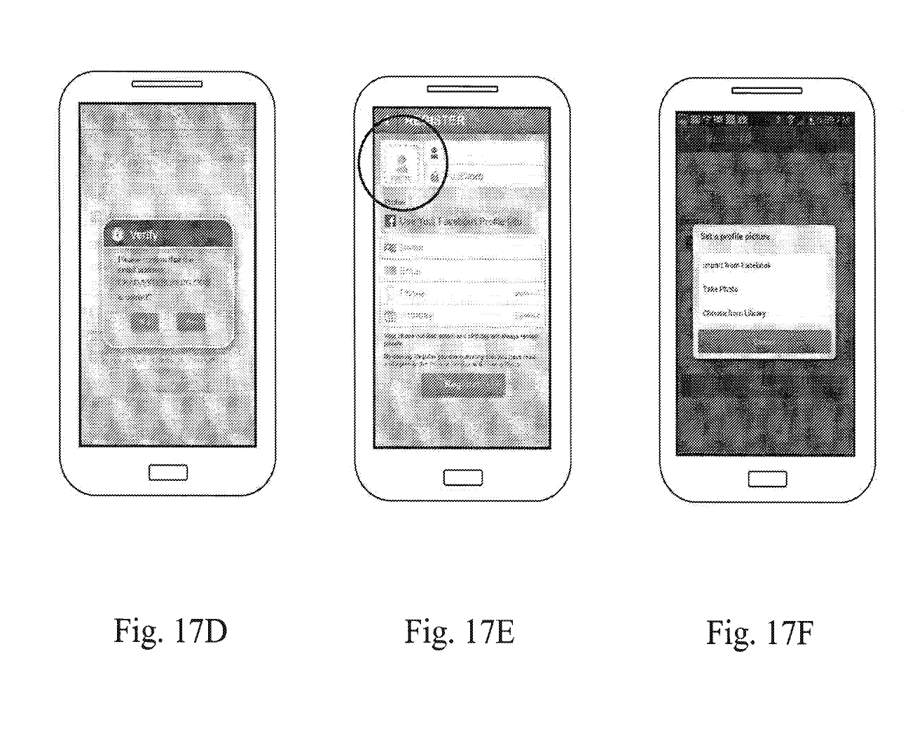

FIGS. 17A-F illustrate exemplary registration processes which may be invoked, for example, when first running the obfuscation application. In FIG. 17A, a user presses an input field such as the username field, and a virtual keyboard appears, 17B. The keyboard may be used to input username, password, and other profile information. Error messages, and confirmation messages may be presented as appropriate, 17C, 17D respectively. Also where appropriate, such as when selecting a personal profile photo 17E, options may be presented for user selection, 17F.

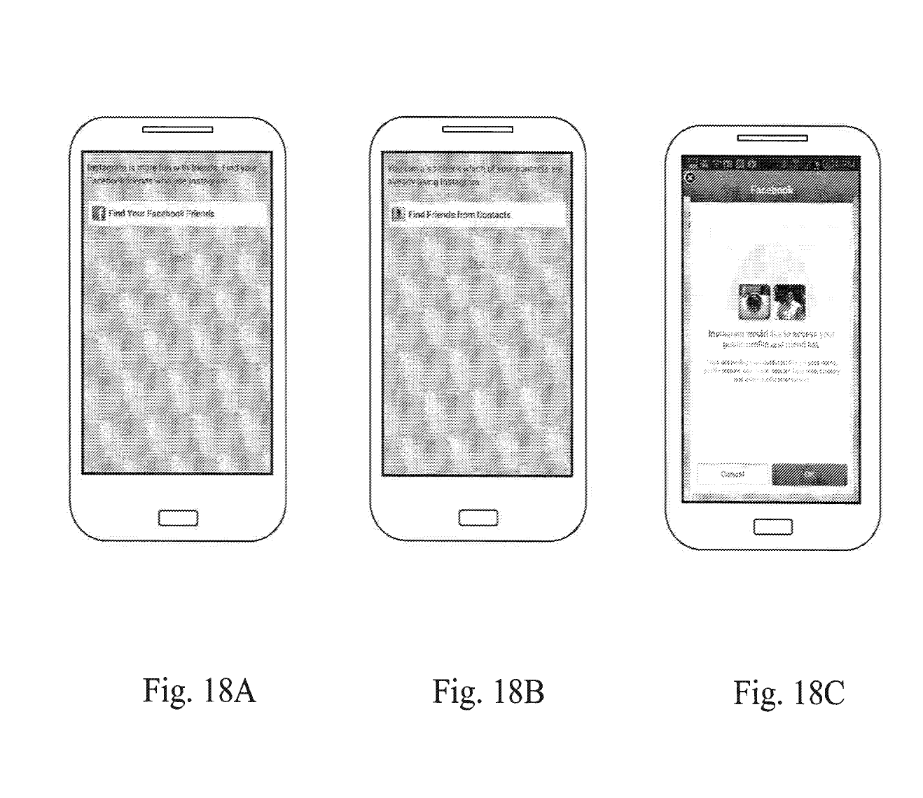

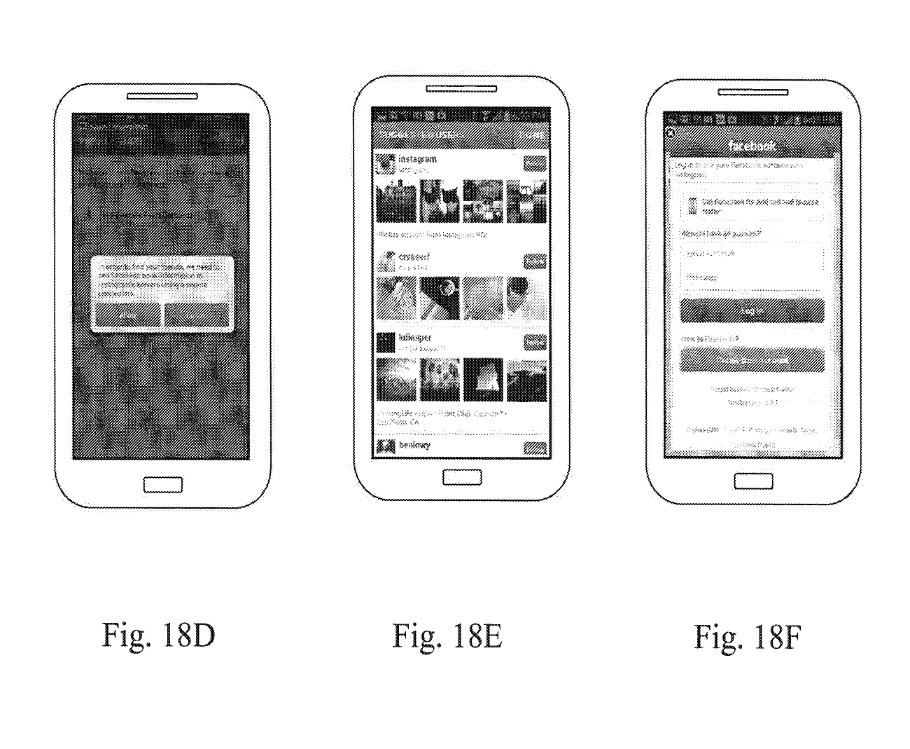

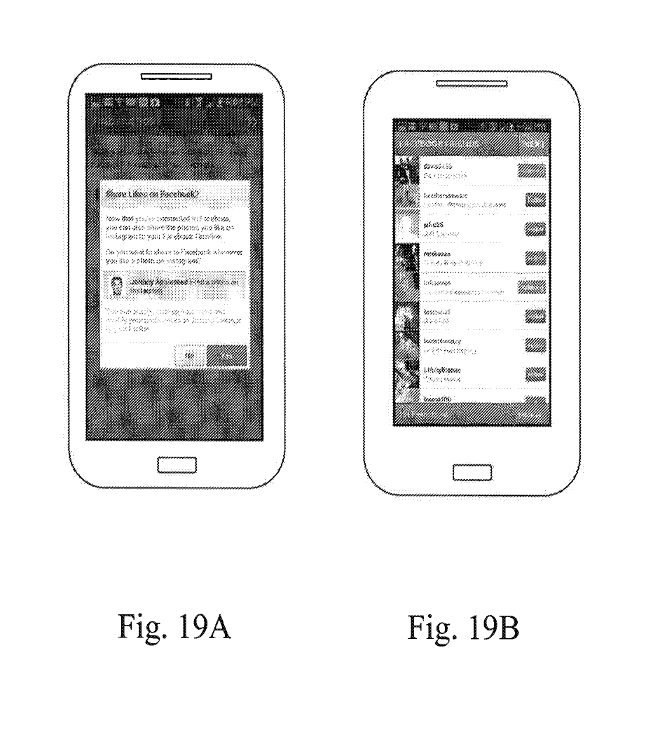

The obfuscation app may be integrated with third party apps. For example, obfuscation operations may be integrated with Facebook and/or Instagram, although other third party apps may also be extended to include obfuscation operations, as shown in FIGS. 18A-18F. Likewise, FIGS. 19A, 19B illustrate interoperation of the obfuscation app and Facebook.

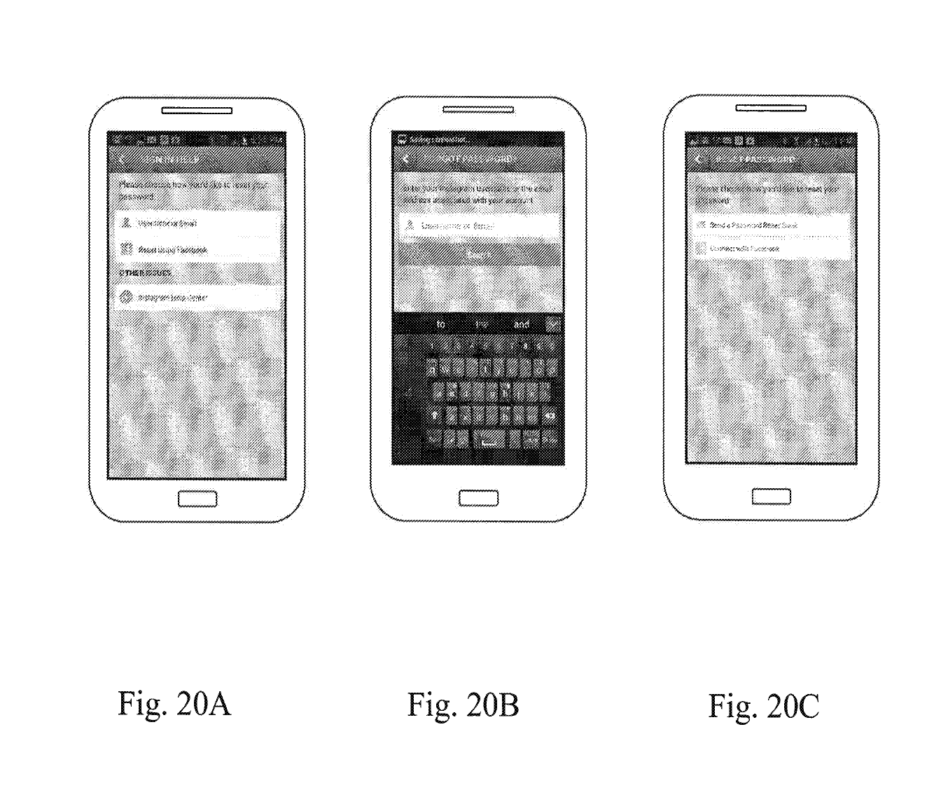

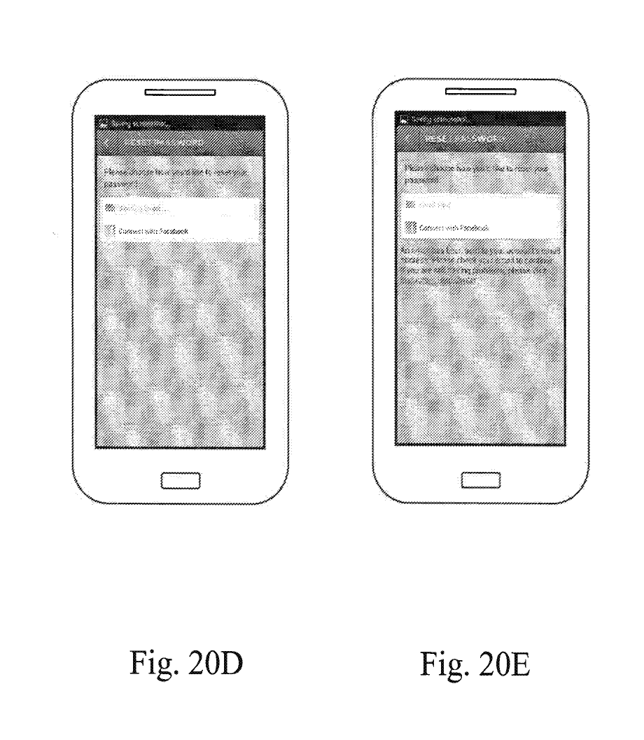

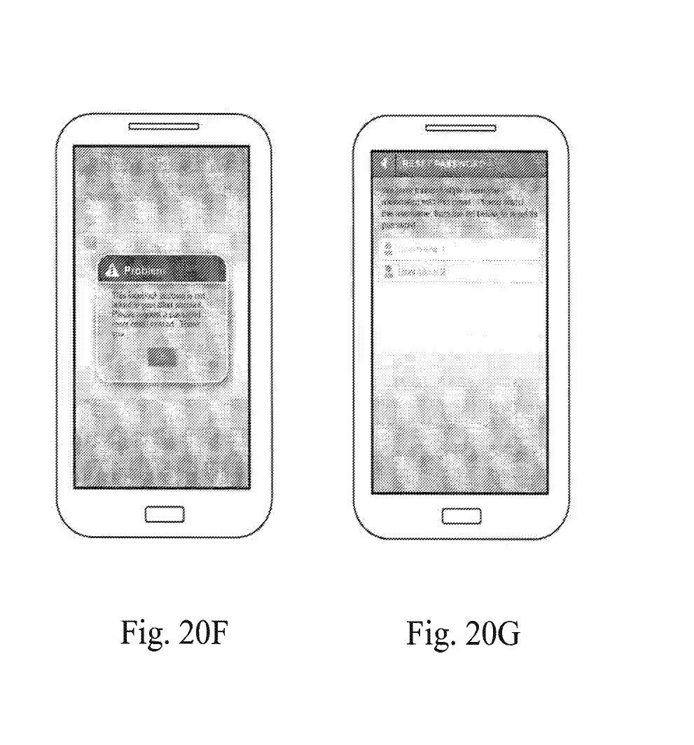

FIGS. 20A-G illustrate user terminal screens in an exemplary implementation in which a user resets their login password. In FIGS. 20A-E, the password is reset with the obfuscation app operating in a standalone mode, although the password reset may alternatively be integrated with the operation of a third party app. FIGS. 20F, G show exemplary screen shots pertaining to unexpected results when resetting a password in connection with a third party app.

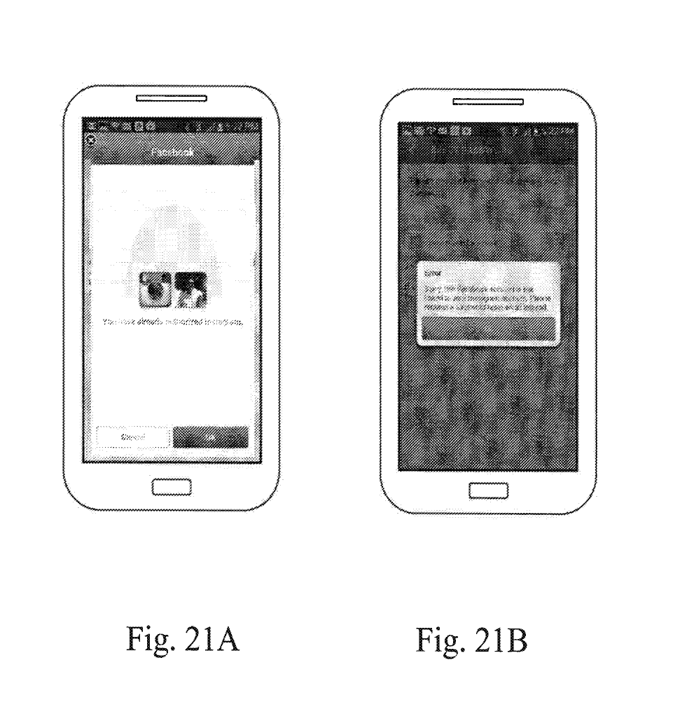

FIGS. 21A, B show exemplary screenshots regarding unexpected results in connection with the obfuscation app cooperating with third party apps.

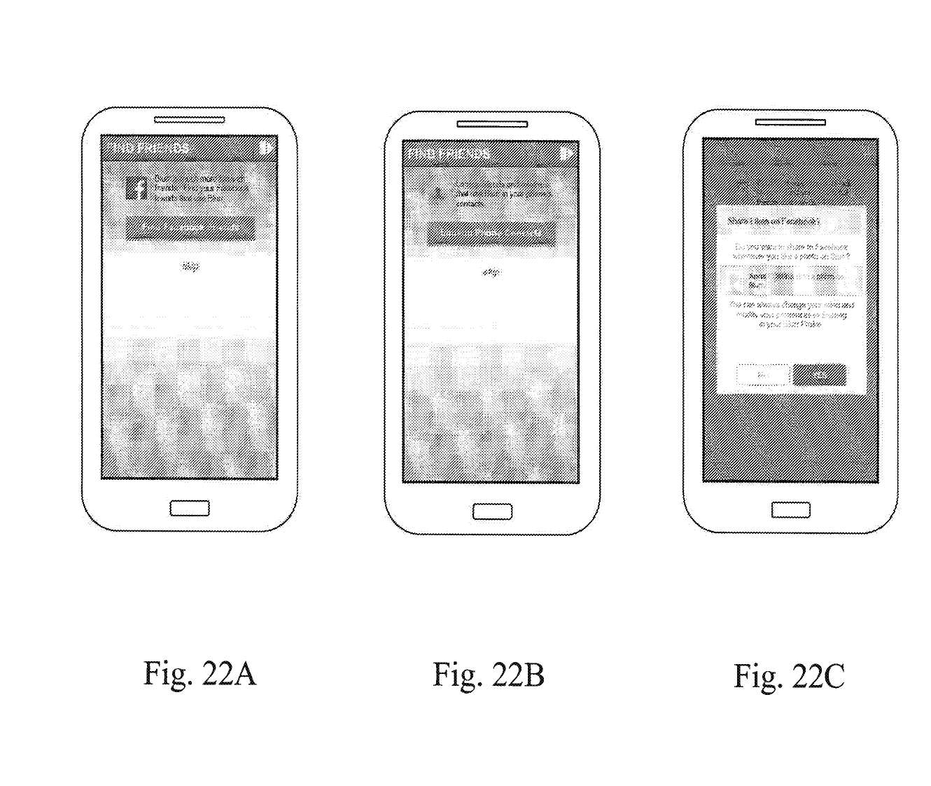

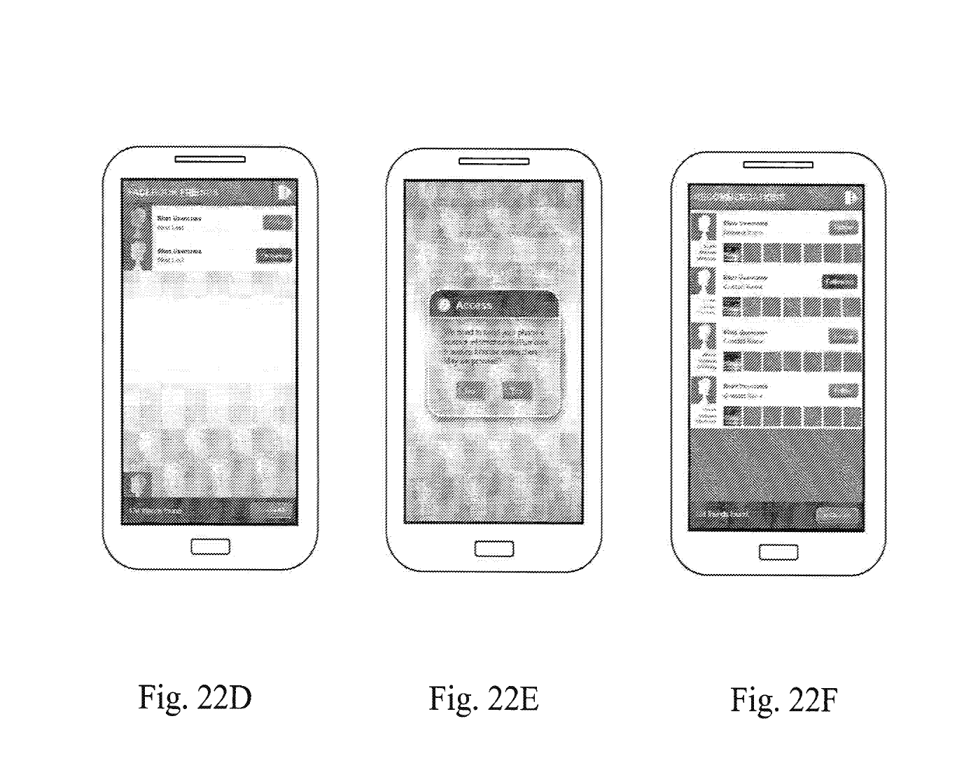

FIGS. 22A-F show exemplary screenshots pertaining to using third party app mechanisms in connection with obfuscation app operations, in this case, taking advantage of Facebook friends, and contacts stored locally on the user terminal.

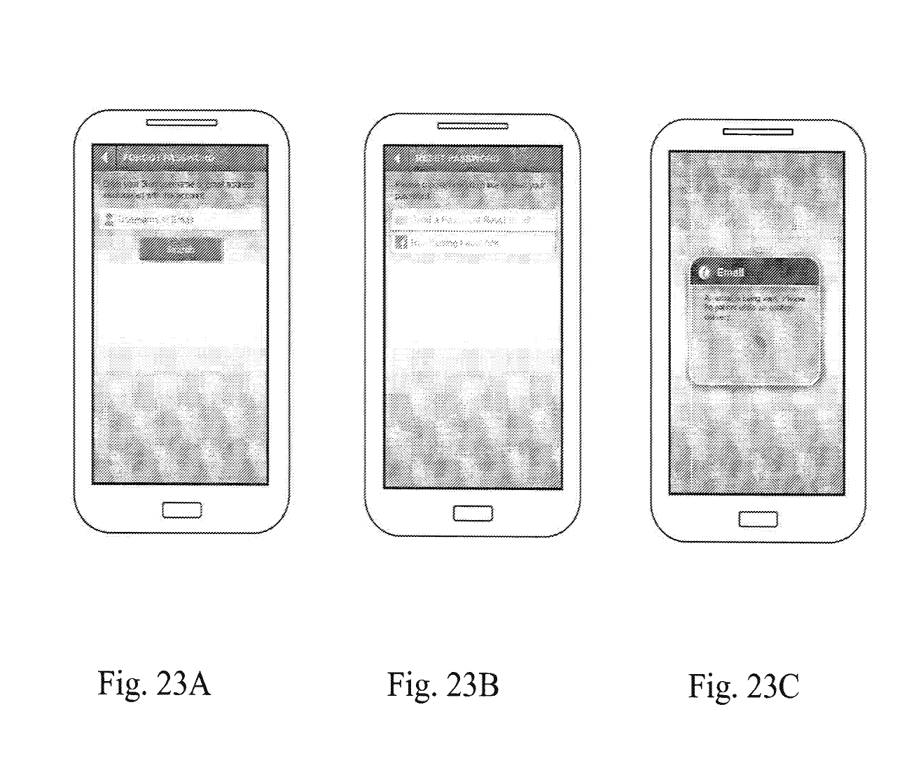

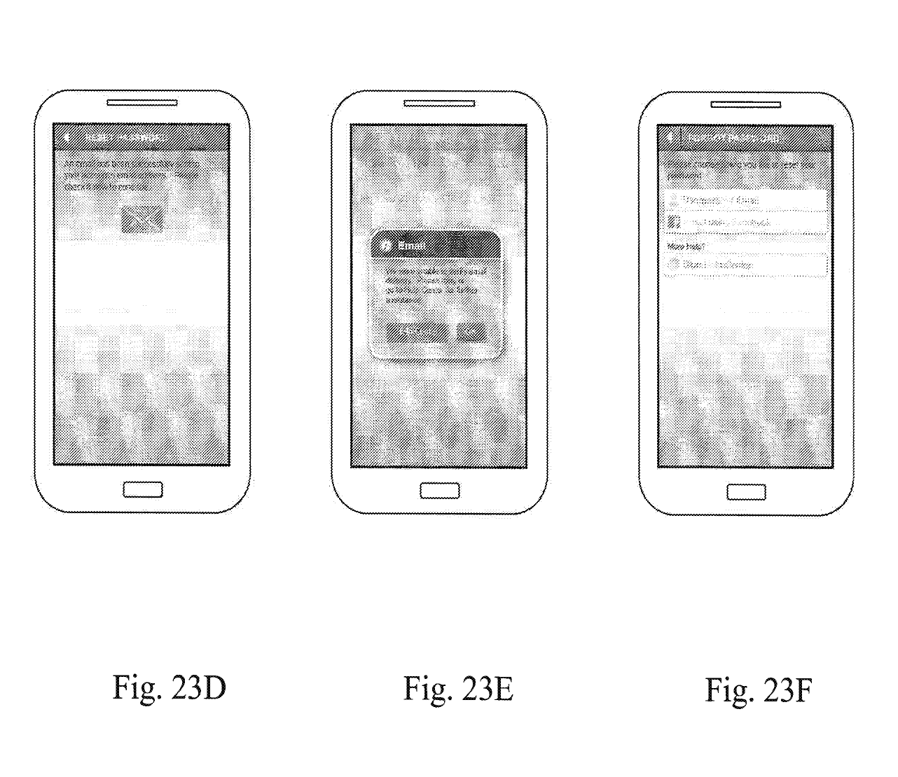

FIGS. 23A-F show exemplary screenshots pertaining to resetting a user password within the obfuscation app in a standalone mode.

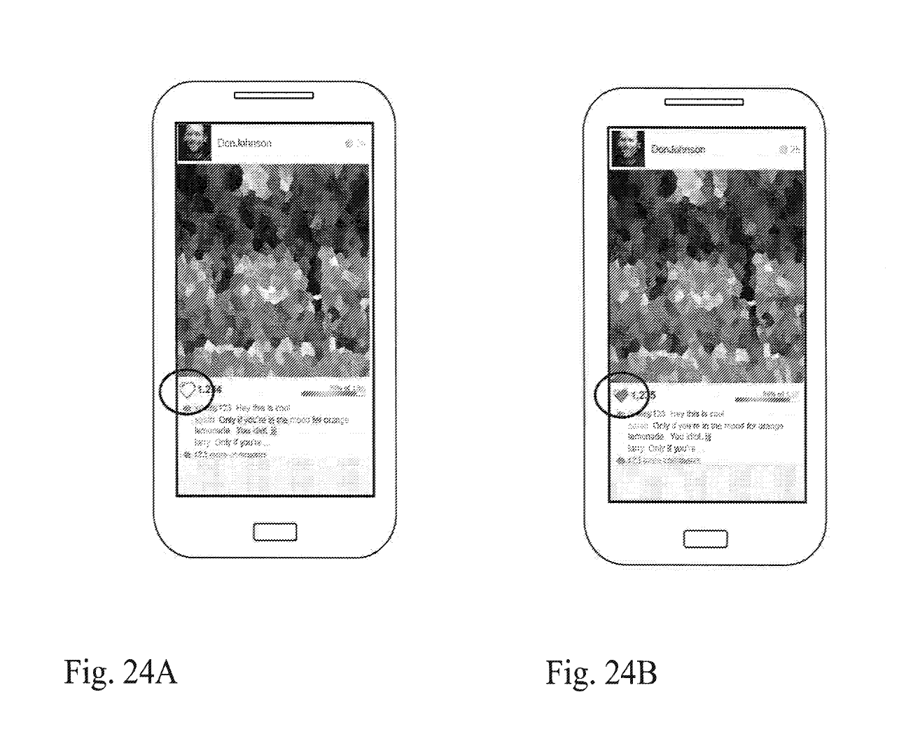

FIGS. 24A, B show illustrative obfuscation app operations. In FIG. 24A, a user chooses the heart icon to like an obfuscated photo being displayed. In the embodiment, the user can only view photos from users they are following. FIG. 24B shows the heart changing its state to show the like state, and the number of likes is incremented.

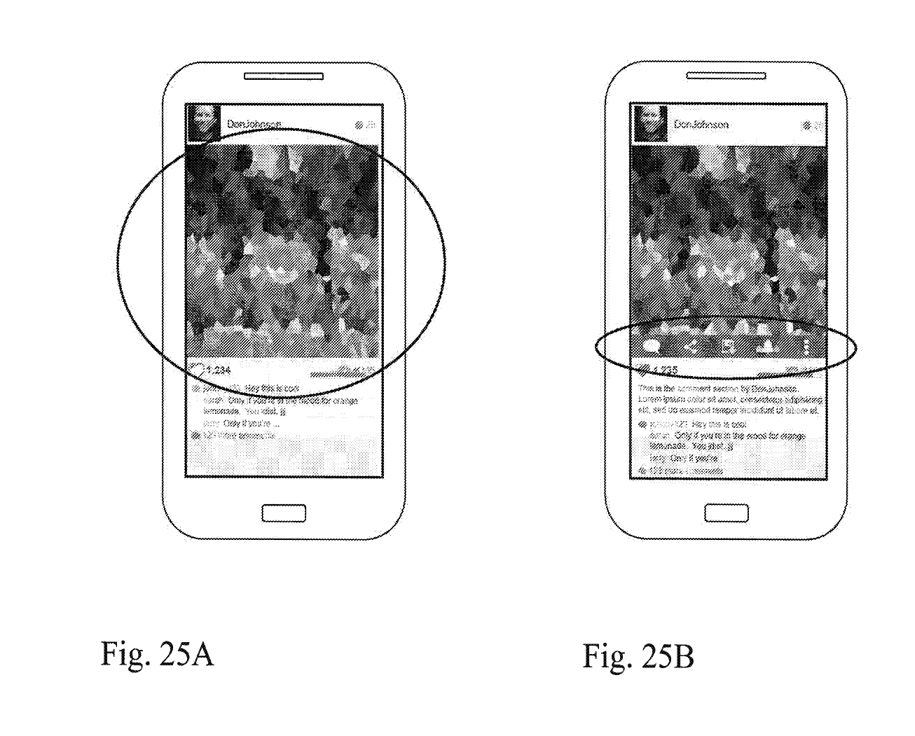

In FIG. 25A, the user selects the image to bring up the post menu. In 25B, the post menu appears.

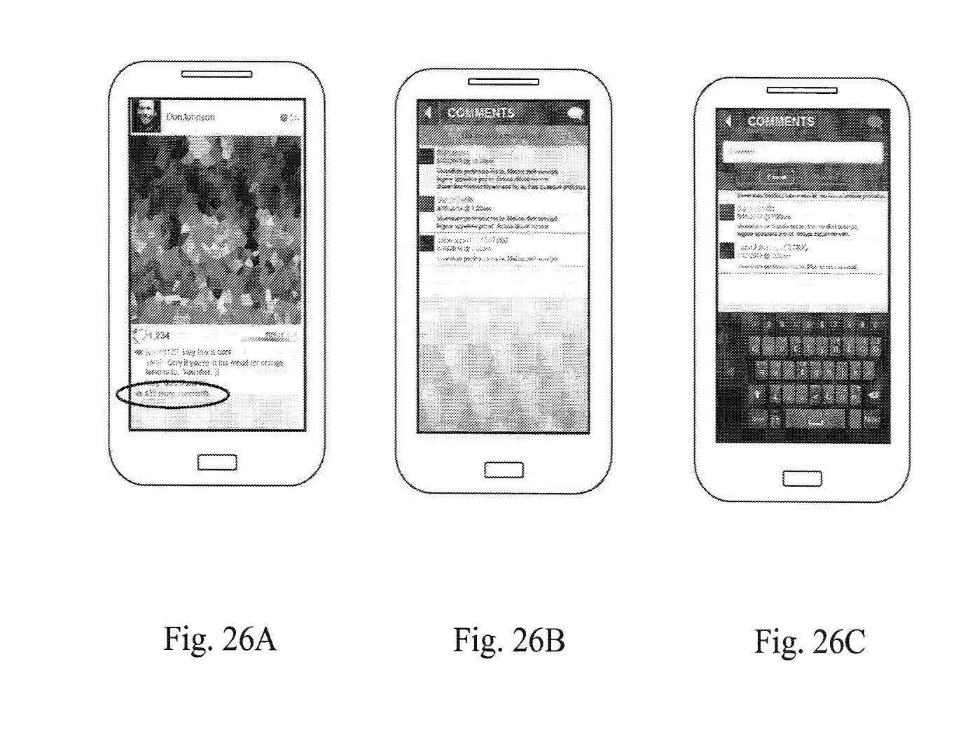

In FIG. 26A, the user selects “123 more comments”, to show the comments screen, 26B. FIG. 26C shows that the comments are scrollable while the comment window is up. A virtual keyboard may be used to write comments, which may be sent, that is, published, using a send button. The comment panel on this screen may be dismissed by canceling, sending, or choosing the blue comment icon.

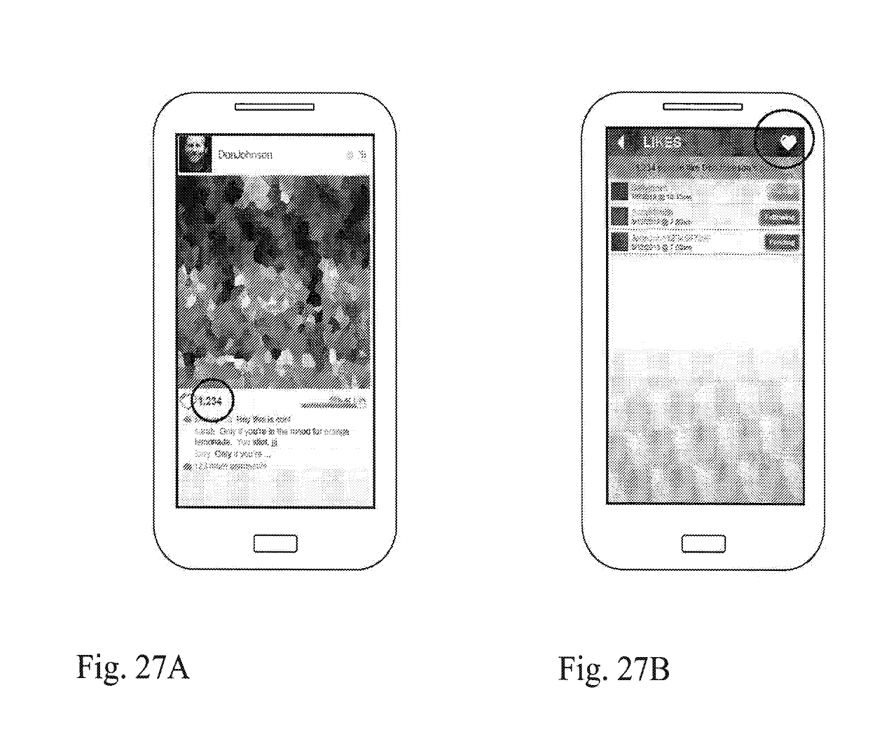

In FIG. 27A, the user selects the number of likes “1234” to view the list of users that liked the post, 27B. The list of likes presents the “follow”, “following”, and “pending” states. For example, the pending state is shown for a user, in this case “john-john12345456890”, to approve the viewer's follow request. Illustratively, approval may be required when a user “locks” their account, which is done through the user profile editing screen. Clicking the heart in the upper right, 27B, will “like” this post, and the heart may change its state.

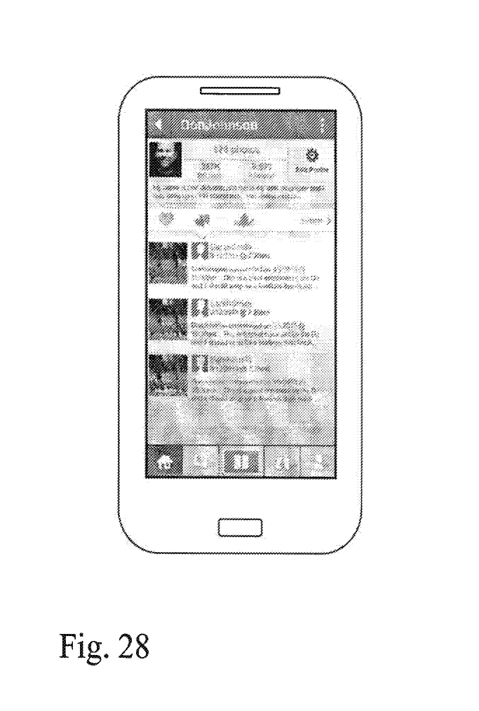

FIG. 28 shows a user viewing comments.

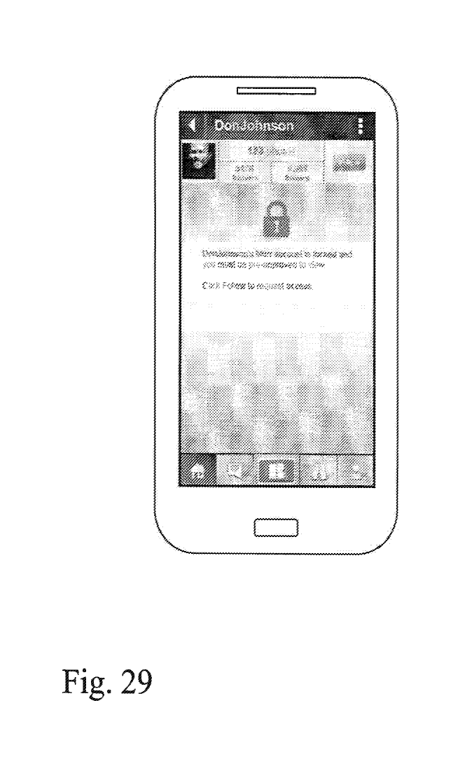

FIG. 29 shows a user attempting to view a locked profile.

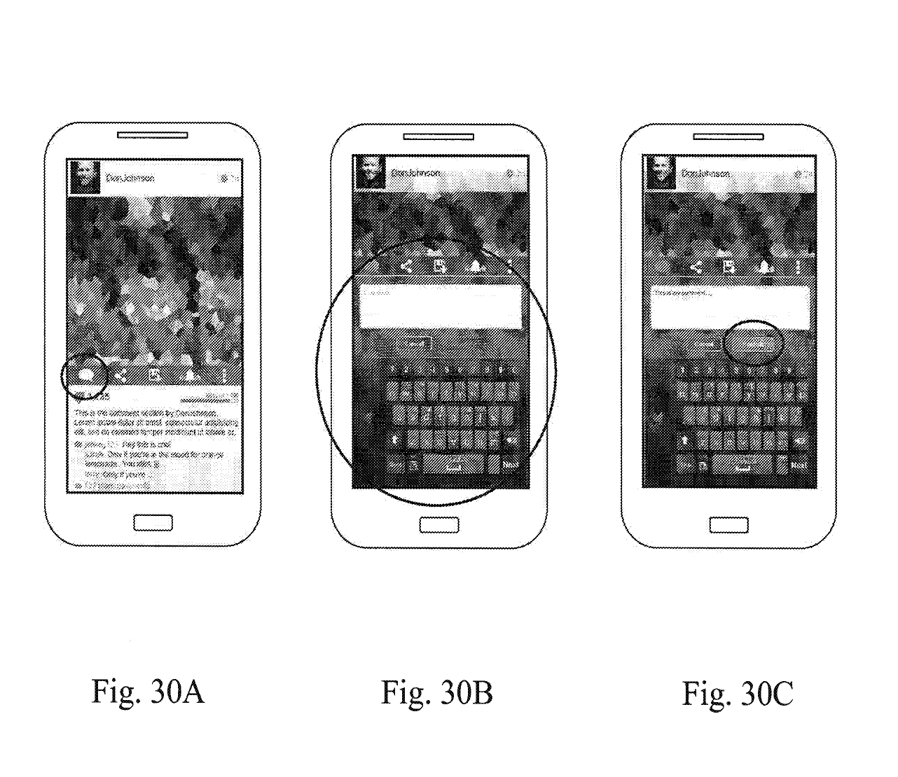

In FIG. 30, a user chooses the “comment” icon to comment on a post. A comment panel animates up for the user to write a comment. Before a comment is begun a cancel button is active, 30B, and after a comment is begun a publish button is active, 30C. To lower the panel, the user may press anywhere off the panel, or may select another menu button. In an embodiment, the length of comments may be limited, for example, limited to the twitter comment max length.

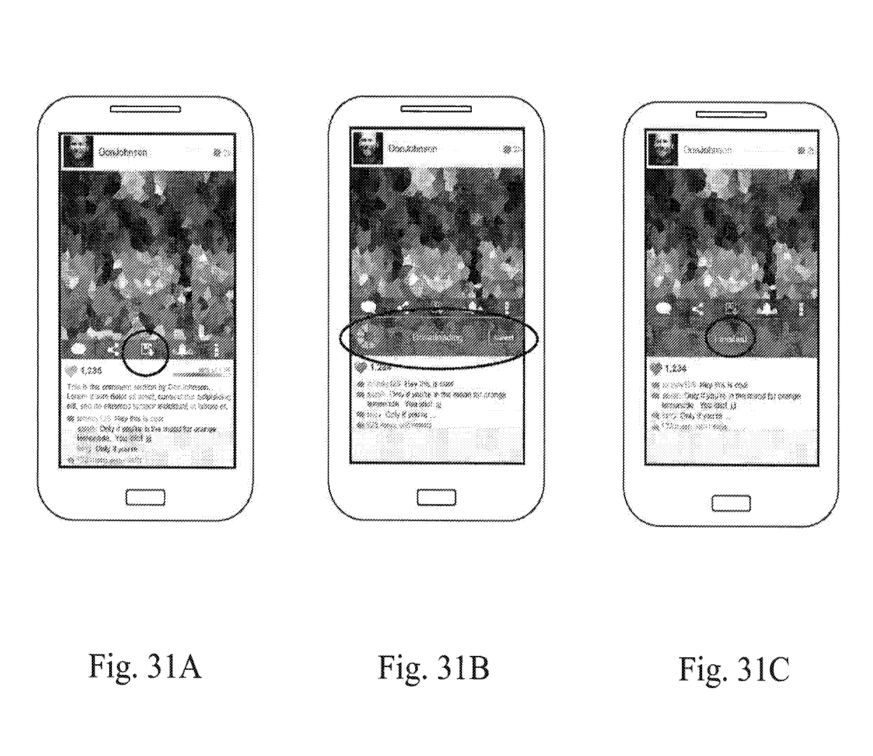

In FIG. 31A, the user selects a “download” icon to copy the image shown to the user terminal's photo library. A download panel may animate up, 31B. A loading screen may be displayed, such as for a minimum of one second. When the download is completed, or a minimum time is reached, the panel may fade. When complete, the panel may transition to a finished state, 31C. The panel may animate down after a predetermined delay, such as one second.

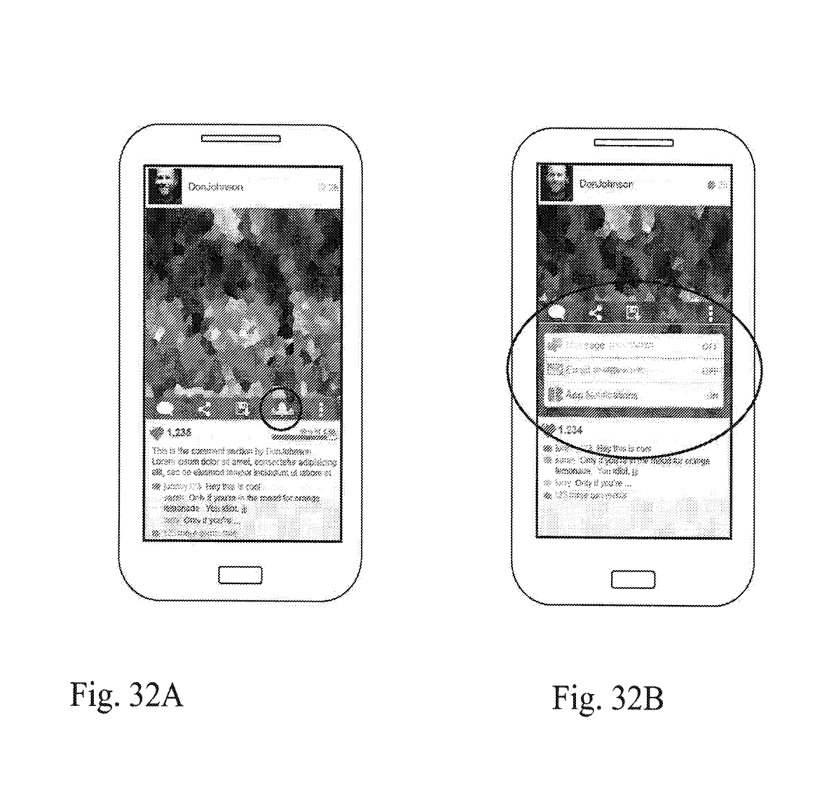

FIG. 32A shows setting an alert, wherein the user selecting the bell icon causes an alerting panel to animate up, 32B. Three alert options may be provided, all defaulted to off. Since mobile messaging requires a phone number (which is an optional registration field), if that field is not provided selecting the mobile messaging field may open a field, such as a main menu field, to input that value. When an alert is set, the alert icon may change state.

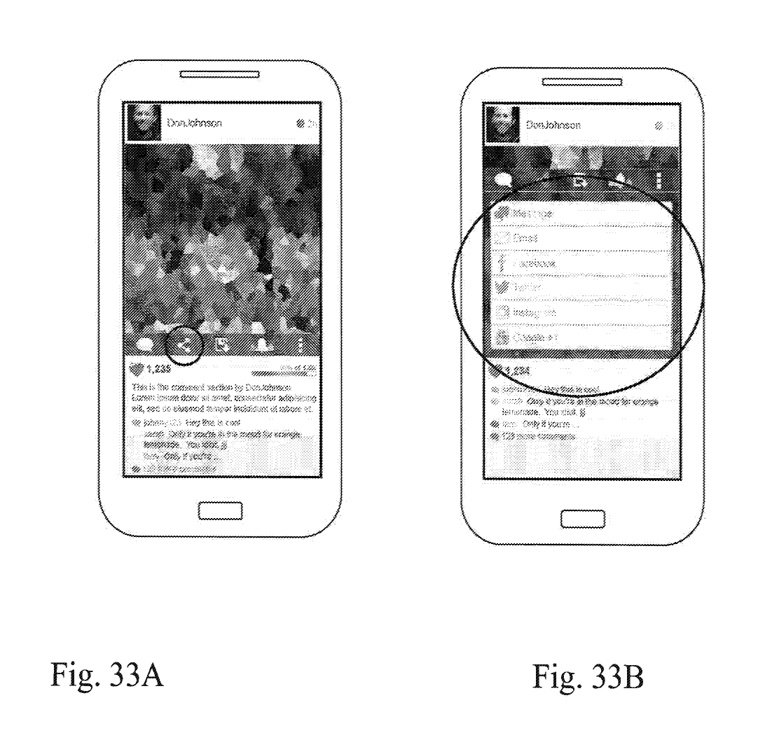

In FIG. 33A the user selects a share icon to share a post, which causes a share menu to appear, 33B, from which the user selects a share method.

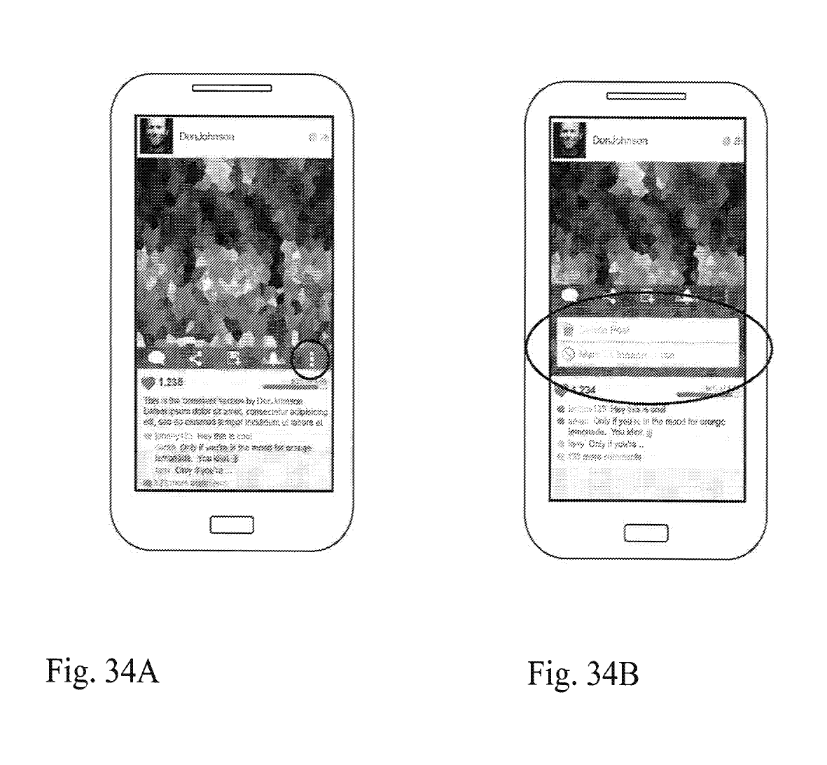

In FIG. 34A, the user selects the icon for additional menu options. In the exemplary embodiment, delete and mark options are shown, 34B.

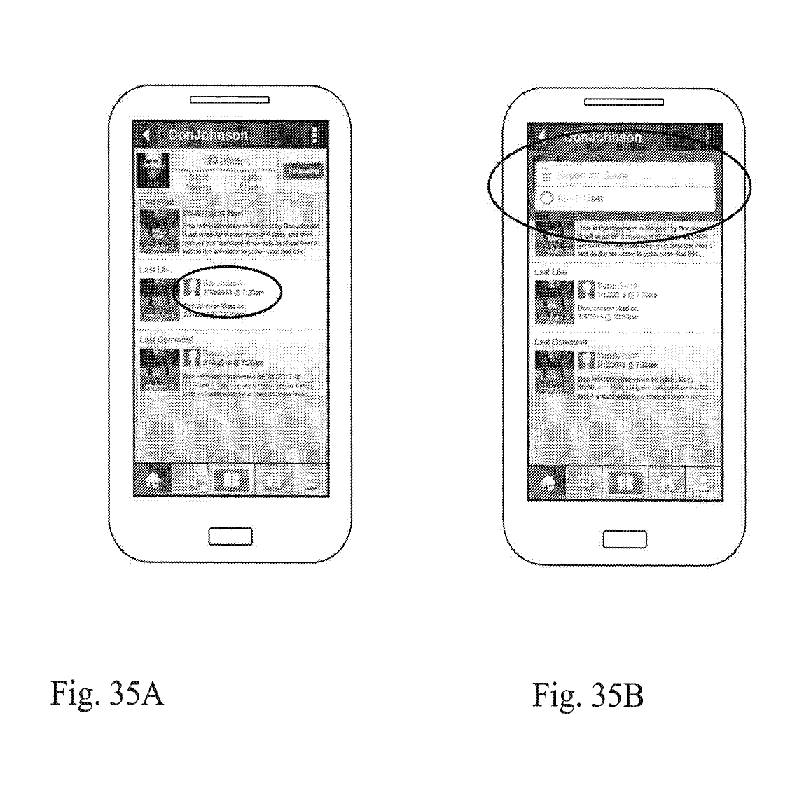

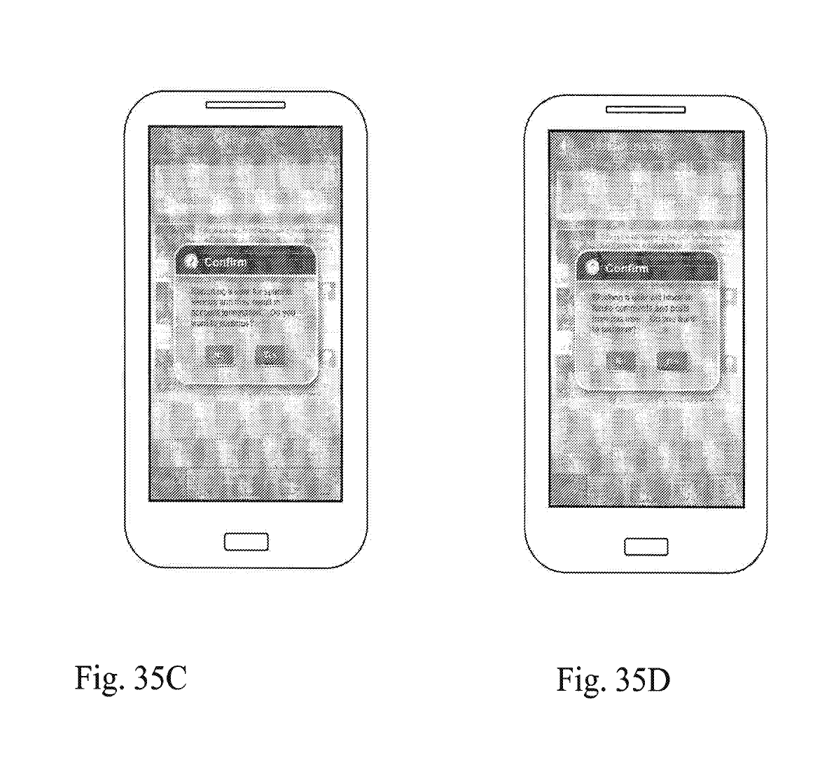

FIG. 35A shows a user selecting another user's name in the app, which may cause a menu of options pertaining to the selected name to animate down, 35B. In the illustrated exemplary embodiment, the options are to report the selected user for sending spam, or to block that user's access to the current user's account. Selecting either option causes a popup message to appear, 35C, 35D respectively.

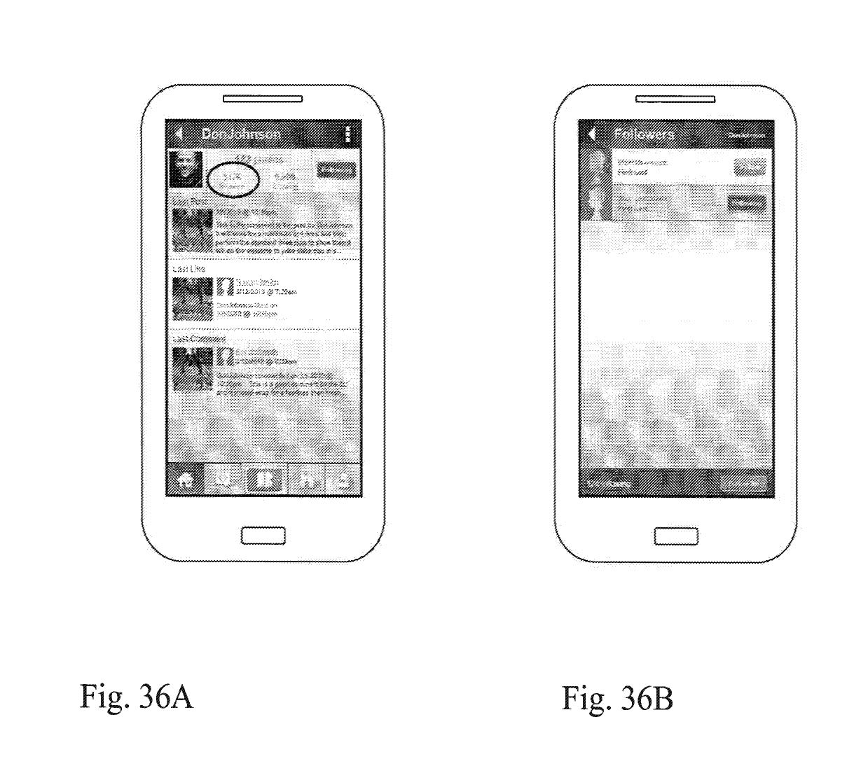

FIG. 36A shows a list of users other than the logged in user, shown when the user chooses any name in the app. Followers of the current users may be displayed by selecting the followers box, 36B.

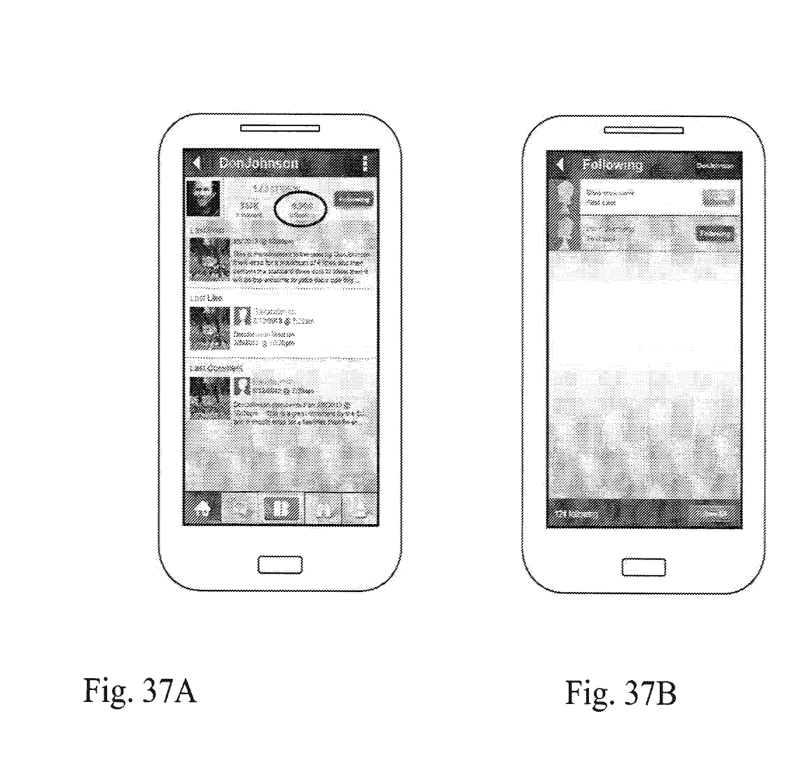

FIG. 37A shows the list of users other than the logged in user. Choosing the following box shows a list of other users the current user is following, 37B.

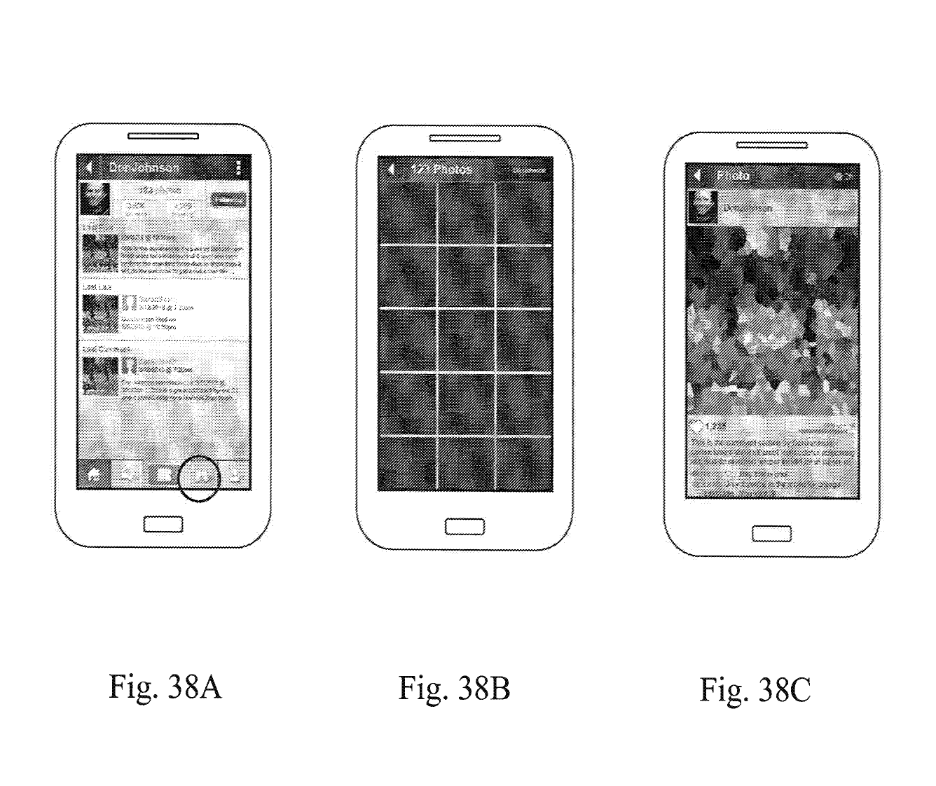

FIG. 38A shows the list of users other than the logged in user. Selecting a view photo icon may invoke presenting a grid of photos, 38B. One of the photos may be selected for applying obfuscation operations, 38C.

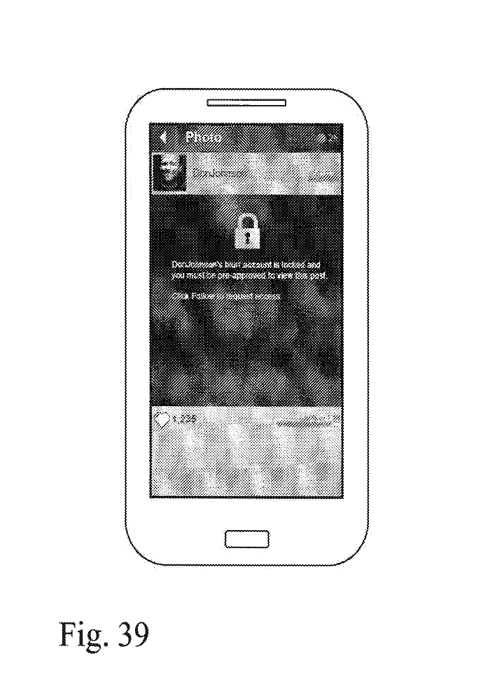

FIG. 39 shows a message displayed to a user trying to access another user's locked account, with instructions on how to request access.

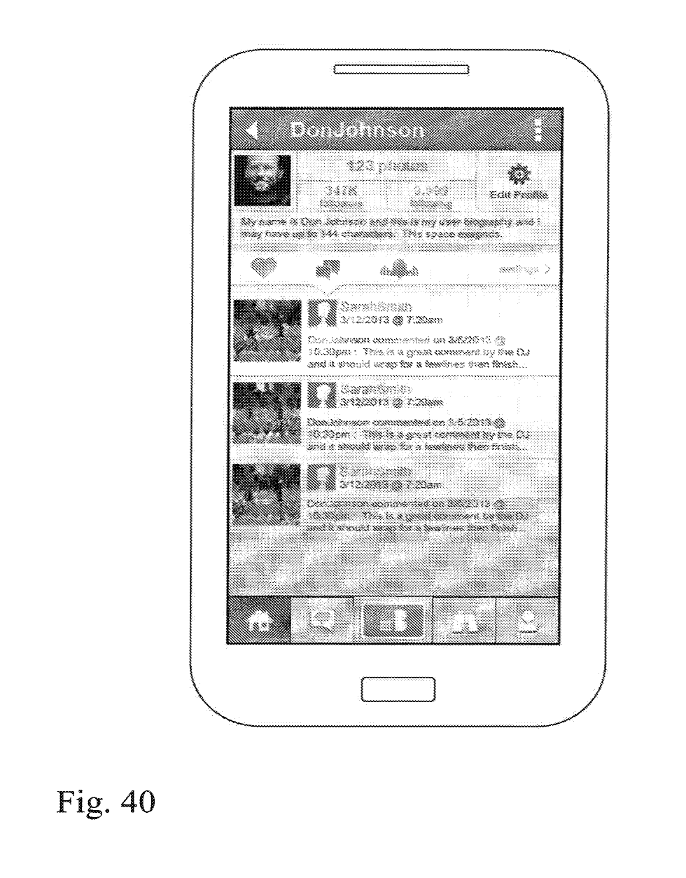

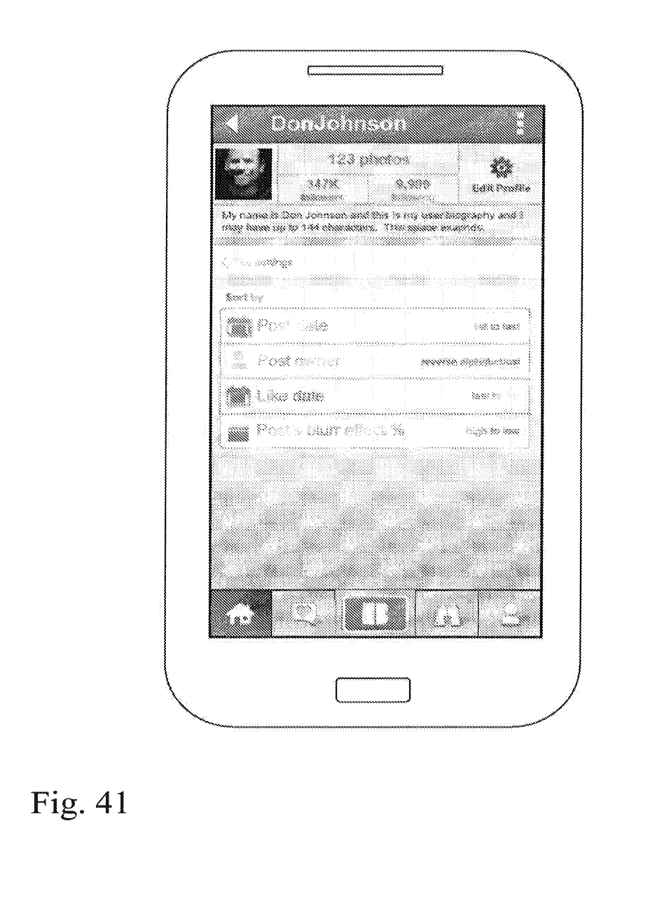

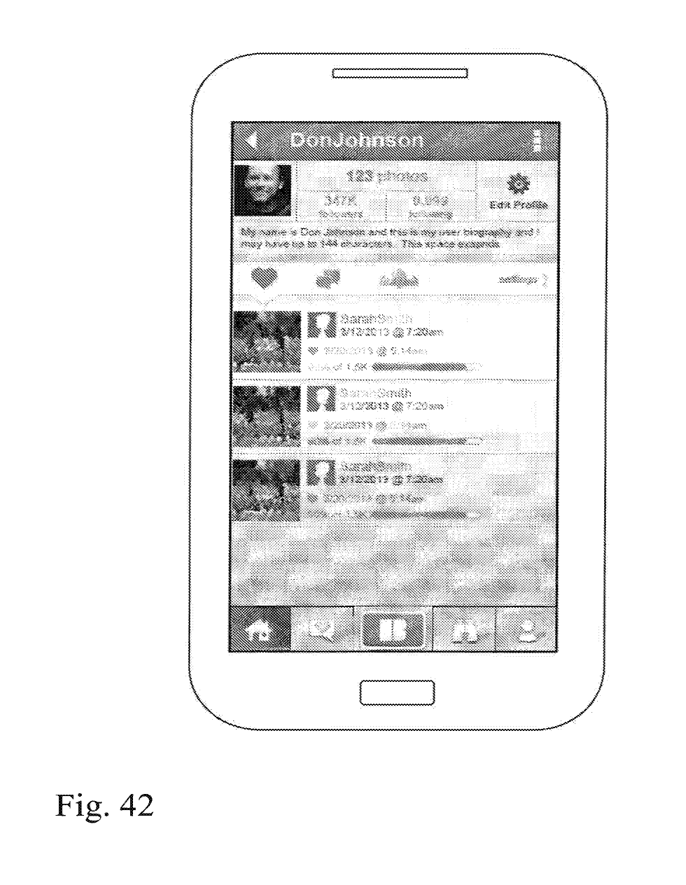

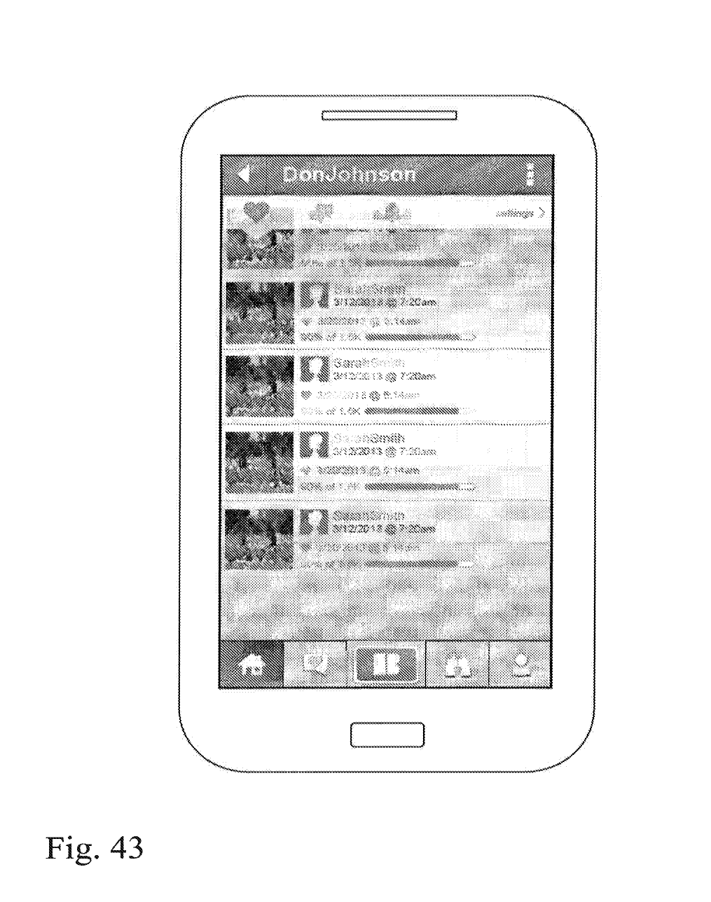

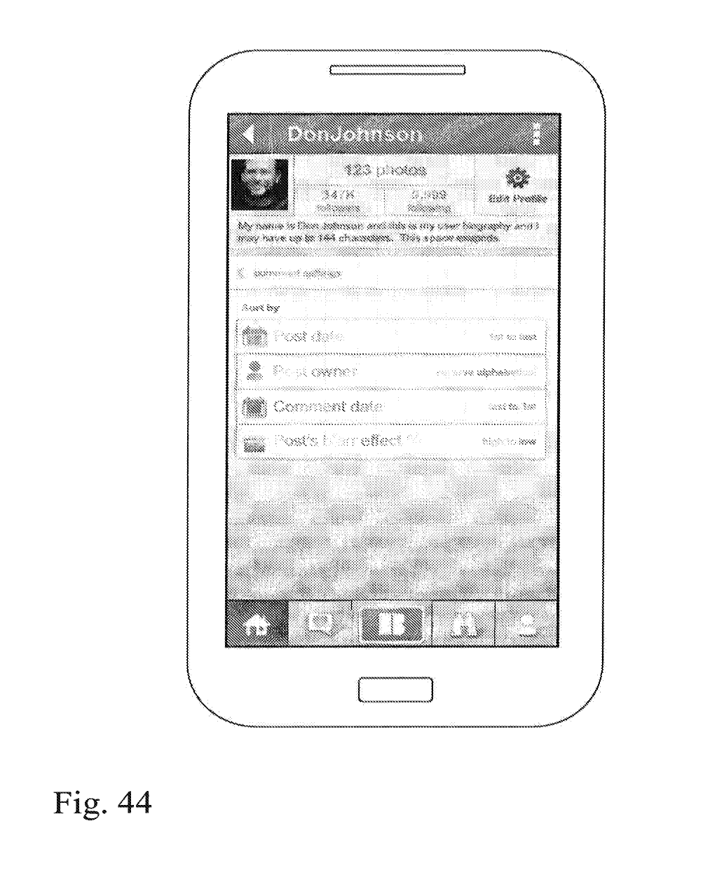

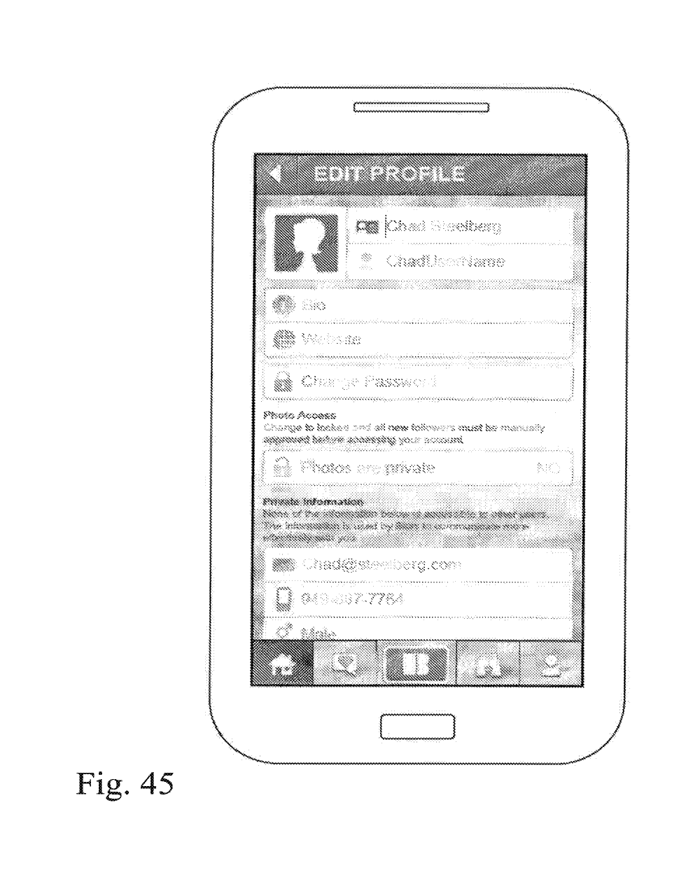

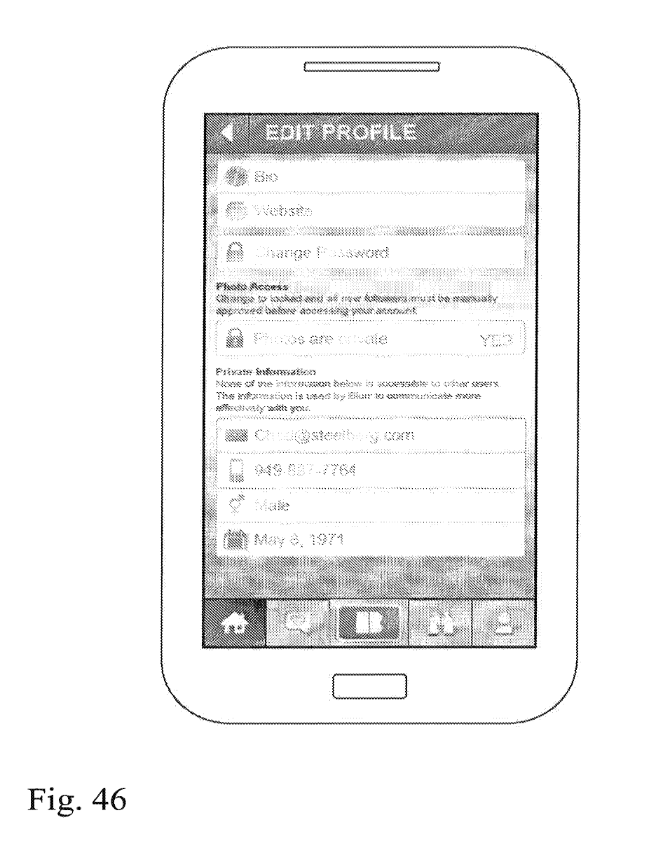

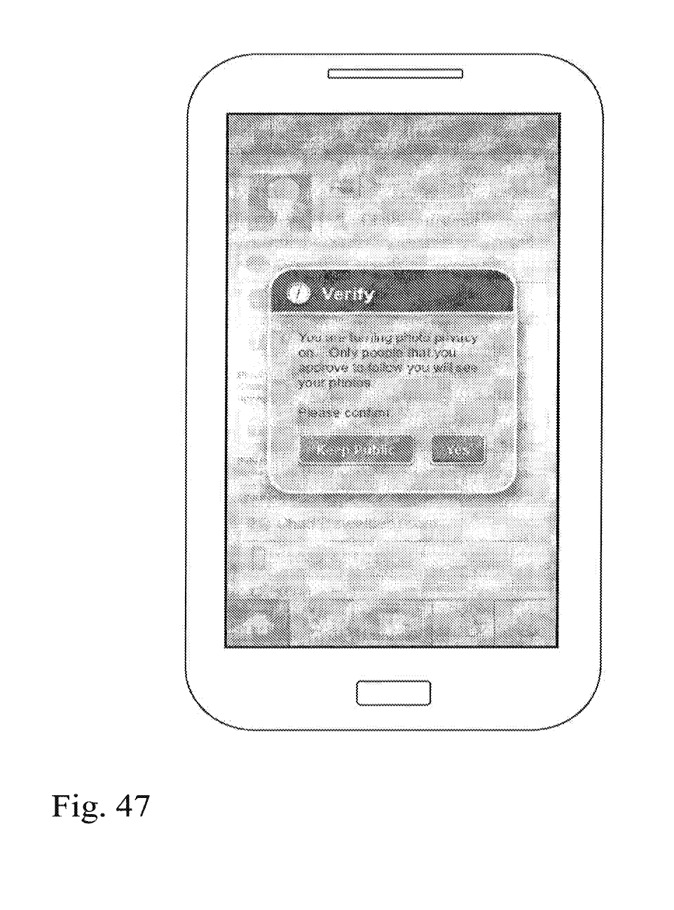

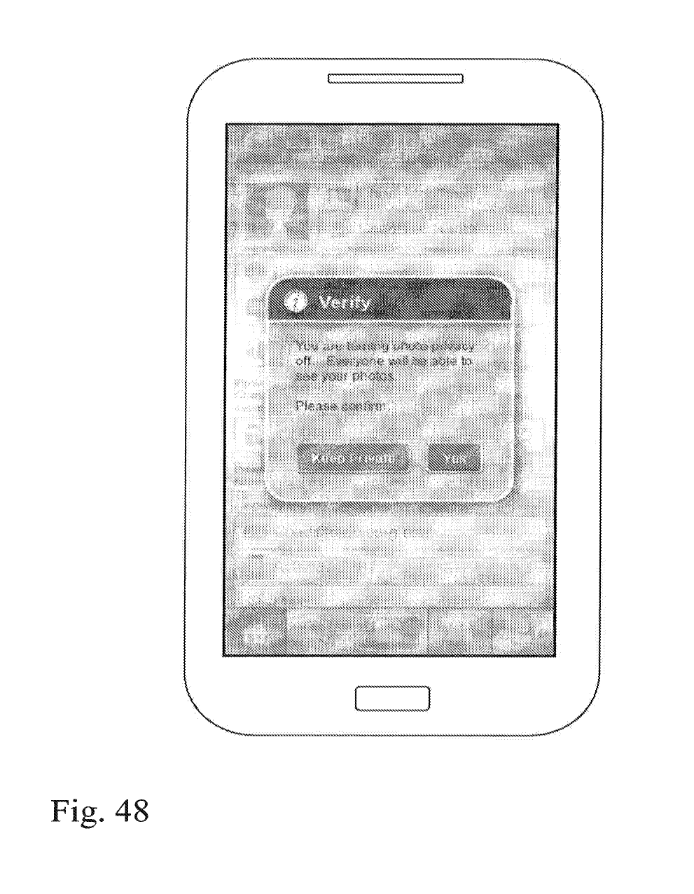

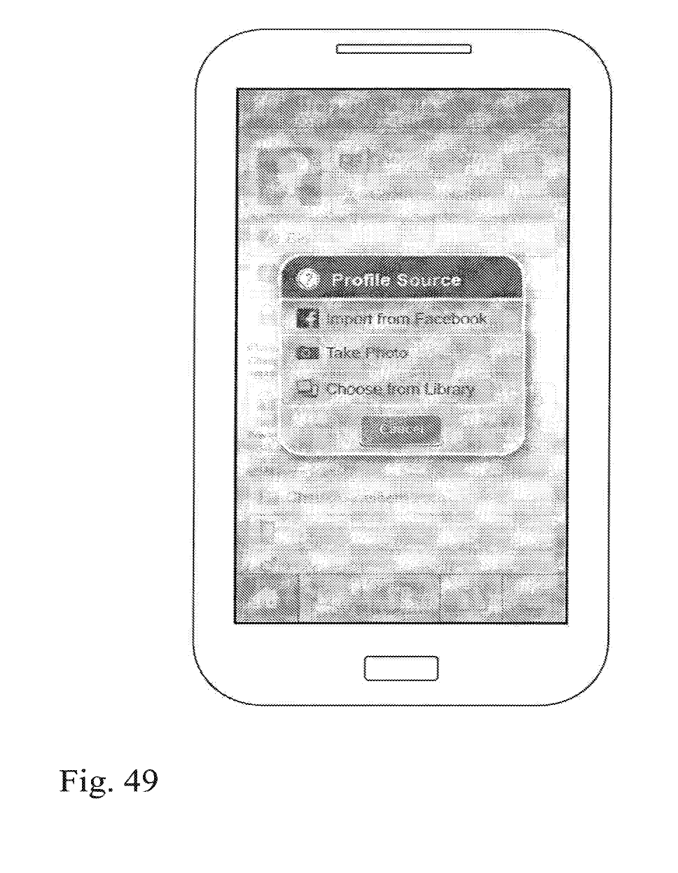

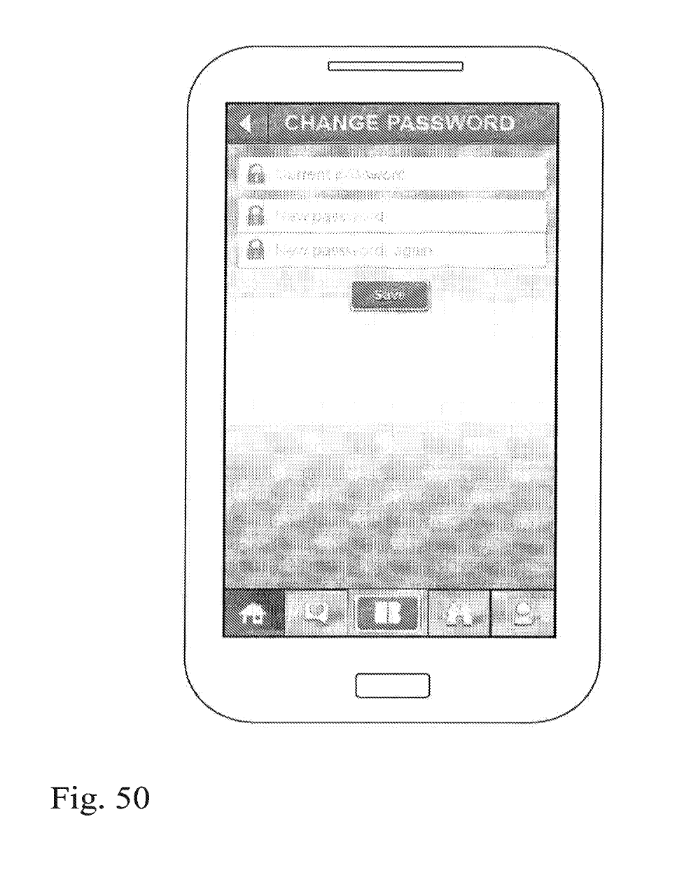

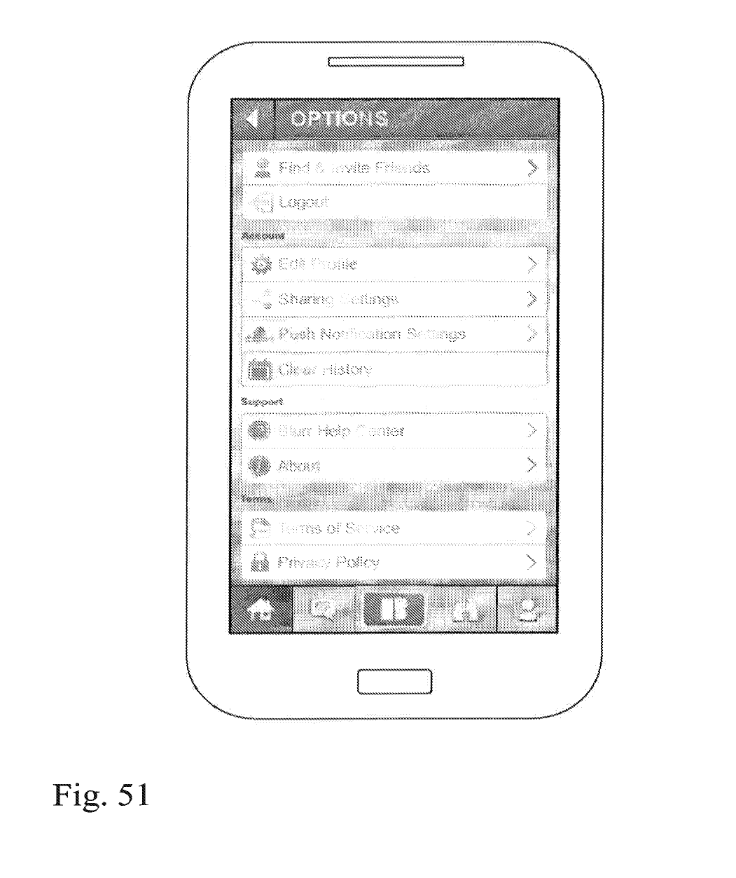

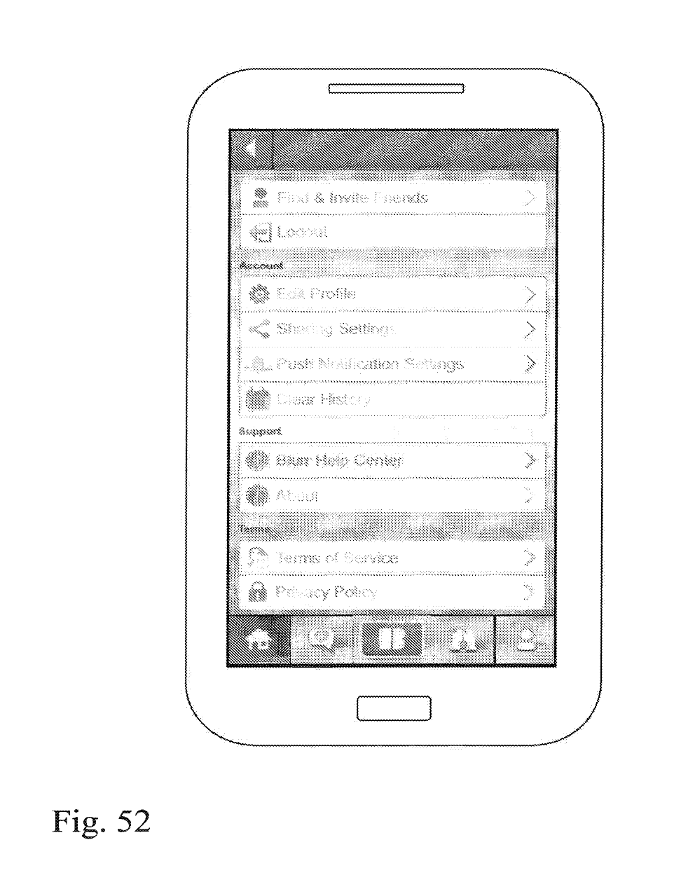

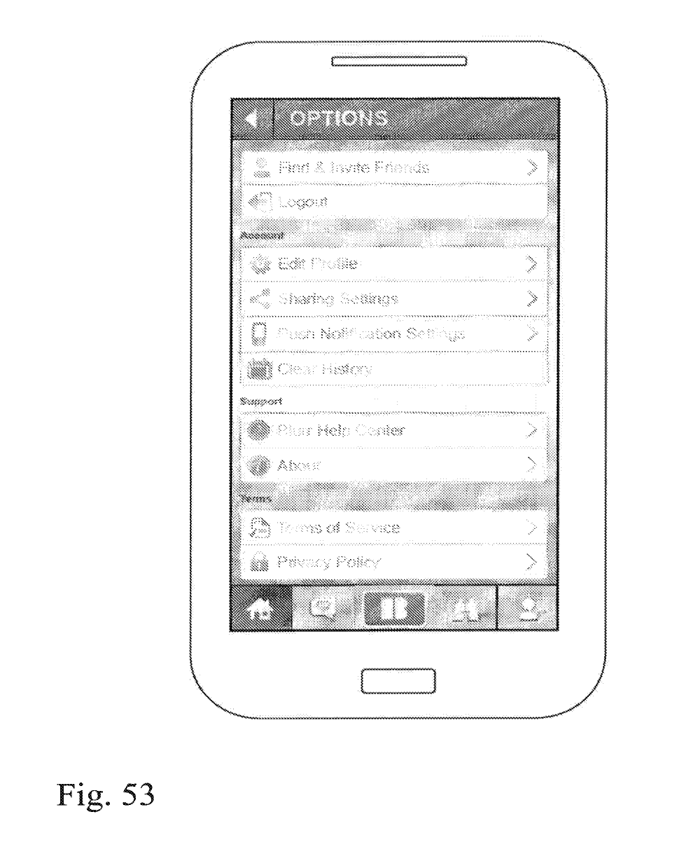

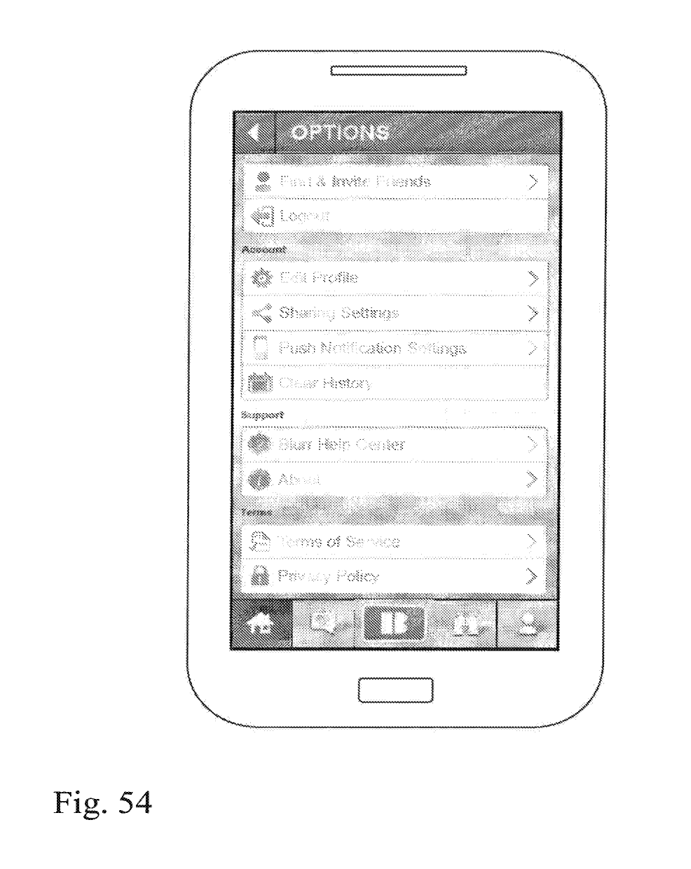

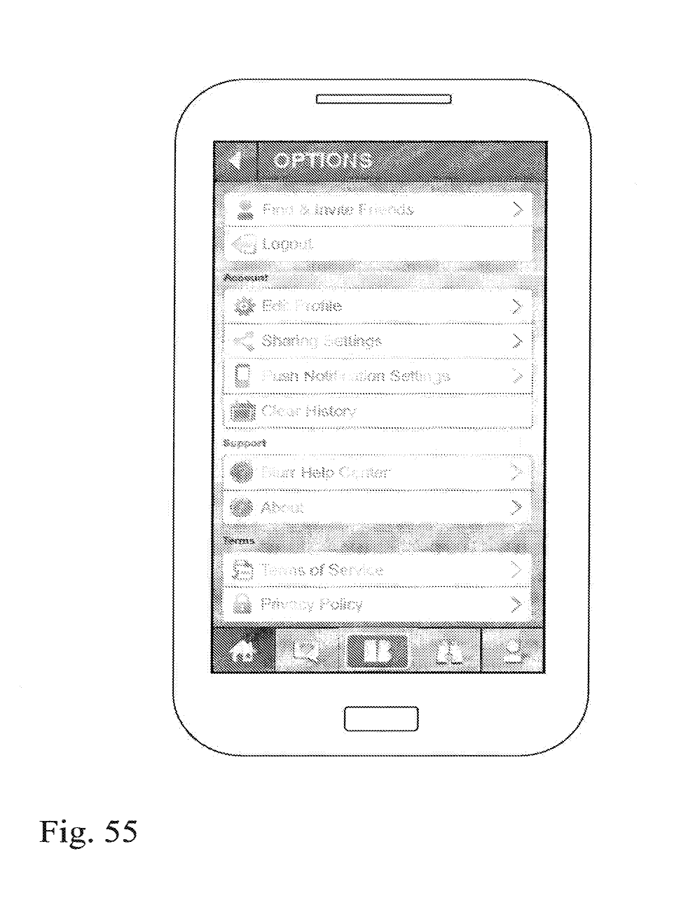

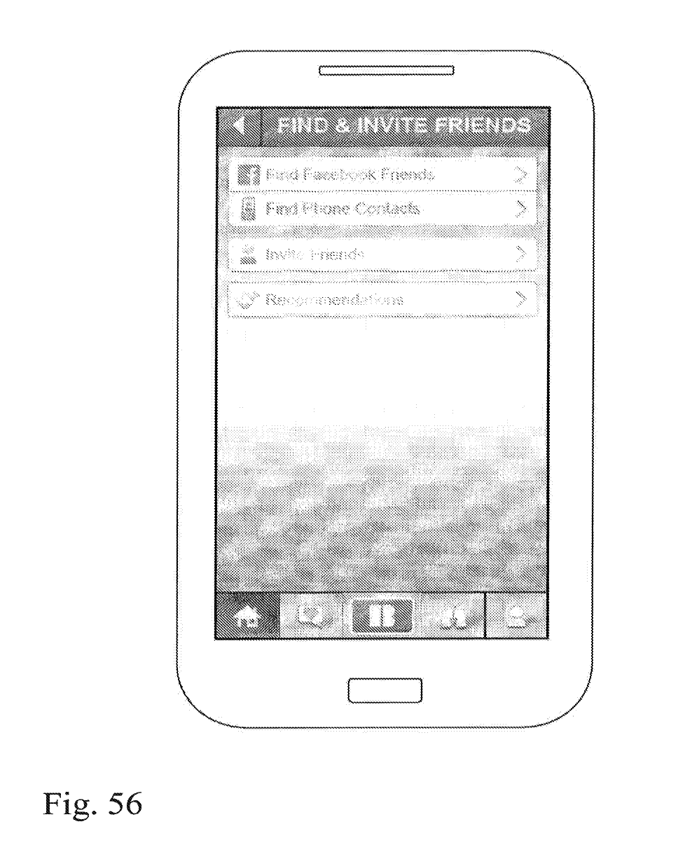

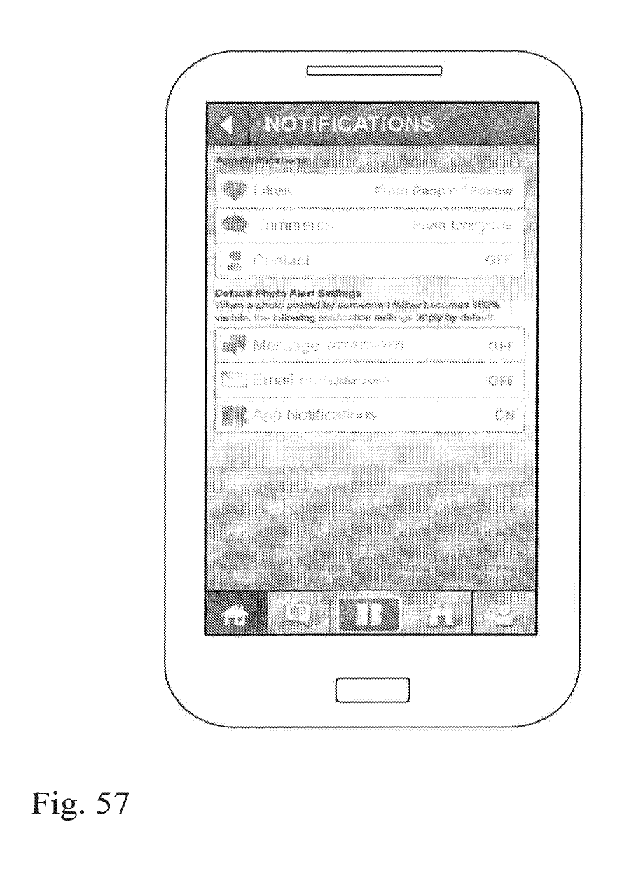

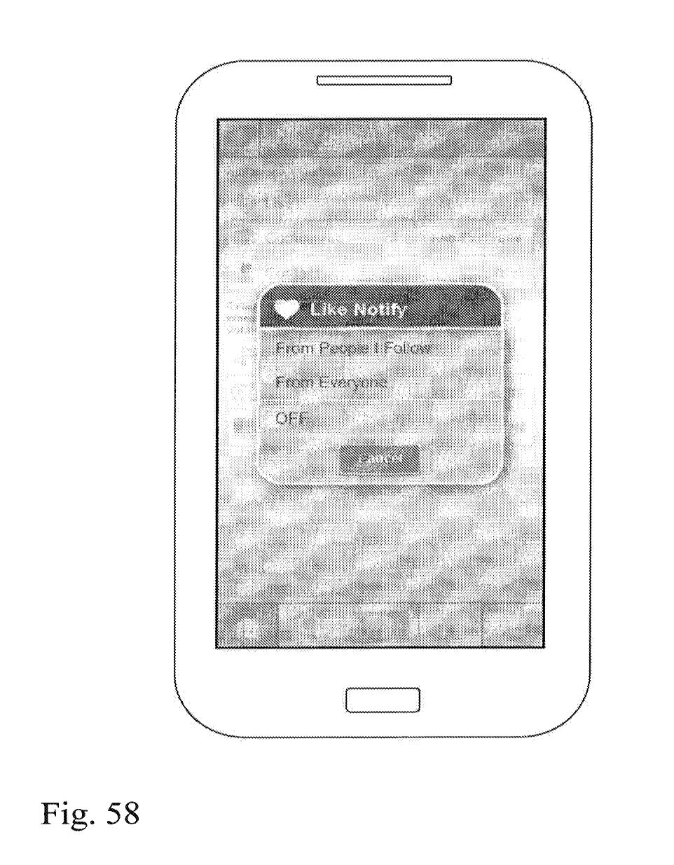

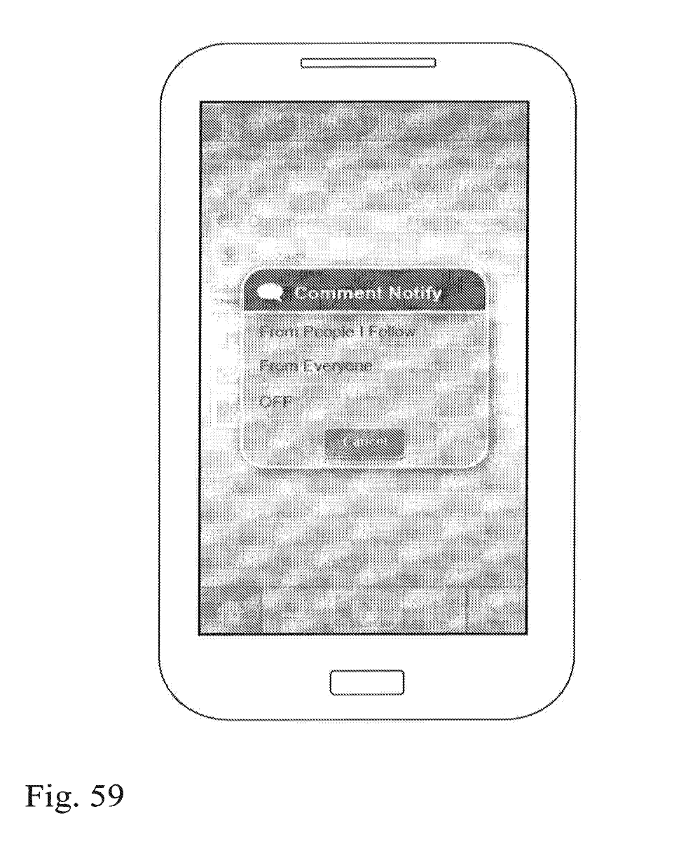

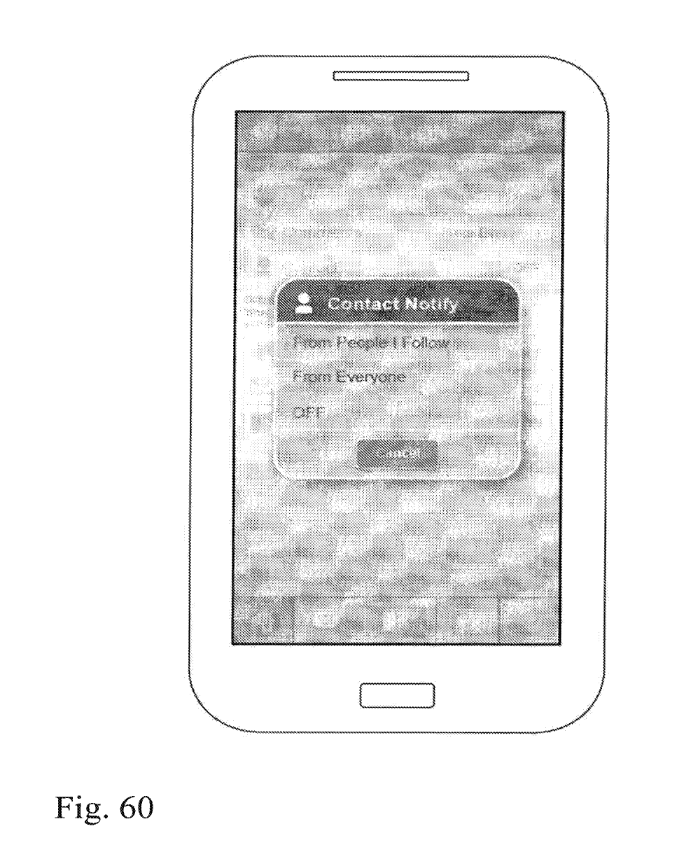

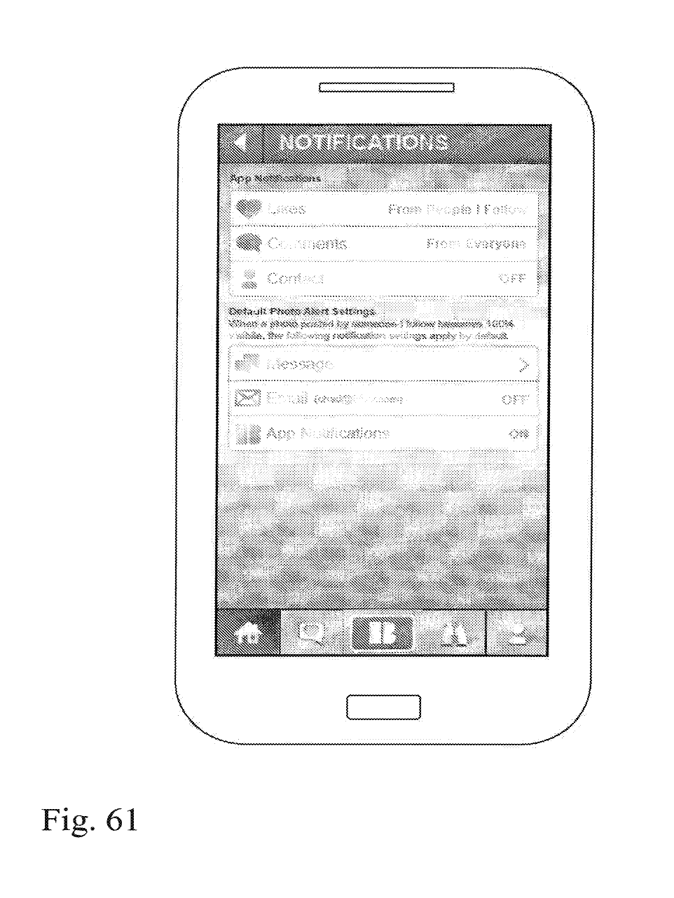

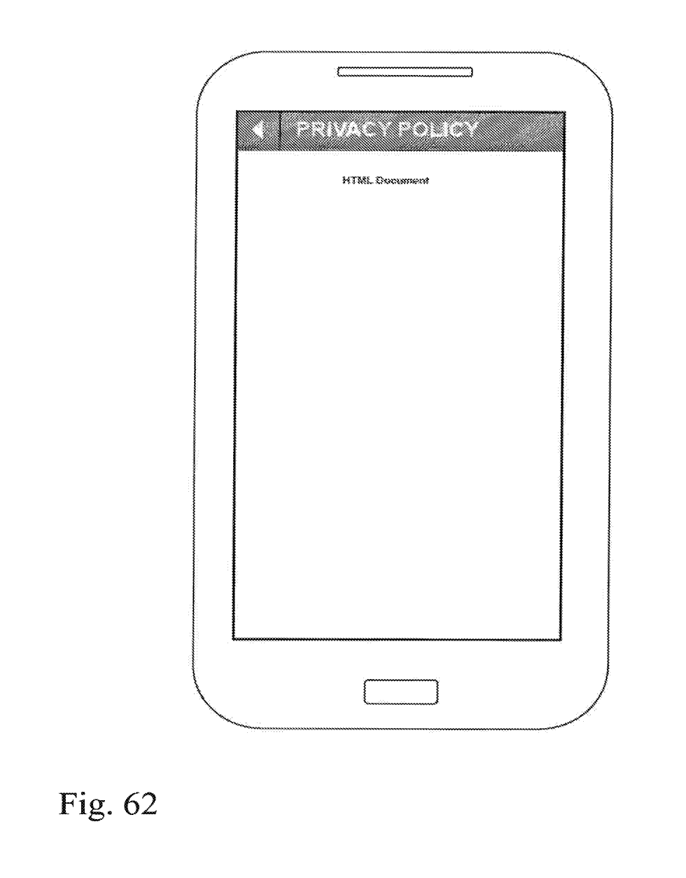

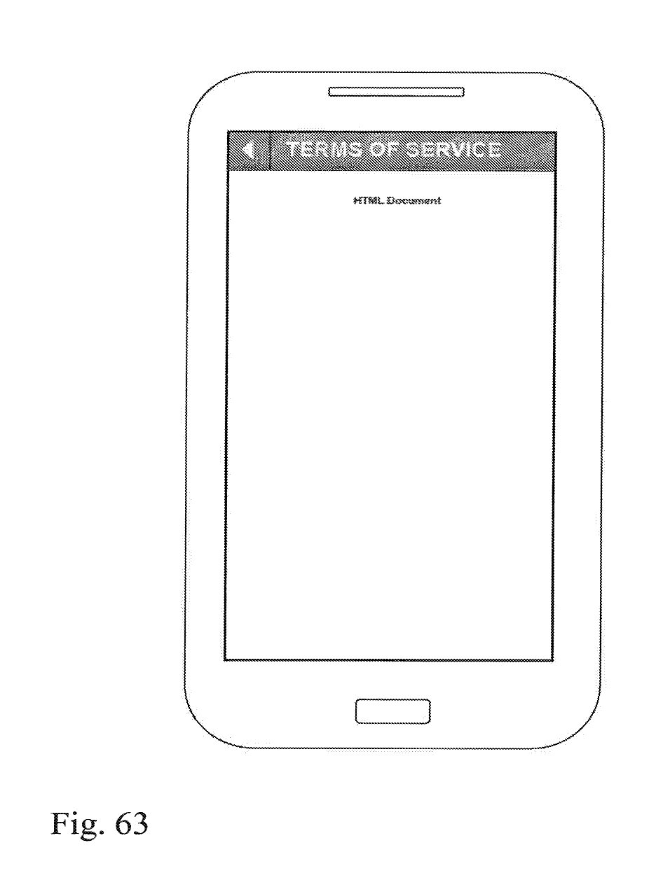

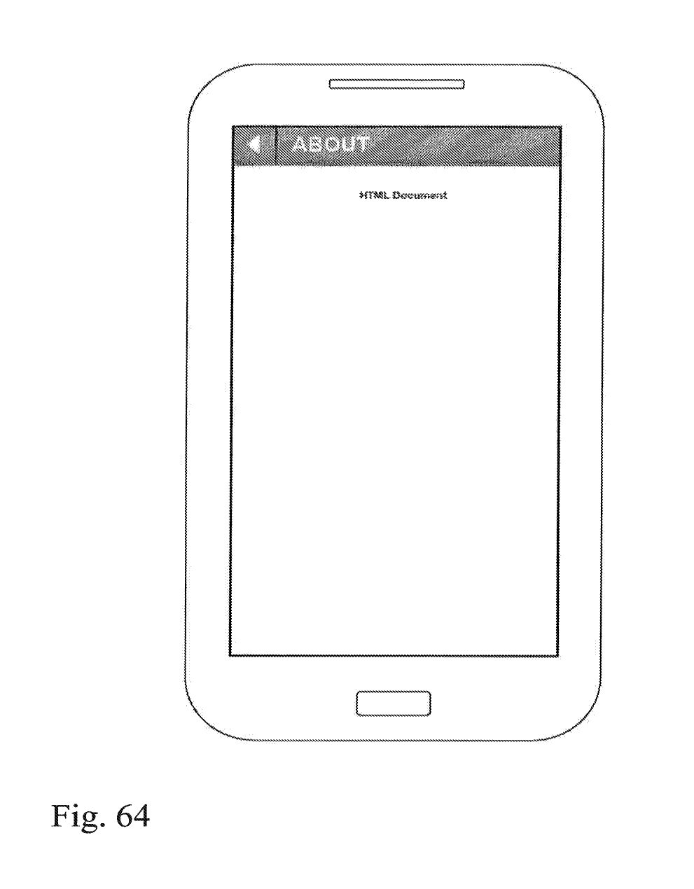

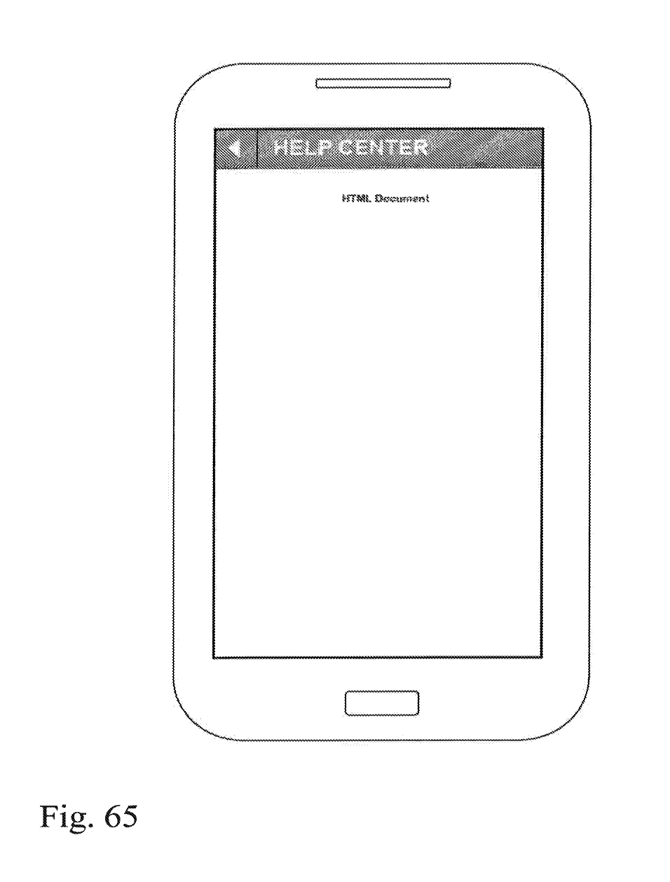

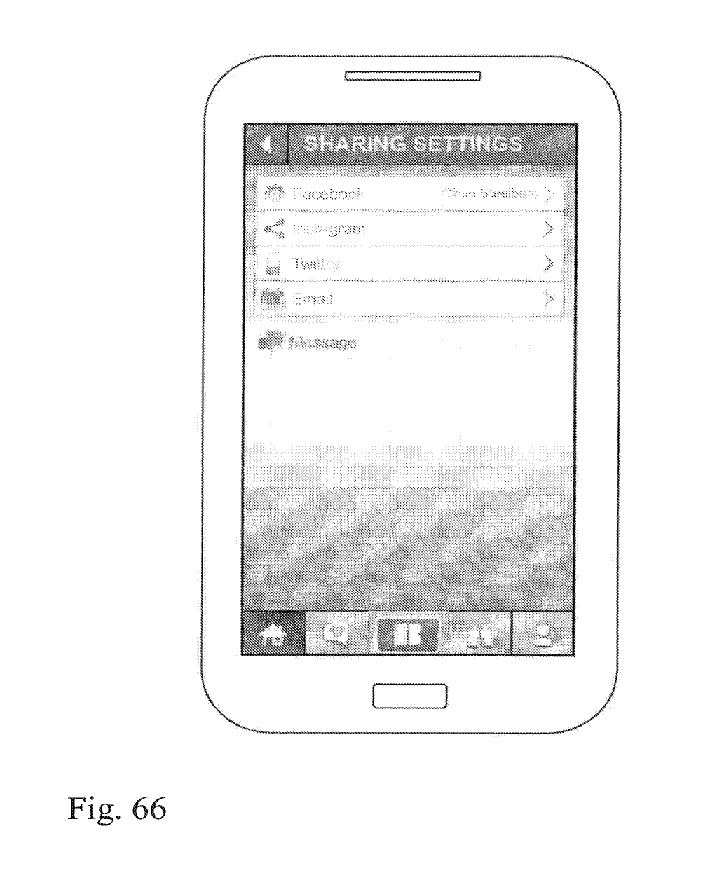

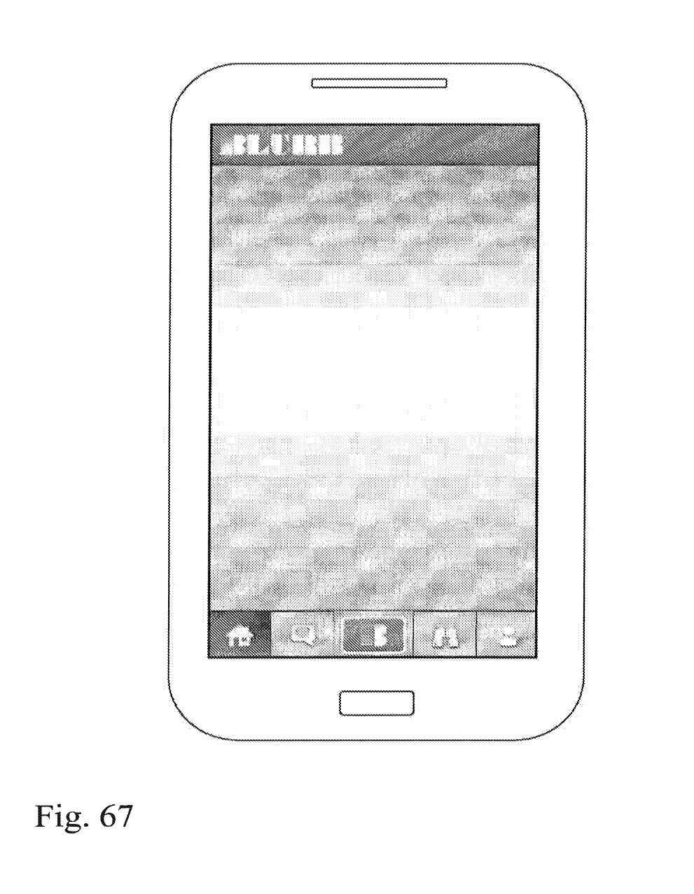

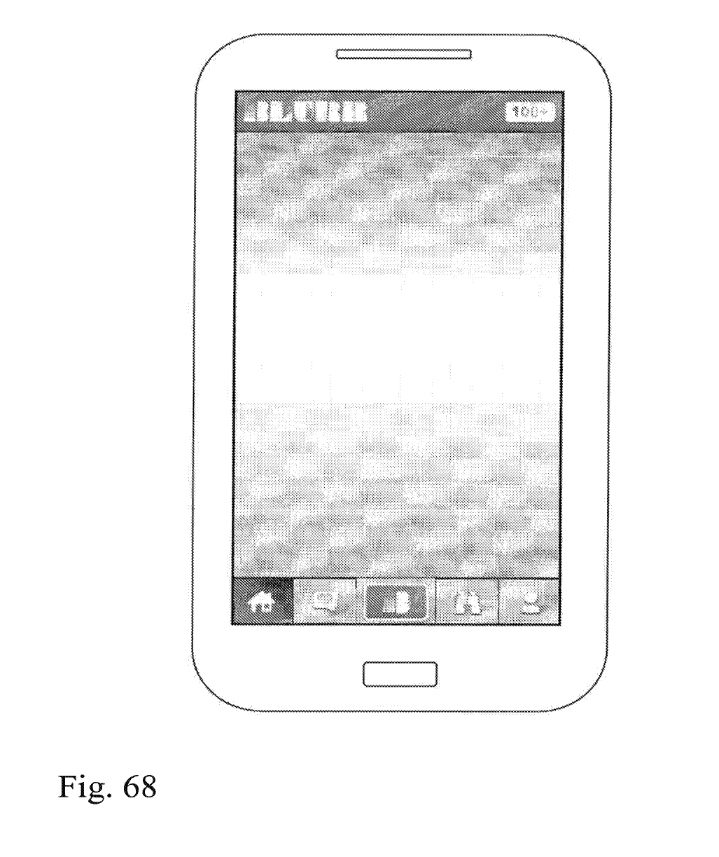

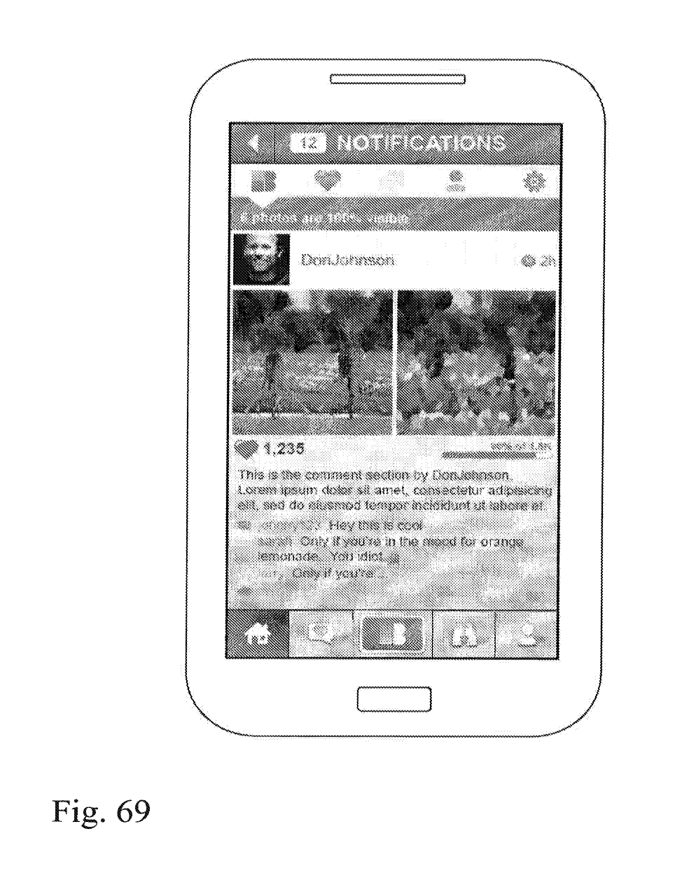

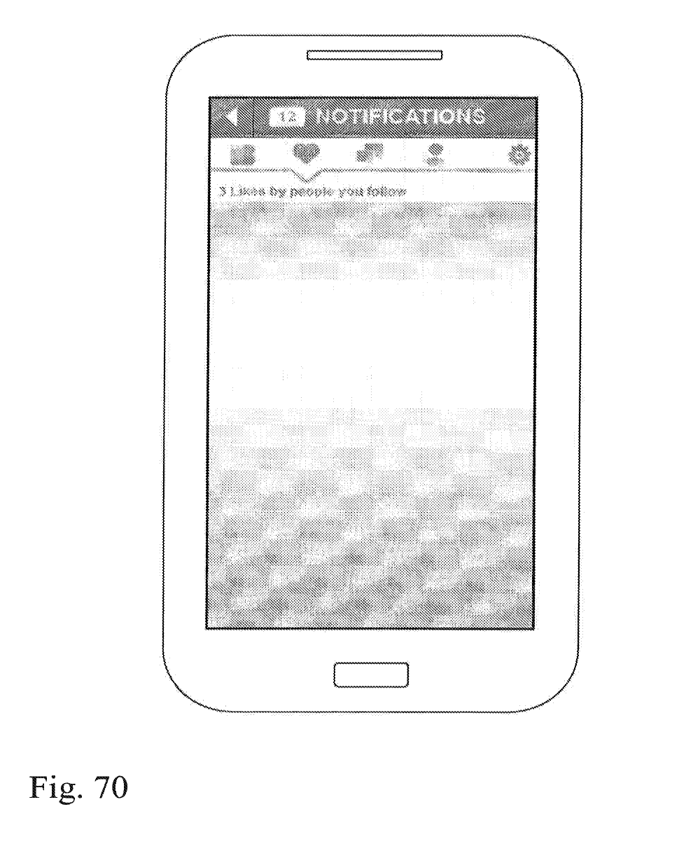

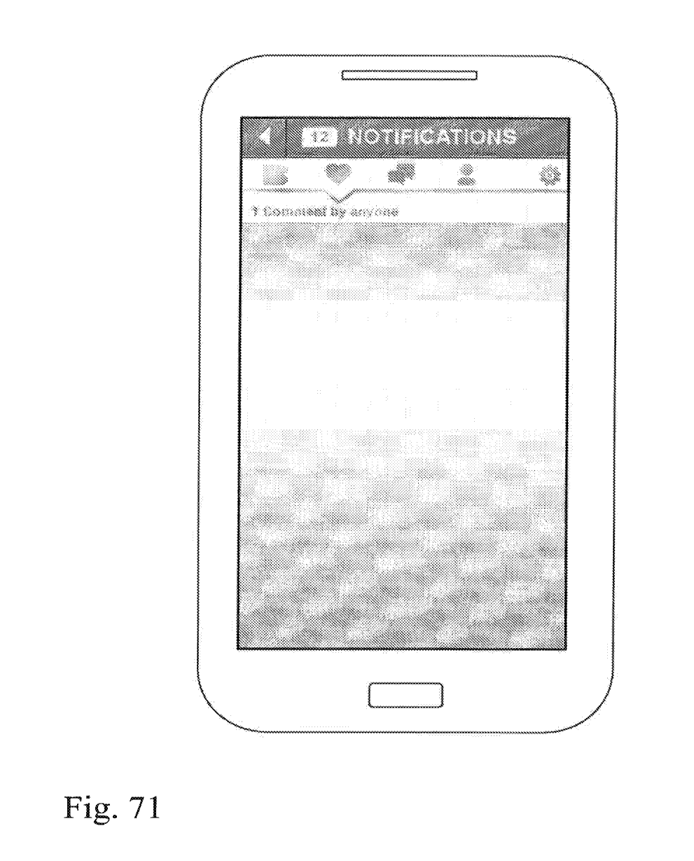

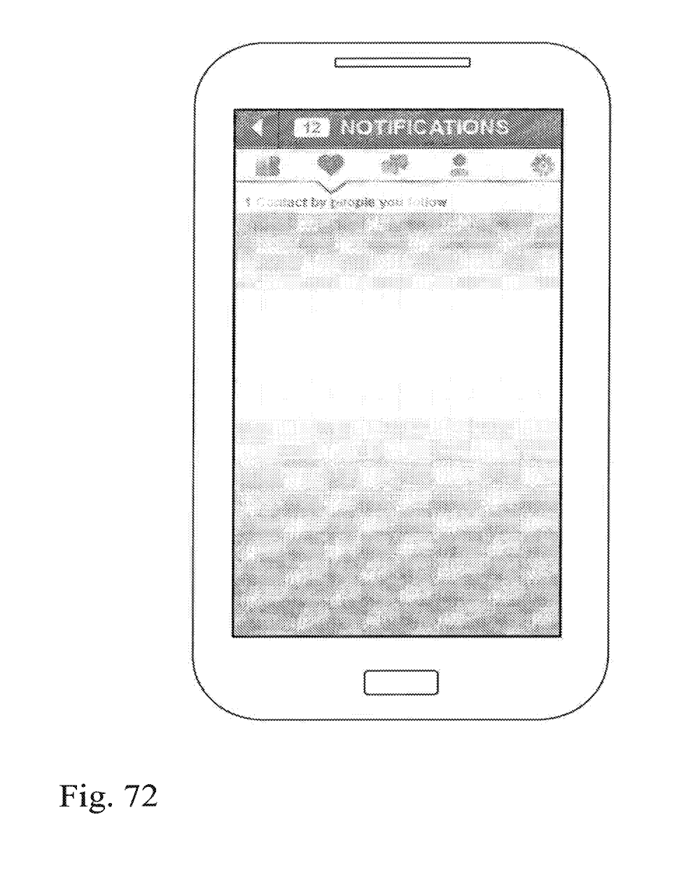

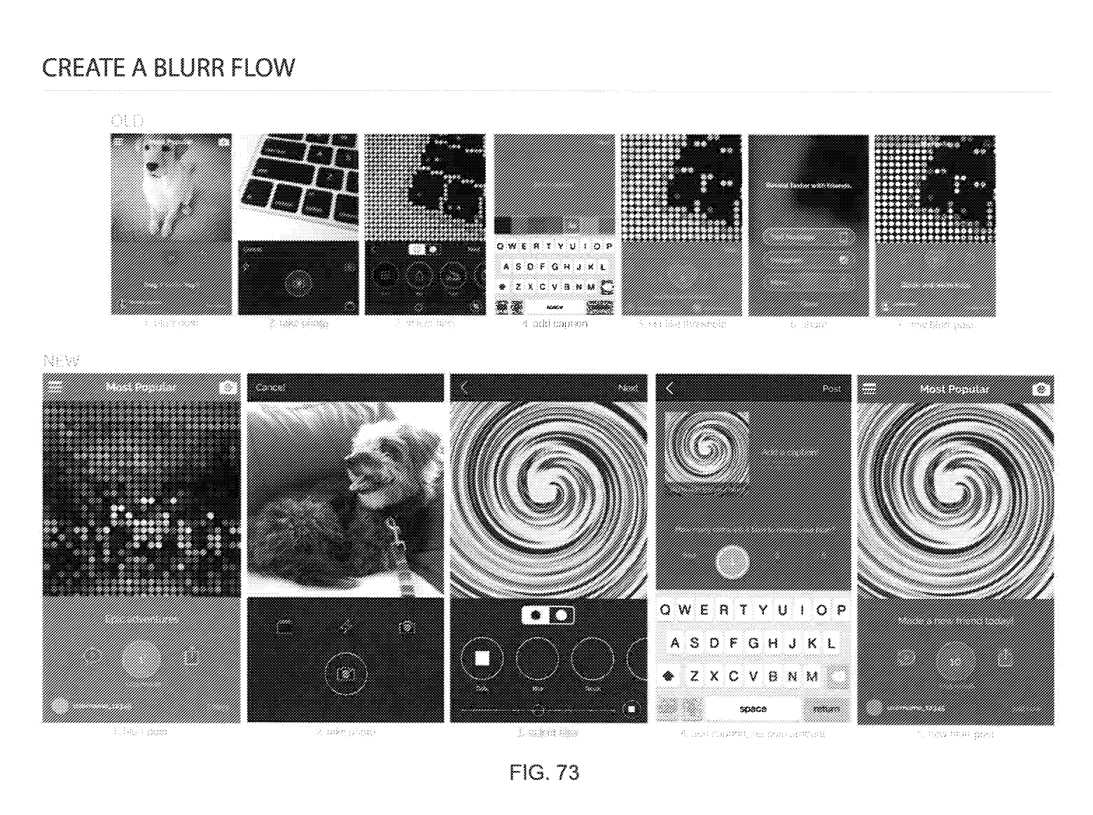

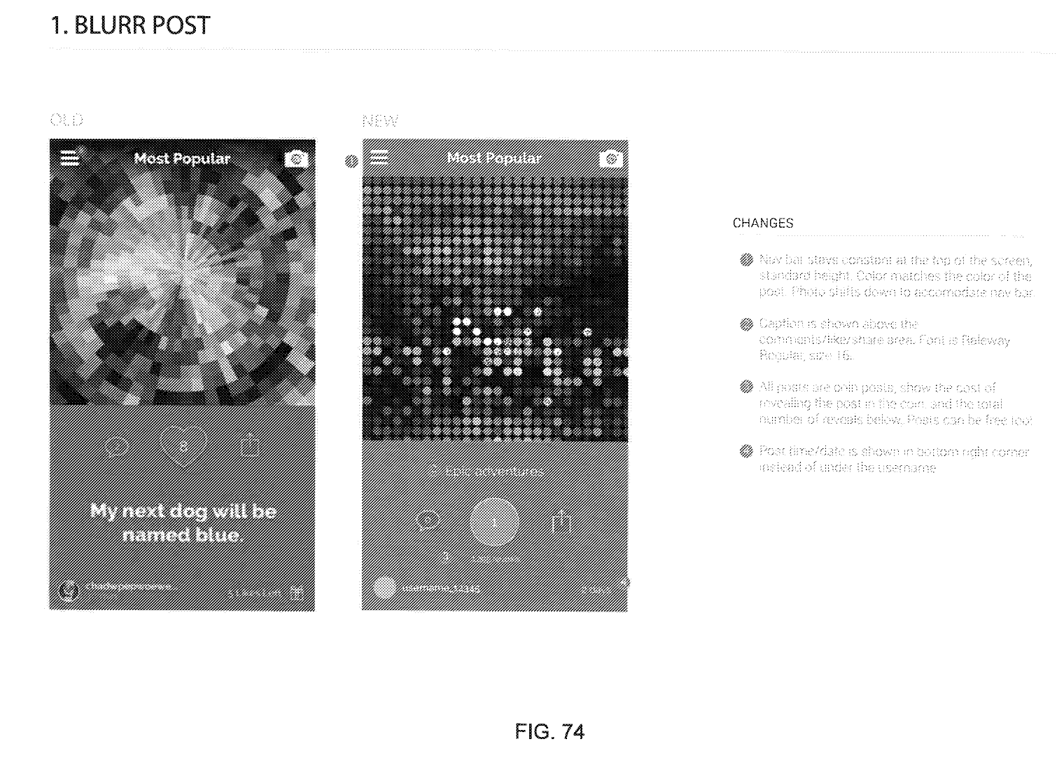

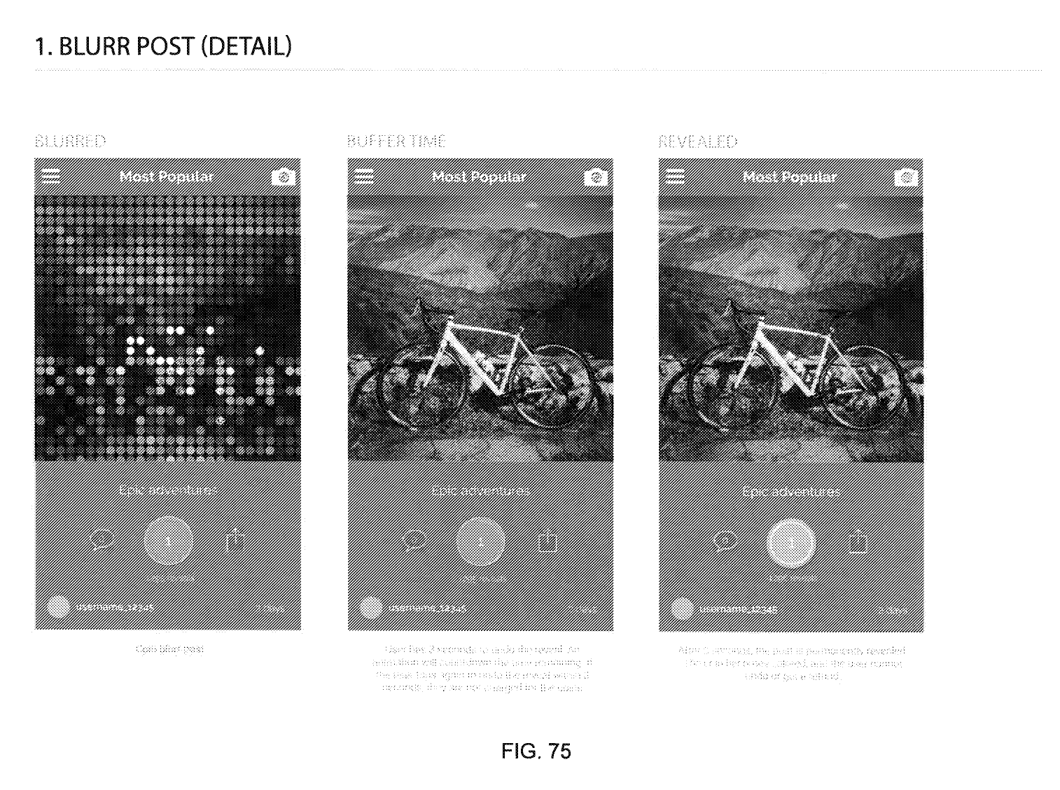

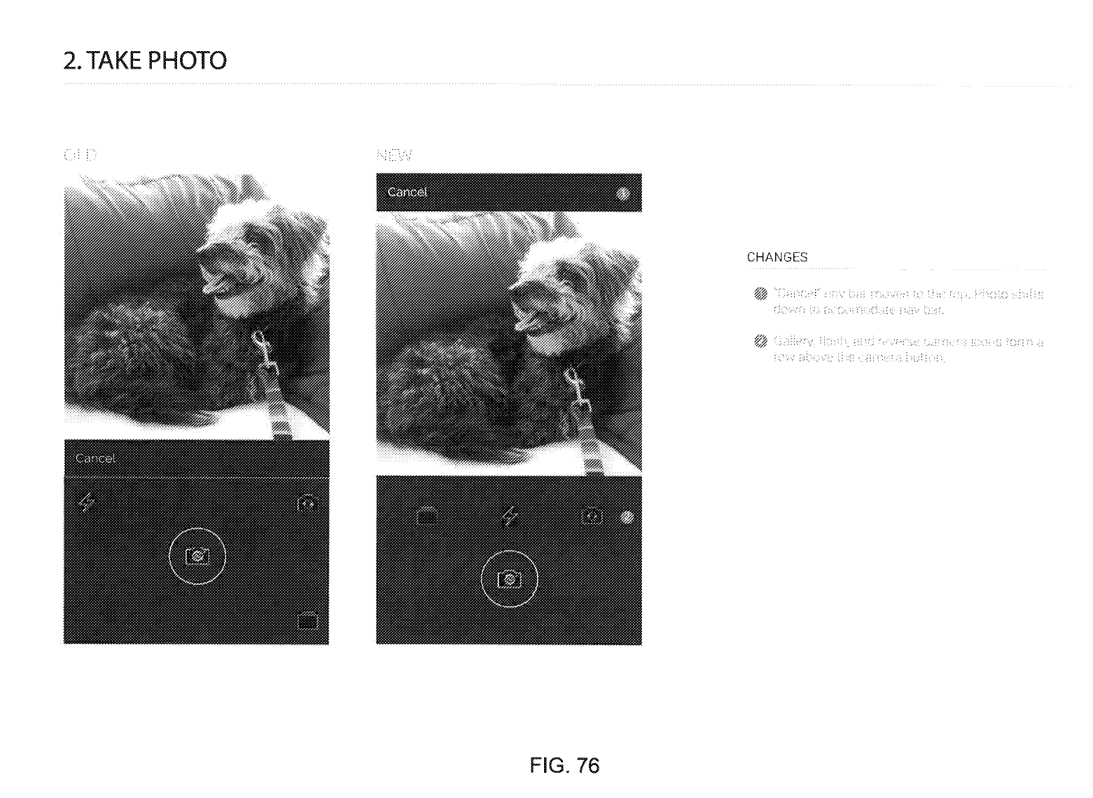

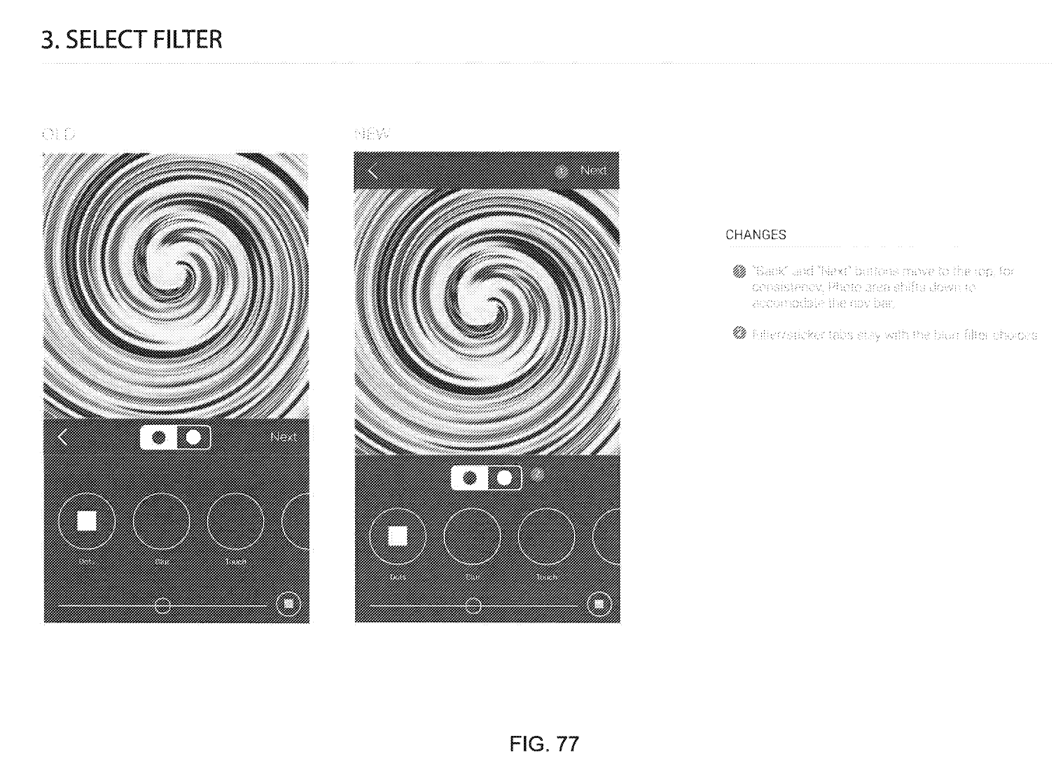

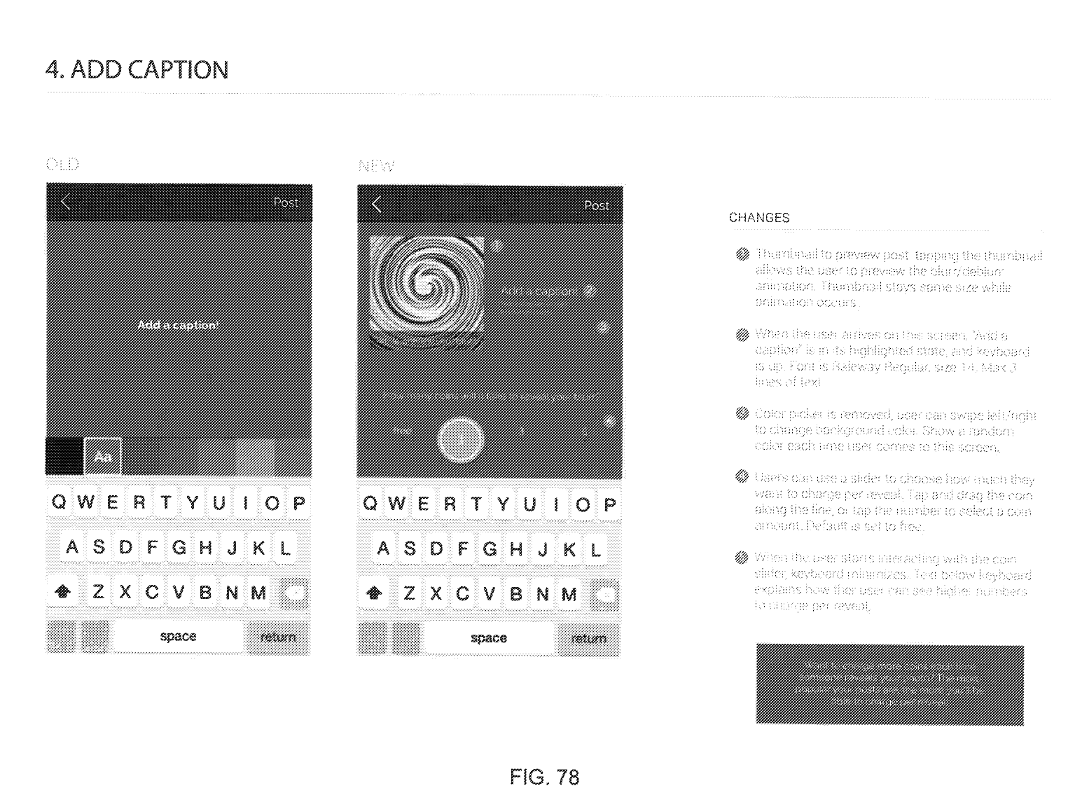

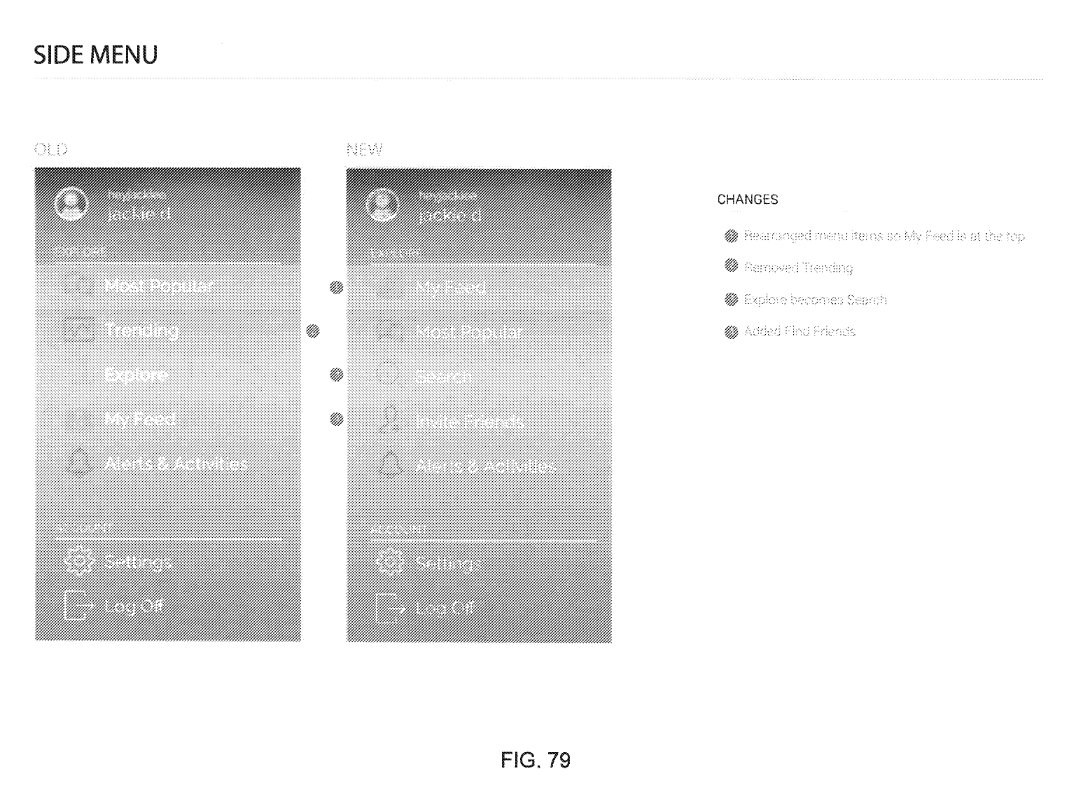

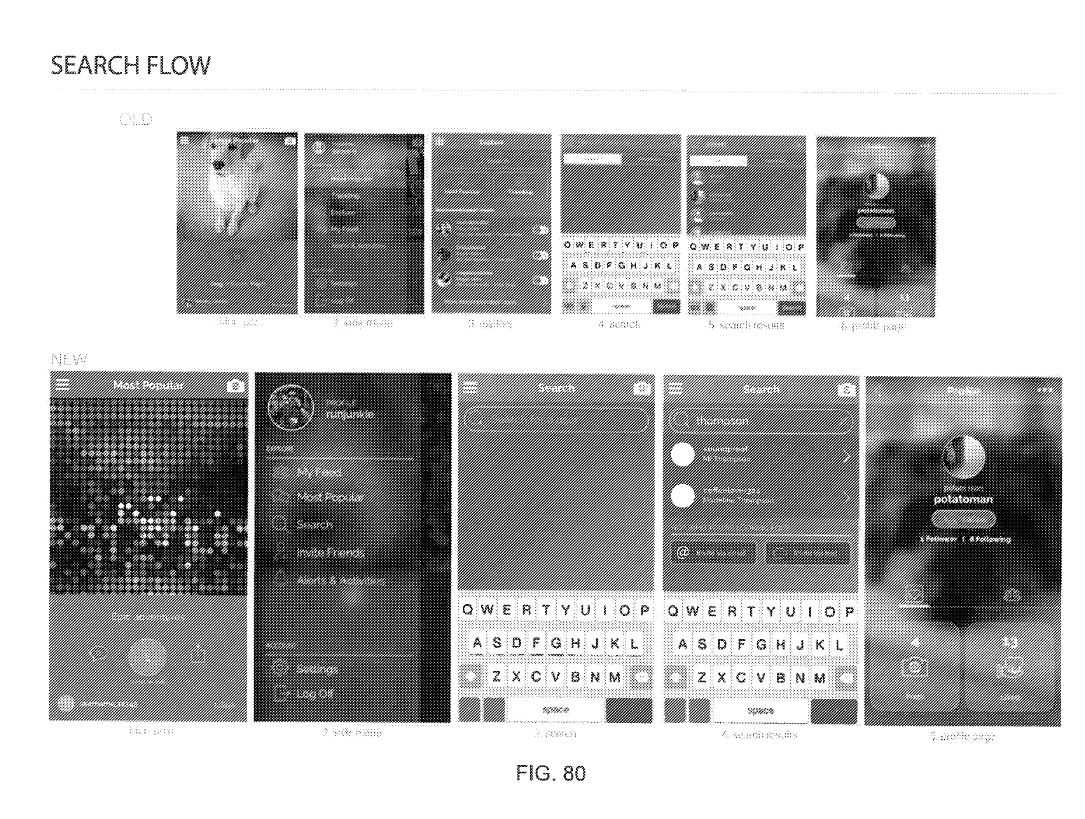

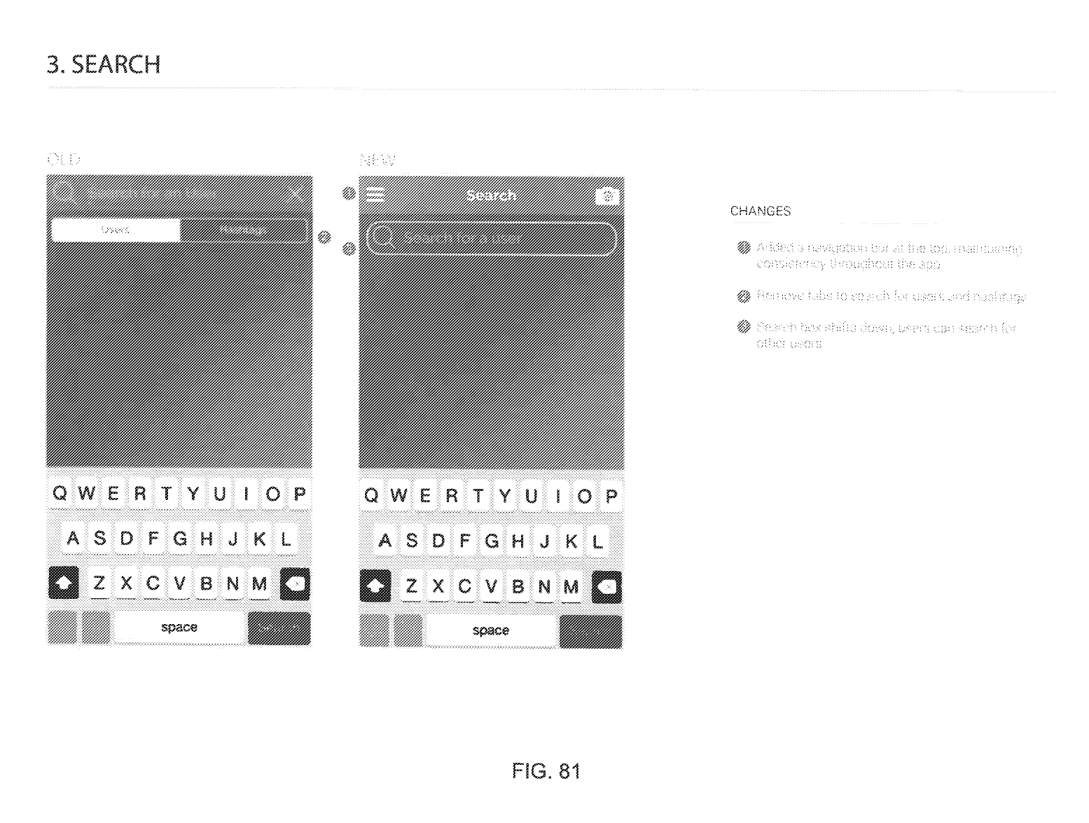

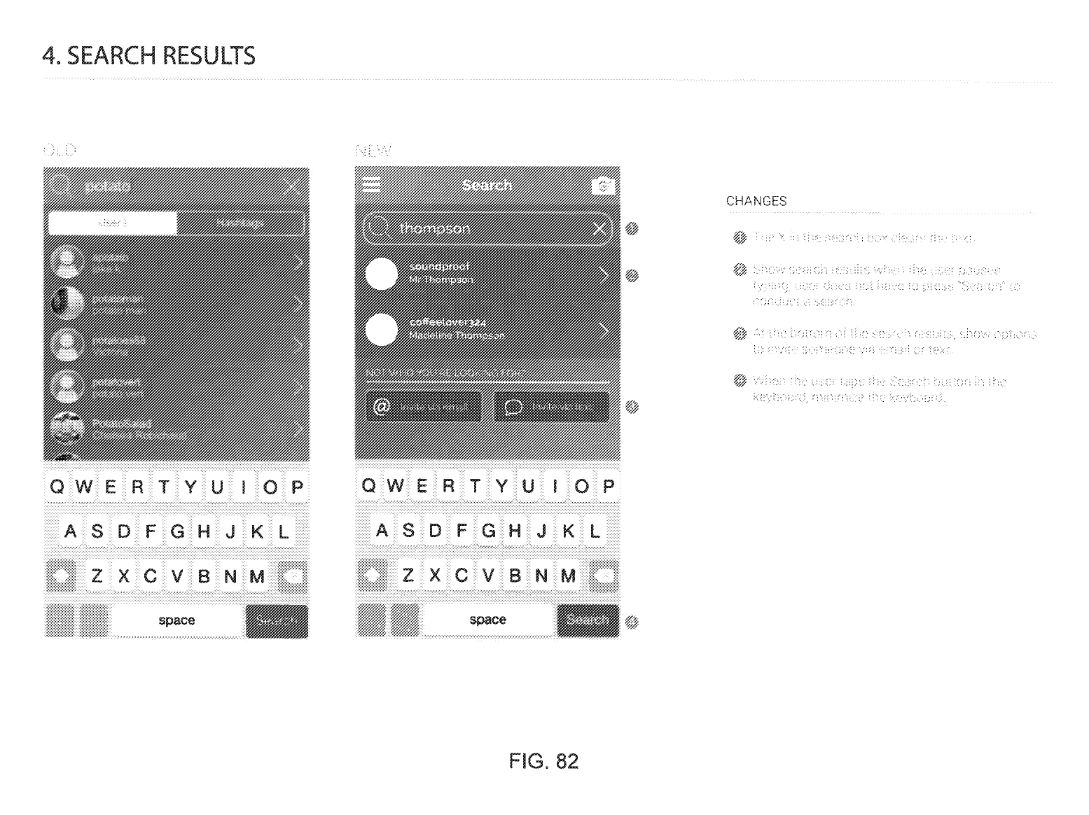

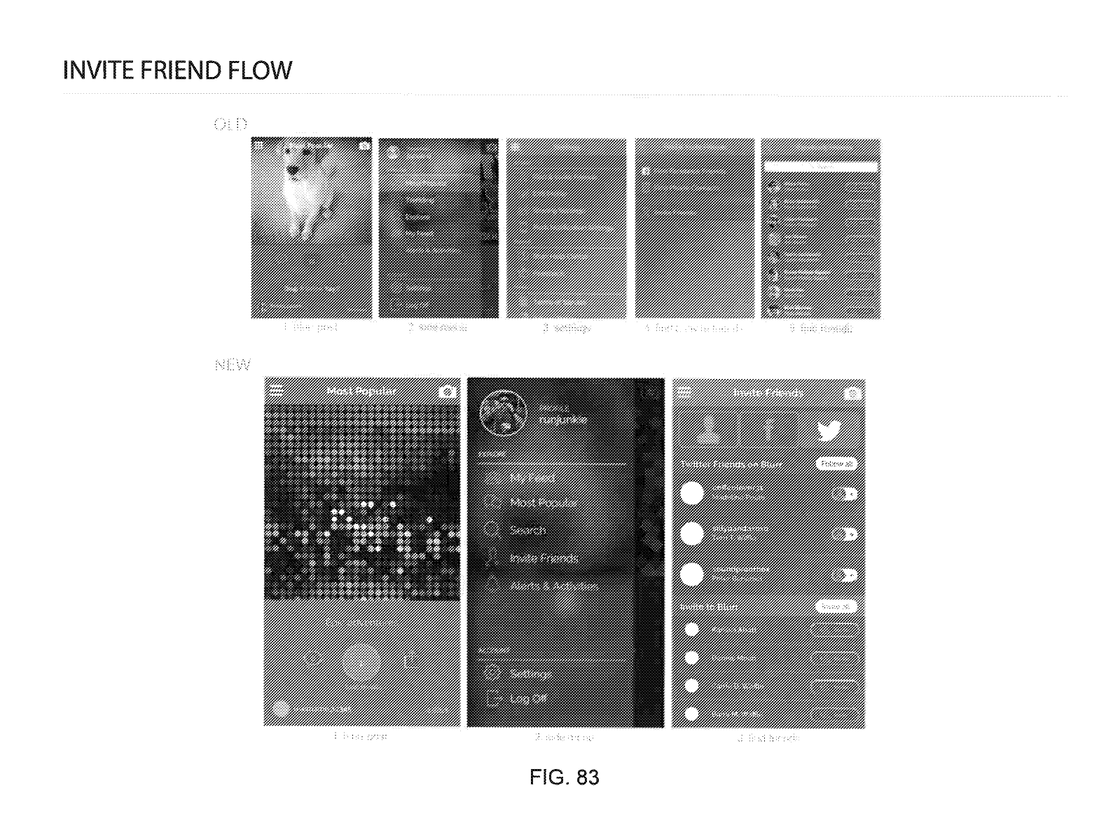

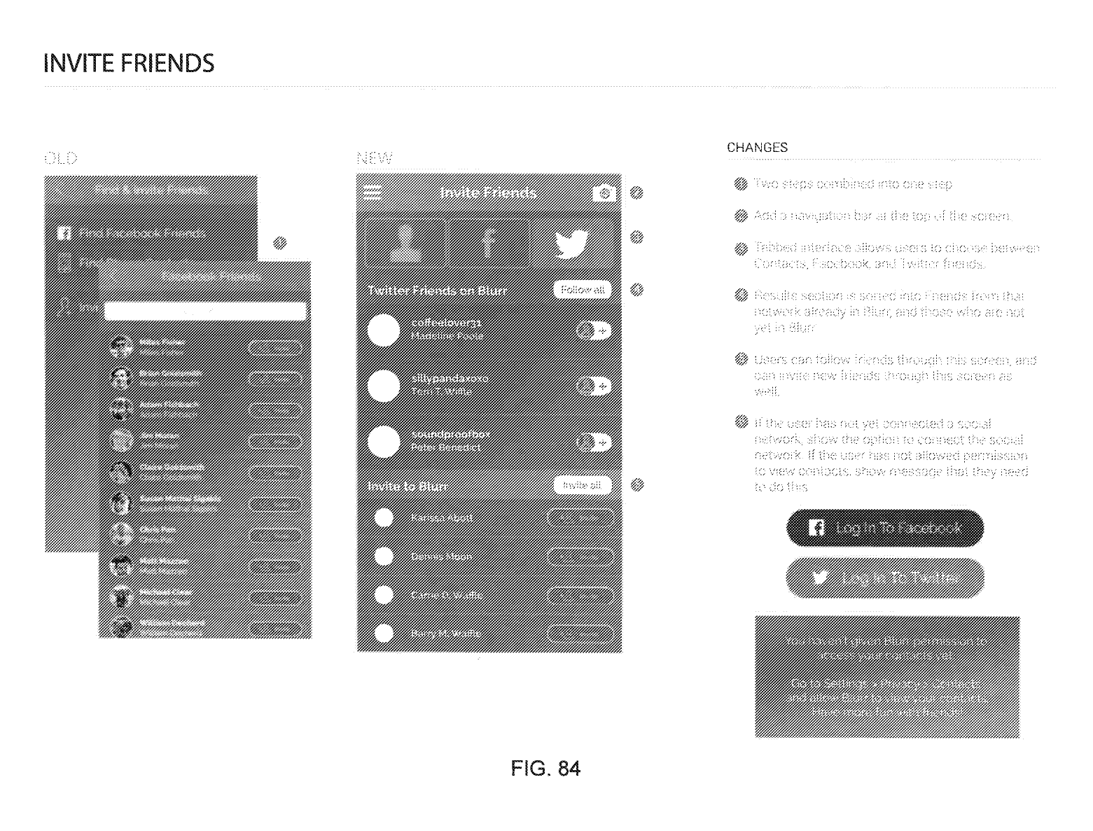

FIGS. 40 through 84 illustrate exemplary screen shots pertaining to various aspects of illustrative obfuscation app embodiments, which may be understood by inspection.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the discussion herein and any claims appended hereto.

What is claimed is:

1. A method of de-obfuscating an obfuscated image, comprising:
providing a view of at least one content;
receiving at least one criteria for receiving an at least partially obfuscated one of the view;
inputting an at least partial satisfaction of the at least one criteria, wherein the view is de-obfuscated responsive to each at least partial satisfaction of the at least one criteria.

2. An apparatus, executed on a mobile device by at least one processor resident thereon, comprising:
a viewing module suitable for providing a view of at least one content;
a receiving modules suitable for receiving at least one criteria for receiving an at least partially obfuscated one of the view;
an input module for inputting an at least partial satisfaction of the at least one criteria, wherein the view is de-obfuscated responsive to each at least partial satisfaction of the at least one criteria.

3. A system for generating digital content with various degrees of obfuscation applied, comprising:
a user terminal with a tangible processor in data communication with a network interface that couples the user terminal to a data communication network, the processor further in data communication with a data storage device storing instructions which, when executed on the processor, cause the user terminal to implement an obfuscation app that performs a method including:
presenting a user interface on a display of the user terminal;
accepting user input from the user interface indicating an item of digital content to obfuscate, at least one obfuscation parameter for use in applying the obfuscation, and at least one obfuscation criterion having an obfuscation information type for use in removing the obfuscation;
sending to an obfuscation server the item of digital content, the at least one obfuscation parameter, and the at least one obfuscation criterion;
receiving from the obfuscation server the digital content with the at least one obfuscation parameter applied as obfuscated digital content; and
presenting the obfuscated digital content on the display of the user terminal; and
the obfuscation server, having a tangible server processor in data communication with a server network interface that couples the server to the data communication network, the server processor further in data communication with a server data storage device storing instructions which, when executed on the server processor, cause the server to perform a method including:
receiving from the user terminal the item of unobfuscated digital content, the at least one obfuscation parameter, and the at least one obfuscation criterion;
applying the at least one obfuscation parameter to the unobfuscated digital content to generate the obfuscated digital content;
sending the obfuscated content to the first user terminal, and to at least one other user terminal responsive to a request from the at least one other terminal;
receiving user terminal information of the obfuscation information type from the user terminal and the at least one other user terminal;
generating an at least partially de-obfuscated digital content item in accordance with the at least one obfuscation criterion based on the received user terminal information; and
sending the at least partially de-obfuscated digital content item to the user terminal and the at least one other user terminal.

4. The system of claim 3, wherein the method performed by the user terminal further includes receiving from the server and displaying the at least partially de-obfuscated digital content.

5. The system of claim 3, wherein the at least one obfuscation parameter includes at least one of an obfuscation type, an obfuscation amount, an obfuscation characteristic, and an obfuscation characteristic amount.

6. The system of claim 3, wherein the at least one obfuscation criterion includes at least one of a geographic location, a radius from the geographic location, an inside/outside the radius indicator, a date/time, an answer to a question, and a payment.

7. The system of claim 3, wherein:
on the user terminal:
the user interface on the display of the user terminal includes a user interface of a third party app extended by the obfuscation app; and
the user terminal sends information of the third party app to the obfuscation server in addition to the item of digital content, the at least one obfuscation parameter, and the at least one obfuscation criterion; and
the method performed by the server further includes:
receiving from the user terminal the information of the third party app; and
interacting with a third party app server that provides third party app services, using an application programming interface (API) of the third party app.

8. The system of claim 7, wherein the at least one obfuscation criterion includes a number of likes.

9. A method of generating digital content with various degrees of obfuscation applied comprising:
presenting, at least partially from an obfuscation server, a user interface on a display of a user terminal;
accepting at the obfuscation server via user input from the user interface an indication of an item of digital content to obfuscate, at least one obfuscation parameter for use in applying the obfuscation, and at least one obfuscation criterion having an obfuscation information type for use in removing the obfuscation;
applying the at least one obfuscation parameter to the unobfuscated digital content to generate the obfuscated digital content;
sending the obfuscated content to at least one other user terminal responsive to a request from the at least one other terminal;
receiving user terminal information of the obfuscation information type from the at least one other user terminal;
generating an at least partially de-obfuscated digital content item in accordance with the at least one obfuscation criterion based on the received user terminal information of the at least one other terminal; and
sending the at least partially de-obfuscated digital content item to the at least one other user terminal.

10. The method of claim 9, wherein the at least one obfuscation parameter includes at least one of an obfuscation type, an obfuscation amount, an obfuscation characteristic, and an obfuscation characteristic amount.

11. The method of claim 9, wherein the at least one obfuscation criterion includes, a geographic location, a radius from the geographic location, an inside/outside the radius indicator, a date/time, an answer to a question, and a payment.

12. The method of claim 9, wherein the user interface on the display of the user terminal includes a user interface of a third party app extended by the obfuscation app, the method further comprising:
receiving, from the user terminal, information of the third party app by the obfuscation server in addition to the item of digital content, the at least one obfuscation parameter, and the at least one obfuscation criterion; and
interacting with a third party app server that provides third party app services, using an application programming interface (API) of the third party app.

13. The method of claim 12, wherein the at least one obfuscation criterion includes a number of likes.

14. A server for use in a system for generating digital content with various degrees of obfuscation applied, the server comprising:
a tangible server processor in data communication with a server network interface that couples the server to the data communication network, the server processor further in data communication with a server data storage device storing instructions which, when executed on the server processor, cause the server to perform a method including:
receiving from a user terminal an item of unobfuscated digital content, an obfuscation information type at least one obfuscation parameter, and at least one obfuscation criterion having an obfuscation information type;
applying the at least one obfuscation parameter to the unobfuscated digital content to generate the obfuscated digital content;
sending the obfuscated content to the user terminal, and to at least one other user terminal responsive to a request from the at least one other terminal;
receiving user terminal information having the obfuscation information type from the user terminal and the at least one other user terminal;
generating an at least partially de-obfuscated digital content item in accordance with the at least one obfuscation criterion based on the received user terminal information; and
sending the at least partially de-obfuscated digital content item to the user terminal and the at least one other user terminal.

15. The server of claim 14, wherein the at least one obfuscation parameter includes at least one of an obfuscation type, an obfuscation amount, an obfuscation characteristic, and an obfuscation characteristic amount.

16. The server of claim 14, wherein the at least one obfuscation criterion includes at least one of a geographic location, a radius from the geographic location, an inside/outside the radius indicator, a date/time, an answer to a question, and a payment.

17. The server of claim 14, wherein the instructions cause the method performed by the server to include:
receiving from the user terminal information of a third party app; and
interacting with a third party app server that provides third party app services, using an application programming interface (API) of the third party app.

18. The server of claim 17, wherein the at least one obfuscation criterion includes a number of likes.

19. A user terminal for use in a system for generating digital content with various degrees of obfuscation applied, the user terminal comprising:
a tangible processor in data communication with a network interface that couples the user terminal to a data communication network, the processor further in data communication with a data storage device storing instructions which, when executed on the processor, cause the user terminal to implement an obfuscation app that performs a method including:
presenting a user interface on a display of the user terminal;
accepting user input from the user interface indicating an item of digital content to obfuscate, at least one obfuscation parameter for use in applying the obfuscation, and at least one obfuscation criterion having an obfuscation information type for use in removing the obfuscation;
sending to an obfuscation server the item of digital content, the at least one obfuscation parameter, and the at least one obfuscation criterion;
receiving from the obfuscation server the digital content with the at least one obfuscation parameter applied as obfuscated digital content; and
presenting the obfuscated digital content on the display of the user terminal.

20. The user terminal of claim 19, wherein the method performed by the user terminal further includes receiving from the server and displaying the at least partially de-obfuscated digital content.

21. The user terminal of claim 19, wherein the at least one obfuscation parameter includes at least one of an obfuscation type, an obfuscation amount, an obfuscation characteristic, and an obfuscation characteristic amount.

22. The user terminal of claim 19, wherein the at least one obfuscation criterion includes, a geographic location, a radius from the geographic location, an inside/outside the radius indicator, a date/time, an answer to a question, and a payment.

23. The user terminal of claim 19, wherein:
the user interface on the display of the user terminal includes a user interface of a third party app extended by the obfuscation app; and
the data storage device stores instructions which, when executed on the processor, cause the user terminal to send information of the third party app to the obfuscation server in addition to the item of digital content, the at least one obfuscation parameter, and the at least one obfuscation criterion.

24. The user terminal of claim 23, wherein the at least one obfuscation criterion includes a number of likes.
